(19) United States
(12) Patent Application Publication
(10) Pub. No.: US 2003/0229884 A1
(43) Pub. Date: Dec. 11, 2003

(54) Interaction manager template

(75) Inventors: Steven R. Carr, San Jose, CA (US); Harry V. Gentilozzi, Marietta, GA (US); Tudor I. Har, Santa Clara, CA (US); Venkatakrishnan Muthuswamy, Cupertino, CA (US)

Correspondence Address: COMPAQ COMPUTER CORPORATION, LEGAL DEPARTMENT, MAIL CODE: M110701, P.O. BOX 692000, HOUSTON, TX, 77269-2000, US

(73) Assignee: Hewlett-Packard Development Company, Houston, TX

(21) Appl. No.: 10/402,482

(22) Filed: Mar. 27, 2003

Related U.S. Application Data
(60) Provisional application No. 60/382,496, filed on May 21, 2002.
(60) Provisional application No. 60/413,186, filed on Sep. 23, 2002.

(51) Int. Cl. G06F 9/44; G06F 9/00

(52) U.S. Cl. 717/101; 709/106

(57) ABSTRACT

A template for deployment of enterprise applications one example of which is an interaction manager. For deployment of the interaction manager, the template is configured with a class framework for building source code of the interaction manager and a test driver. The template is further configured with wizards. An application wizard provides for building a base class portion of the class framework. Interaction and attribute wizards provide for extending or modifying the class framework once the base class portion is built so as to provide for enterprise-specific deployment of the interaction manager along with the test driver. In addition, test driver script is provided through which the test driver is to be used for validating and measuring the performance of the interaction manager once their source code is converted to executable code.

### REFERENCE TO PRIOR APPLICATION

This application claims the benefit of and incorporates by reference U.S. Provisional Application No. 60/382,496, titled “IM Template,” filed May 21, 2002, and U.S. Provisional Application No. 60/413,186, also titled “IM Template,” filed Sep. 23, 2002.

### CROSS REFERENCE TO RELATED APPLICATIONS

This application is related to and incorporates by reference U.S. patent application Ser. No. 09/948,928, filed Sep. 7, 2001, entitled “Enabling a Zero Latency Enterprise”, U.S. patent Ser. No. 09/948,927, filed Sep. 7, 2001, entitled “Architecture, Method and System for Reducing Latency of Business Operations of an Enterprise”, U.S. patent application Ser. No. 10/013,091, filed Dec. 7, 2001, entitled “ZLE Enriched Publish and Subscribe” and U.S. patent application Ser. No. ______ (Attorney Docket No. 200300827-2), filed ______ entitled “Interaction Manager”.

### BACKGROUND

1. Field

The present invention relates to deployment of an interaction management facility. As an example, the invention relates to deployment interaction management associated with customer relation management (CRM) applications.

2. Background

One of the critical information technology needs of any large organization (hereafter generally referred to as “enterprise”) is maintaining a comprehensive view of its operations and information, preferably in real time. In view of that, its information technology (IT) infrastructure is often configured to allow distribution of valuable information across the enterprise to its groups of information consumers, including remote employees, business partners and customers.

With conventional solutions in place, enterprises have been using some form of an enterprise application integration (EAI) platform to integrate and exchange information between their applications. However, with substantial amounts of information located on disparate systems and platforms, information is not necessarily present in the desired form and place. Moreover, the distinctive features of business applications that are tailored to suit the requirements of a particular domain complicate the integration of applications. In addition, the new and legacy software applications are often incompatible and their ability to efficiently share information with each other is diminished.

Deficiencies in integration and data sharing are indeed a difficult problem of IT environments for any enterprise. When requiring information for a particular transaction flow that involves several distinct applications, the inability of organizations to operate as one-organ, rather than separate parts creates a challenge in information exchange and results in economic inefficiencies.

Consider for example applications designed for customer relationship management (CRM) in the e-business environment, also referred to as eCRMs. Conventional eCRMs are designed with an interaction manager (IM) for a specific type of business or industry, but they are not designed for facilitating adaptation to other business enterprises. Moreover, traditional eCRM systems are built on top of proprietary databases that do not contain the detailed up-to-date data on customer interactions. These proprietary databases are not designed for large data volumes or high rate of data updates. As a consequence, these solutions are limited in their ability to gather and leverage real-time knowledge for enriching data presented to customers. Moreover, such solutions are typically incapable of customizing offers or promotions that feed on real-time events specific to the enterprise, including offers and promotions personalized to customers of the enterprise. And, industry-specific applications supporting these solutions are not easily adaptable to other industries.

### SUMMARY

In view of the foregoing, the preferred solution provides an interaction manager (IM) template. The IM template provides an IM deployment mechanism where the IM is designed for gathering information associated with customer interactions that occur within sessions and for enriching those interactions with offers or recommendations based upon the comprehensive real-time view of customer information, augmented by business rules and/or data mining. With the assistance of wizards, and with class libraries, source code, scripts and documentation the IM template is established as an application framework customized to support the special needs of enterprises. In the preferred form, the IM template is a class framework that allows enterprise-specific deployment of an interaction manager and provides wizards to generate custom interaction types. This allows management of sessions with interactions of various types. The typical implementation of this framework also allows IM deployment for operation under both CORBA and Tuxedo.

The IM template is provided as part of the ZLE (zero latency enterprise) development kit (ZDK). The ZLE framework is configured with various enterprise applications, including the IM. The IM is integrated with a zero latency enterprise (ZLE) data store that caches transaction information collected from the various enterprise applications into normalized tables to provide a comprehensive view of the customer information. The ZLE data store is built to scale to the highest data volumes and rates of update. Furthermore, the IM builds a de-normalized cache of customer information for the duration of a session to optimize response times and throughput for interactions. This cache is disk-based and enabling linear scalability of the data store under a shared-nothing architecture. Finally, the design of the application framework and wizards enable easy customization to the requirements of specific enterprises.

The IM template addresses both the development and deployment of the executable code and the underlying ZLE data store. In its typical form, the IM is deployed either as a CORBA object or as a Tuxedo Server (CORBA stands for common object request broker architecture). In addition to the IM, the IM template provides a test driver. The test driver can be run as a CORBA client or a Tuxedo client, or it can be used to directly test the logic of the IM when linked as standalone.

In accordance with the purpose of the invention, as embodied and broadly described herein, the IM template is preferably divided into several sub-frameworks containing (1) business logic, (2) test driver logic, (3) CORBA deployment logic and (4) Tuxedo deployment logic. These frameworks are bound together by a well-defined application interface, independent of the deployment environment, and implemented by the business logic. The application, business logic and test driver sub-frameworks provide a mechanism for deploying the IM along with a test driver for validating and measuring the performance of the IM. The test driver invokes the application interface. The CORBA deployment framework includes an adapter to this application interface that binds with the CORBA stub, and a CORBA servant that serves as a facade to this application interface. The Tuxedo deployment framework includes an adapter to this application interface that issues a Tuxedo request, and a Tuxedo server that serves a facade to this application interface. The application interface defines a distinct method for each distinct interaction type. Each method is exposed either as a Tuxedo service or a method of the CORBA object when deployed into the corresponding environment.

The IM is preferably developed using object oriented programming techniques (e.g., in C++). In object oriented programming, a class is an object type used as a template for creating objects, and objects created thereby are instances of that class. Objects encapsulate data and subroutines (methods) and are considered semiautonomous in that they enclose data and methods that are private to them. An object interacts with the rest of the program through interfaces that are defined by the object's public (externally callable) methods. Moreover, the program structure can be hierarchical where an instance of a subclass inherits attributes from an instance of a super class. Accordingly, in the IM template context, distinct interaction types are implemented in distinct subclasses inheriting from common super classes.

In view of the foregoing, the template is adaptable with wizards that, among others, are used to customize the application interfaces. Wizards are added to facilitate automatic generation of custom code by defining the interactions and the attributes of those interactions. The wizards perform the customization required by the test driver, CORBA deployment framework, and Tuxedo deployment logic. This includes the generation and customization of distinct classes within each of the four frameworks. Support for cookies (i.e., for anonymous and obscurely identified customers) is implemented in a separate subclass that can be omitted from the completed application.

Altogether, the present invention makes it much easier to test, debug and validate the IM. Moreover, the present invention makes the code more generally useful and deployable, most notably in regards to memory management. Hence, unlike IM templates in traditional deployment environments, the IM template in accordance with the present invention was radically restructured to be adaptable to different enterprises (different organization types and different industries).

Hence, in accordance with the purpose of the invention, as embodied and broadly described herein, a method for deploying an IM includes producing a template adaptable with wizards for enterprise-specific deployment of the IM along with a test driver. As noted, the wizards include an application wizard, an interaction wizard, and an attribute wizard. The method thus includes the step of invoking the application wizard which invocation instantiates a project file. The project file is instantiated with a set of base classes that define build targets of which a first target includes common and business logic library, a second target includes a test driver library and a third target includes a stand alone test program with modules linked to the first and second targets. The method also includes the step(s) of invoking the interaction wizard once for each enterprise-specific interaction type and data object, which invocation creates classes and connects them to any of the base classes. The method further includes the step(s) of invoking the attribute wizard, once for each attribute of the enterprise-specific interaction type and data object, which invocation adds lines of code to or modifies any of the classes specific to the interaction named in the attribute wizard invocation. To create the IM along with the test driver in the form of an executable file the classes and base classes are compiled and linked.

In one instance, the method further includes building a fourth target that fashions a CORBA server with modules linked to the first target; and building a fifth target that fashions a CORBA client with modules linked to the second target. In another instance the method further includes building a fourth target that fashions a Tuxedo server with modules linked to the first target; and building a fifth target that fashions a Tuxedo client with modules linked to the second target. It is noted that other types of middle-ware are possible and that the IM (and test driver) can be deployed for support of both CORBA and Tuxedo-based servers and clients.

Advantages of the invention will be appreciated by those skilled in the art from the description herein. Advantages of the invention will be realized and attained from practice of the invention disclosed herein.

### BRIEF DESCRIPTION OF THE DRAWINGS

The accompanying drawings, which are incorporated in and constitute a part of this specification, illustrate several embodiments of the invention and together with the description, serve to explain the principles of the invention. Wherever convenient, the same reference numbers will be used throughout the drawings to refer to the same or like elements.

FIG. 1 illustrates a ZLE framework that defines, in the preferred embodiment, a multilevel architecture (ZLE architecture) centered on a virtual hub.

FIG. 2 illustrates the core of the ZLE framework.

FIG. 3 illustrates a ZLE framework with an application server supporting ZLE core services that are based on Tuxedo, CORBA or Java technologies.

FIG. 4 illustrates a ZLE framework configured for publish and subscribe operations

FIG. 5 illustrates the enriched publish and subscribe operations.

FIG. 6 illustrates the elements of interaction management in the eCRM example.

FIGS. 7a-c, illustrate interaction manager (IM) operations at the start of a new session, upon resuming a session and on changing a customer during a browse (cookie) session.

FIGS. 8a-f further illustrate IM operations, including inserting new session records, loading customer data, getting offers, inserting records, caching session data.

FIG. 9 demonstrates the business rules based for example of demographic information.

FIGS. 10a-c, illustrate three data types cached in the data store.

FIGS. 11a,b, illustrate respectively the IM template, and a comparison between the IM template and the base template.

FIG. 12 shows application wizard invocation examples.

FIGS. 13a,b, show interaction and attribute wizards invocation examples.

FIG. 14 shows the build targets for a typical deployment.

FIGS. 15a-g, respectively illustrate the standalone, CORBA, and Tuxedo build design and classes framework.

FIGS. 16a,b, show business logic classes for the ATM example.

FIGS. 17a,b, show business logic classes for the eCRM example.

FIG. 18 shows the C-language SQL modules.

FIGS. 19a,b, show the test driver classes for the ATM and eCRM examples, respectively.

FIGS. 20a-c, illustrate the test driver command syntax.

FIGS. 21a-c, illustrate the test script syntax with various test scenarios.

### DETAILED DESCRIPTION OF THE INVENTION

Servers, such as Hewlett-Packard's NonStop™ servers, host various mission-critical applications for enterprises around the world. One such mission-critical application is directed to customer-relations management (CRM). In view of that, the present invention relates to interaction management associated with CRMs, including CRMs in the e-business environment (eCRMs). In this context, the interaction manager (IM) is an enterprise application that captures interactions with enterprise ‘customers’, gathers customers' data, calls upon a rules service to obtain offers customized for such customers and passes the offers to these customers.

For the purpose of deploying the IM, the present invention introduces an interaction manager (IM) template with a new framework. The new framework of the IM template is formulated based on the observation that enterprise-specific adaptability has not been a factor considered in prior art CRM deployment schemes. The aspect of enterprise-oriented customization is realized, in part, by the introduction of wizards into the new IM template framework.

The design of a representative system embodying an interaction manager targets the maintenance of a comprehensive real-time view of enterprise operations and information. Thus, by configuring the information technology (IT) platform with a framework that enables the enterprise to integrate its services, applications and data in real time, the enterprise can function as a zero latency enterprise (ZLE) and achieve enterprise-wide real-time view of its operations.

To enable one of ordinary skill in the art to make and use the invention, the description of the invention is presented herein in the context of a patent application and its requirements. Although the invention will be described in accordance with the shown embodiments, one of ordinary skill in the art will readily recognize that there could be variations to the embodiments and those variations would be within the scope and spirit of the invention.

I. Zero Latency Enterprise (ZLE) Overview

In the preferred embodiment, the present invention operates in the context of an information technology (IT) infrastructure that enables an enterprise to run as a zero latency enterprise (ZLE). As a preferred functional and architectural strategy, the interaction manager (IM) will be embodied in the ZLE framework. Namely, the IM is implemented as part of the scheme for reducing latencies in enterprise operations. This scheme enables the enterprise to integrate its services, business rules, business processes, applications and data in real time. In other words, it enables the enterprise to run as a ZLE.

A. The ZLE Concept

In integrating e-commerce into their business models enterprises have had to deal with the shortcomings of latencies in their operations, including their interaction with and responses to consumers. Zero latency allows an enterprise to achieve coherent operations, efficient economics and competitive advantage.

Notably, what is true for a single system is also true for an enterprise—reduce latency to zero and you have an instant response. An enterprise running as a ZLE, can achieve enterprise-wide recognition and capturing of business events that can immediately trigger appropriate actions across all other parts of the enterprise and beyond. Along the way, the enterprise can gain real-time access to a real-time, consolidated view of the its operations and data from anywhere across the enterprise. As a result, the enterprise can apply business rules and policies consistently across the enterprise including all its products, services, and customer interaction channels. As a further result, the entire enterprise can reduce or eliminate operational inconsistencies, and become more responsive and competitive via a unified, up-to-the-second view of customer interactions with any part(s) of the enterprise, their transactions, and their behavior. Moreover an enterprise running as a ZLE and using its feedback mechanism can conduct instant, personalized marketing scored and fine-tuned in real time while the customer is engaged. This result is possible because of the real-time access to the customer's profile and enterprise-wide rules and policies (while interacting with the customer). What is more, an enterprise running as a ZLE achieves faster time to market for new products and services, reduced exposure to fraud, customer attrition, and other business risks. In addition, an enterprise running as a ZLE has the tools for managing its rapidly evolving resources (e.g., workforce) and business processes.

B. The ZLE Framework and Architecture

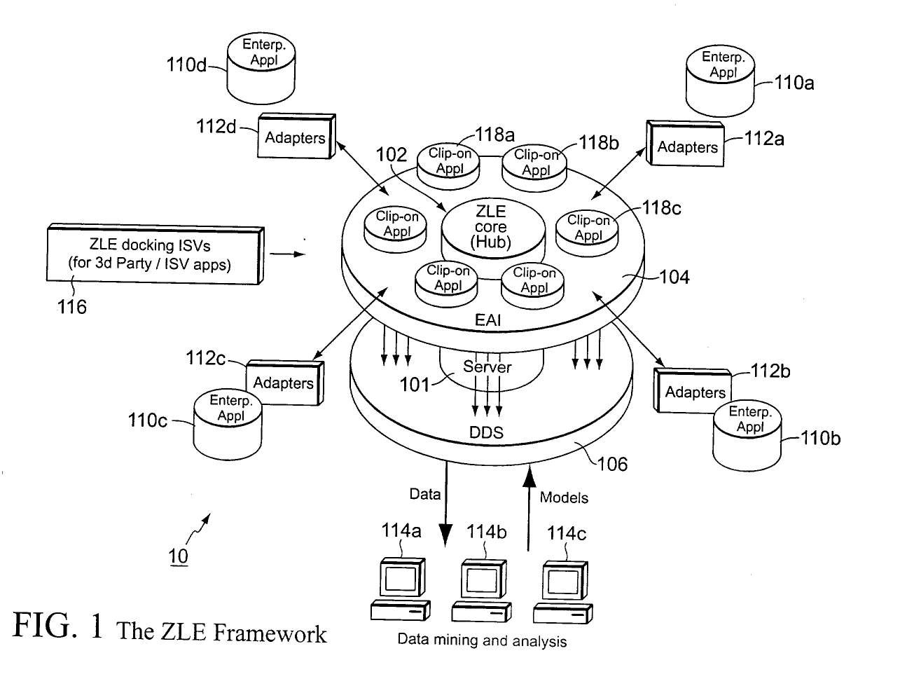

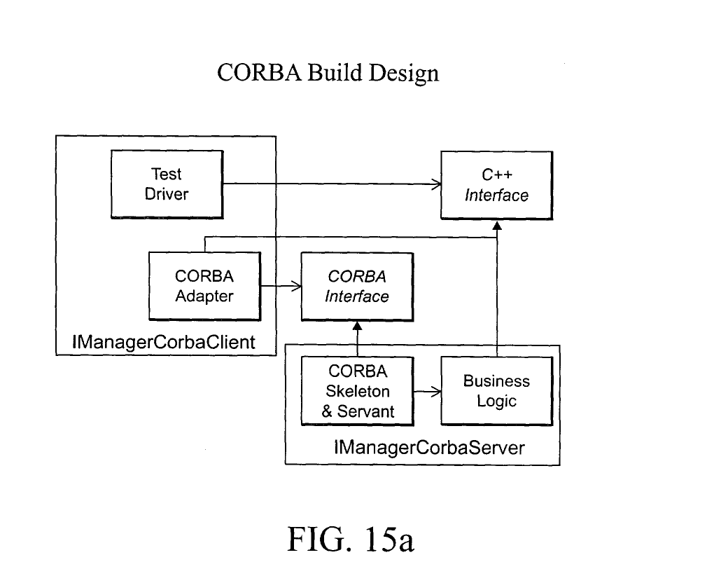

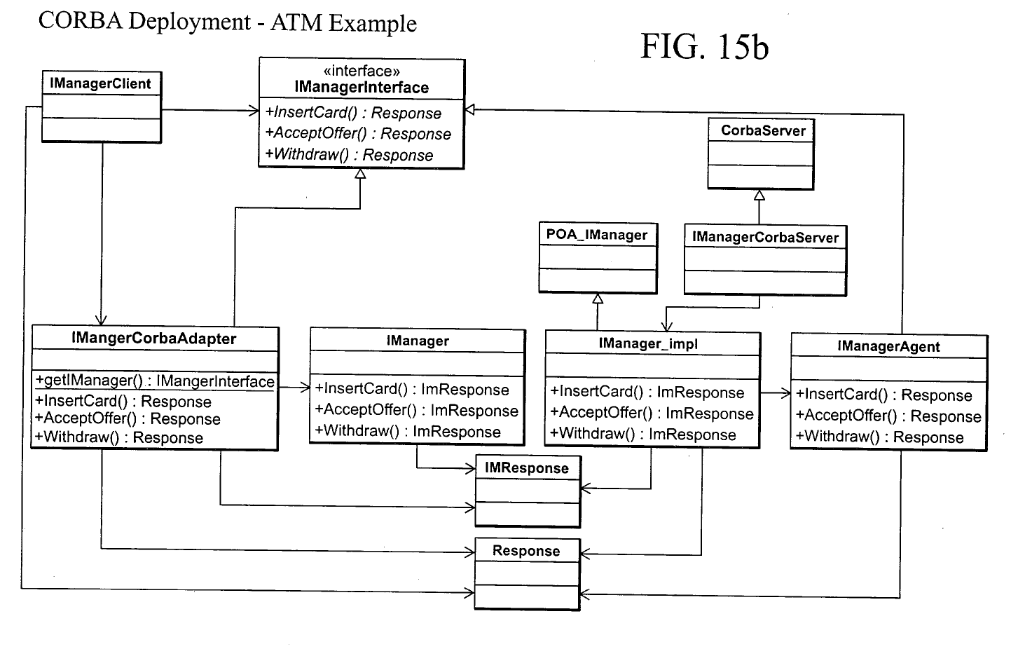

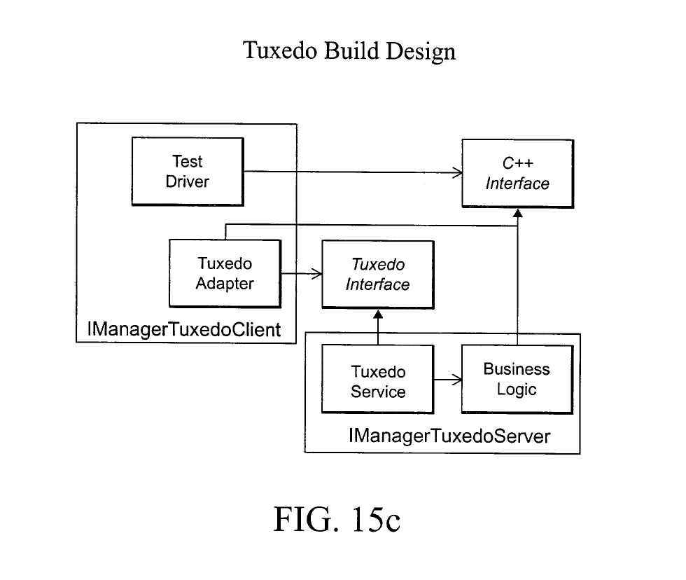

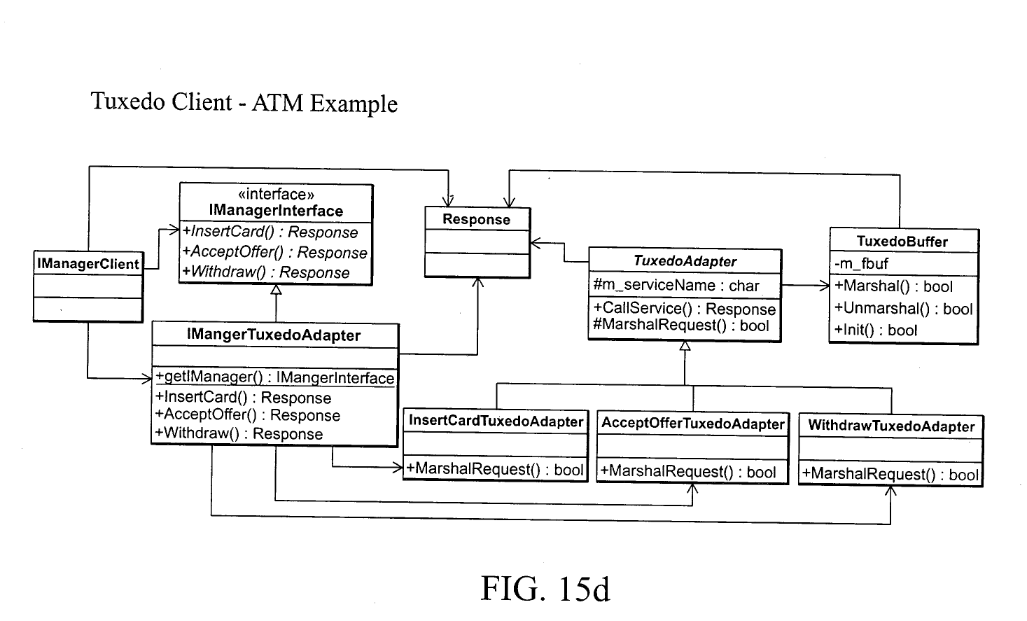

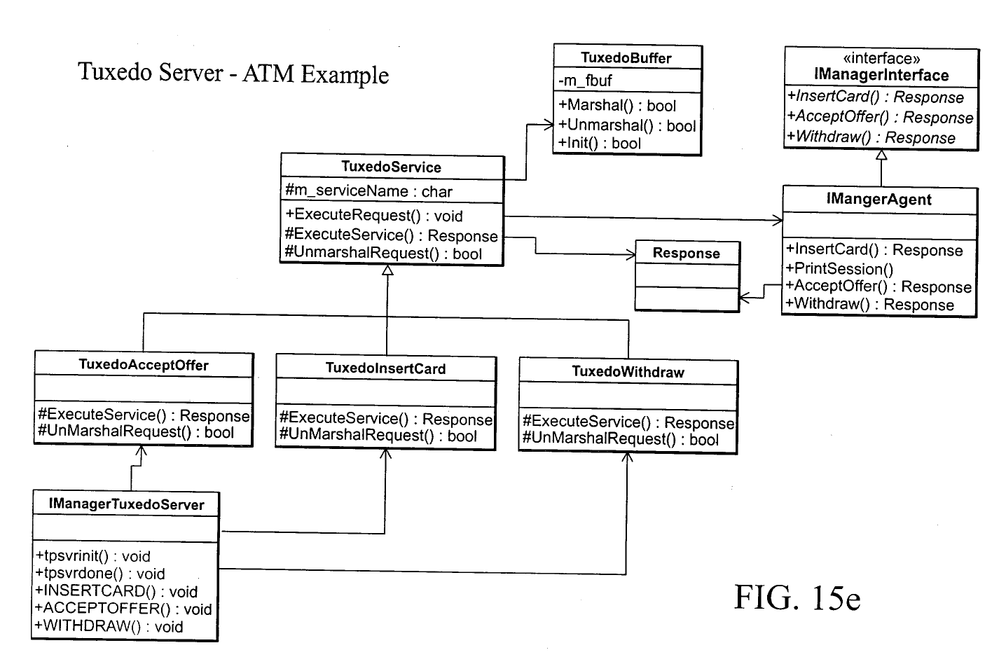

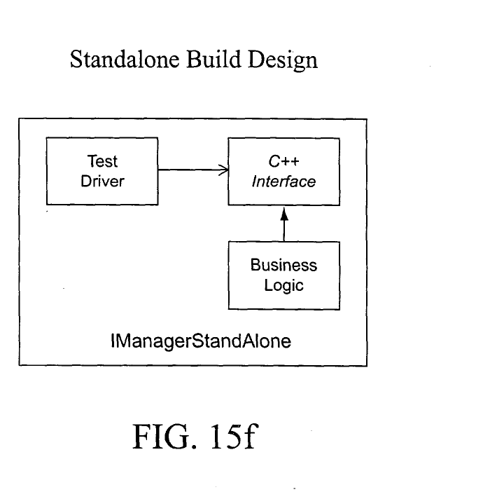

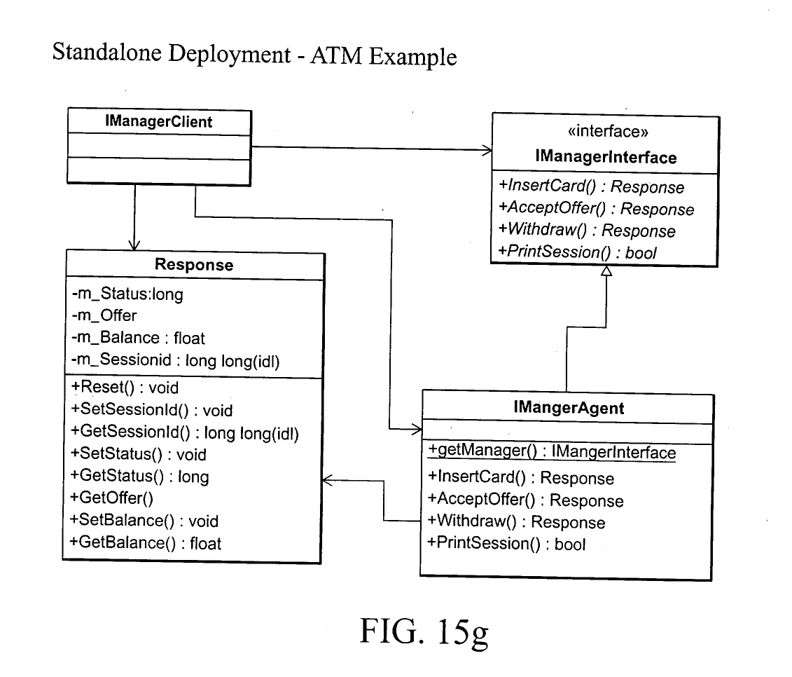

To become a zero latency enterprise, an enterprise integrates, in real time, its business processes, applications, data and services. Zero latency involves real-time recognition of business events (including interactions), and simultaneously synchronizing and routing information related to such events across the enterprise (as shown in FIG. 15a). As a means to that end, the aforementioned enterprise-wide integration for enabling the ZLE is implemented in a framework, the ZLE framework. FIG. 1 illustrates a ZLE framework.

As shown, the ZLE framework 10 defines a multilevel architecture, the ZLE architecture. This multilevel architecture provides much more than an integration platform with enterprise application integration (EAI) technologies, although it integrates applications and data across an enterprise; and it provides more comprehensive functionality than mere real time data warehousing, although it supports data marts and business intelligence functions. As a basic strategy, the ZLE framework is fashioned with hybrid functionality for synchronizing, routing, and caching, related data and business intelligence and for transacting enterprise business in real time. With this functionality it is possible to conduct live transactions against the ODS. For instance, the ZLE framework aggregates data through an operational data store (ODS) 106 and, backed by the ODS, the ZLE framework integrates applications, propagates events and routes information across the applications through the EAI 104. In addition, the ZLE framework executes transactions in a server 101 backed by the ODS 106 and enables integration of new applications via the EAI 104 backed by the ODS 106. Furthermore, the ZLE framework supports its feedback functionality via the data mining and analysis 114 and reporting mechanism (which are also backed by the ODS). Advantageously, the ZLE framework 10 is extensible in order to allow new capabilities and services to be added. Thus, the ZLE framework enables coherent operations and reduction of operational latencies in the enterprise.

The preferred ZLE framework 10 defines a ZLE architecture that serves as a robust system platform capable of providing the processing performance, extensibility, and availability appropriate for a business-critical operational system. The multilevel ZLE architecture is centered on a virtual hub, called the ZLE core (or ZLE hub) 102. The enterprise data caching functionality (ODS) 106 of the ZLE core is depicted on the bottom and its EAI functionality 104 is depicted on the top. Data mining and analysis applications 114 pull data from the ODS 106 at ZLE core 102 and contribute result models to it. The result models can be used to drive new business rules, actions, interaction management and so on. Although the data mining and analysis applications 114 are shown residing with systems external to the ZLE core, they can alternatively reside with the ZLE core 102. Clip-on applications 108, including the IM, are tightly coupled to the ZLE core 102 residing on top of the ZLE core and directly accessing its services. Enterprise applications 110, such as SAP's enterprise resource planing (ERP) application or Siebel's customer relations management (CRM) application, are loosely coupled to the ZLE core (or hub) 102 being logically arranged around the ZLE core and interfacing with it via application or technology adapters 112. The docking of ISV (independent solution vendors) solutions such as the enterprise applications 110 is made possible with the ZLE docking 116 capability. The ZLE framework's open architecture enables core services and plug-in applications to be based on best-of-breed solutions from leading ISVs. This, in turn, ensures the strongest possible support for the full range of data, messaging, and hybrid demands.

1. The ZLE Core

The ZLE core is a virtual hub for various specialized applications that can clip on to it and are served by its native services. Any specialized applications—including those that provide new kinds of solutions that depend on ZLE services, e.g., IM—can clip on to the ZLE core. The ZLE core is also a hub for data mining and analysis applications that draw data from and feed result—models back to the ZLE core. Indeed, the ZLE framework combines the EAI, ODS, OLTP (on-line transaction processing), data mining and analysis, automatic modeling and feedback, thus forming the touchstone hybrid functionality of every ZLE framework. To this functionality others can be added including the functionality of native and core ISV services and of clip-on and enterprise applications. Moreover, the ZLE core enables an array of enterprise applications (third party application) to interface to and become part of the ZLE framework.

The ZLE core components include an ODS acting as a central repository with cluster-aware RDBMS functionality, a transactions application server acting as a robust hosting environment for integration services and clip-on applications, and core services. These components are not only integrated, but the ZLE core is designed to derive maximum synergy from this integration. Furthermore, the services at the core of ZLE optimize the ability to integrate tightly with and leverage the ZLE architecture, enabling a best-of-breed strategy. They contribute essential ZLE services that enable a true Compaq ZLE™.

It is noted that Compaq®, Compaq ZLE™, AlphaServer™, NonStop™, and the Compaq logo, are trademarks of the Hewlett-Packard Company (formerly Compaq Computer Corporation of Houston, Tex.). True64™ is a trademark of Compaq information Technologies Group, L.P., and UNIX® is a trademark of the Open Group. Any other product names may the trademarks of their respective originators.

2. ZLE Core Services

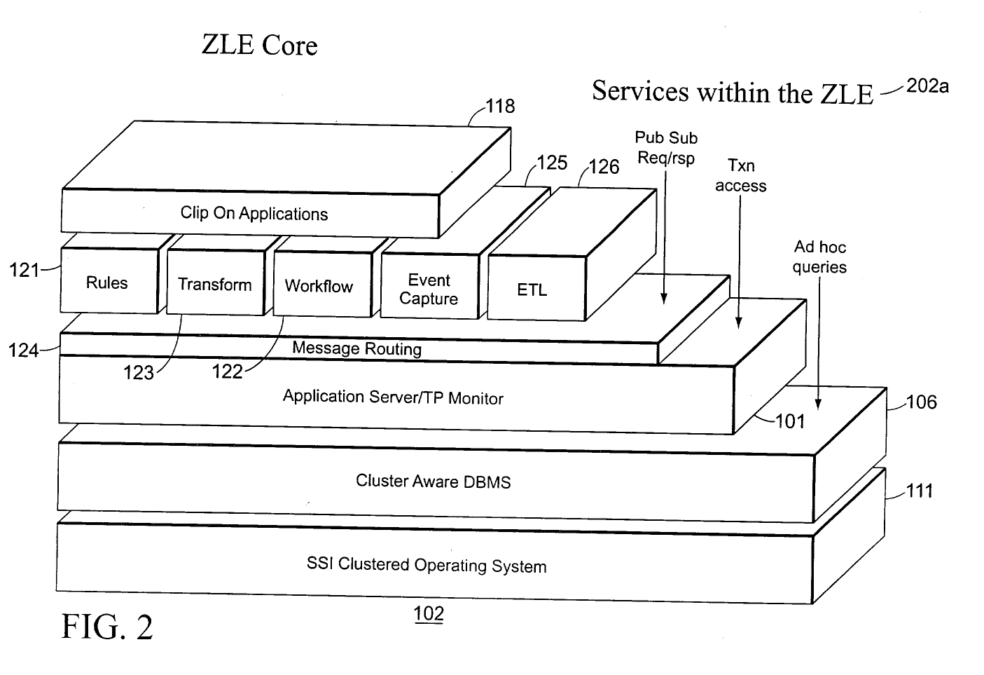

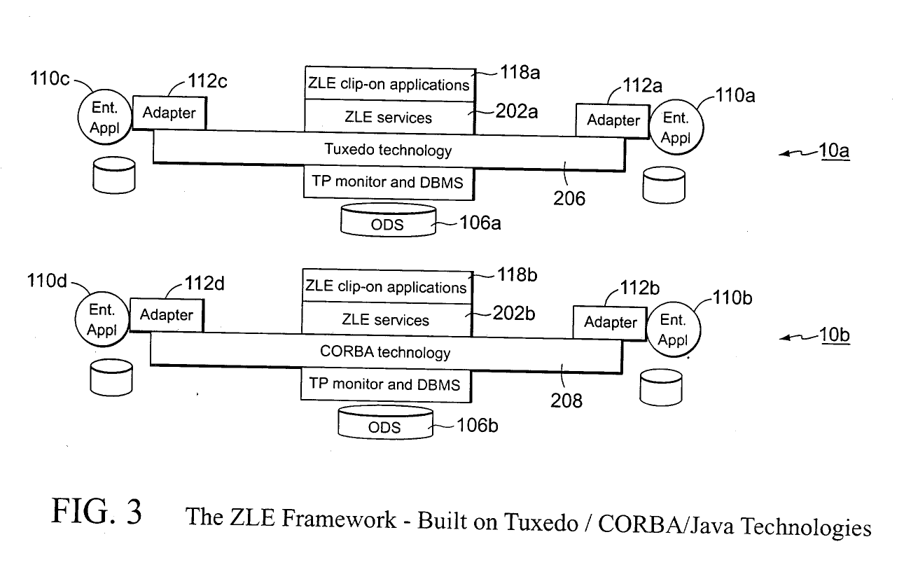

At the ZLE core of the ZLE framework resides a set of ZLE service—i.e., core services and capabilities—as shown in FIGS. 2 and 3. The core services 202 can be fashioned as native services and core ISV services (ISVs are third-party enterprise software vendors). The ZLE services (121-126) are preferably built on top of an application server environment founded on Tuxedo 206, CORBA 208 or Java technologies (CORBA stands for common object request broker architecture). The broad range of core services includes business rules, message transformation, workflow, and bulk data extraction services; and, many of them are derived from best-of-breed core ISVs services provided by Compaq, the originator of the ZLE framework, or its ISVs.

Among these core services, the rules service (121) is provided for event-driven enterprise-wide business rules and policies creation, analysis and enforcement. The rules service itself is a stateless server (or context-free server). It is not keeping track of the current state and goes back to the initial state. Incidentally, the rules service does not need to be implemented as a process pair because it is stateless, and a process pair is used only for a stateful server. It is just a server class so any instance of the server class can process it. Implemented using Blaze Advisor, the rules service enables writing business rules using graphical user interface or syntax like a declarative, English-language sentence. Additionally, in cooperation with the interaction manager, the rules service is designed to find and apply the most applicable business rule upon the occurrence of an event. Based on that, the rules service is designed to arrive at the desired data (or answer) which is uniform throughout the entire enterprise. Hence this service may be referred to as the uniform rules service. This service allows the ZLE framework to provide a uniform rule-driven environment for flow of information and supports its feedback mechanism (through the IM). The rules service can be used by the other services within the ZLE core, and any clip-on and enterprise applications that an enterprise may add, for providing enterprise-wide uniform treatment of business rules and transactions based on enterprise-wide uniform rules.

The extraction, transformation, and load (ETL) service (126) enables large volumes of data to be transformed and moved quickly and reliably in and out of the database (often across databases and platform boundaries). The data is moved for use by analysis or operational systems as well as by clip-on applications.

The message transformation service (123) maps differences in message syntax, semantics, and values, and it assimilates diverse data from multiple diverse sources for distribution to multiple diverse destinations. The message transformation service enables content transformation and content-based routing, thus reducing the time, cost, and effort associated with building and maintaining application interfaces.

The workflow (process flow) service 122 is provided for supporting global business transactions across multiple systems, and for mapping and controlling the flow of short or long term business transactions across the enterprise. The workflow (or process-flow) service manages the flow of business transactions and processes between multiple systems and applications that are integrated via the ZLE framework and may take only seconds or up to days to execute. This entails monitoring and managing ongoing transactions as well as ensuring the correct flow of business transactions. The workflow service leverages the state engine capabilities of the ZLE core database to track the state of the transaction—and provide visibility into its progress—over the ensuing hours, days, and weeks it takes to run its course.

The parallel message router and inserter service (124) is provided for high performance, high-volume routing, and insertion of transaction event data into the ODS and other ZLE services and applications. Message routing may involve the rules and workflow services of the ZLE core. These services may intervene to determine where particular messages are to be routed based on content and predefined workflow process. A powerful message routing and insertion capability is designed for routing high volumes of messages through the ZLE architecture. To propagate high volumes of messages to the database and elsewhere within the ZLE framework, the router and inserter function leverages the parallelism of the ZLE platform. This capability can further include content-based routing and use of the ODS as a database management system that can store transactions in SQL tables and as a centralized message store and queuing system for efficient publish/subscribe message distribution. Constantly refreshed information, such as stock prices or data on inventory levels, can be inserted into the ODS and then published to the appropriate subscriber.

Essentially, this message routing and insertion capability is routing between the internal components of the ZLE core. Hence, although the ZLE framework supports message oriented middleware (MOM), this capability differs from the functionality of routing and queuing systems that move messages from application to application.

3. Server Platform

Fundamentally, the ZLE framework includes elements that are modeled after a transaction processing (TP) system. In broad terms, a TP system includes application execution and transaction processing capability, one or more databases, tools and utilities, networking functionality, an operating system and a collection of services that include TP monitoring. A key component of any TP system is a server. The server is capable of parallel processing, and it supports concurrent TP, TP monitoring and management of transactions-flow through the TP system. The application server environment advantageously can provide a common, standard-based framework for interfacing with the various ZLE services and applications as well as ensuring transactional integrity and system performance (including scalability and availability of services). Thus, the ZLE services (121-126) are executed on a server, preferably a clustered server platforms 101 such as the Hewlett-Packard NonStop™ server. These clustered server platforms 101 provide the parallel performance, extensibility (e.g., scalability), and availability requisite for business-critical operations.

In one configuration, the ODS is embodied in the storage disks within such server system. NonStop™ server systems are highly integrated fault tolerant systems and do not use externally attached storage. The typical NonStop™ server system will have hundreds of individual storage disks housed in the same cabinets along with the CPU's, all connected via a server net fabric. Although all of the CPU's have direct connections to the disks (via a disk controller), at any given time a disk is accessed by only one CPU (one CPU is primary, another CPU is backup). One can deploy a very large ZLE infrastructure with one NonStop™ server node. In one example the ZLE infrastructure is deployed with 4 NonStop™ server nodes. In another example, the ZLE infrastructure is deployed with 8 NonStop™ server nodes.

It is noted that in the present configuration the data mine is set up on a Windows NT or a Unix system because present (data mining) products like SAS' are not suitable for running directly on the NonStop™ server systems. SAS is a third party application specializing in data mining. The Genus Mart Builder is a component pertaining to the data preparation area where you are collecting aggregates and moving them down into SAS. Future configurations with a data mine may use different platforms as they become compatible.

4. Clip-On Applications

Clip-on applications 118, literally clip on to, or are tightly coupled with, the ZLE core 102. They are not standalone applications in that they require the substructure of the ZLE core and its services (e.g., native core services) in order to deliver highly focused, business-level functionality of the enterprise. Clip-on applications, provide business-level functionality that leverages the ZLE core's real-time environment and application integration capabilities and customizes it for specific purposes. ISVs (such as Trillium, Recognition Systems, and MicroStrategy) as well as the originator of the ZLE framework (Hewlett-Packard Corporation, formerly Compaq Computer Corporation) can contribute value-added clip-on applications such as for fraud detection, customer interaction and personalization, customer data management, narrowcasting notable events, and so on. A major benefit of clip-on applications is that they enable enterprises to supplement or update its ZLE core native or core ISV services by quickly implementing new services. Examples of clip-on applications include the interaction manager, narrowcaster, campaign manager, customer data manager, and more. The following describes these examples in some detail.

The interaction manager (IM) application (by Hewlett-Packard Corporation) leverages the rules engine 121 within the ZLE core to define complex rules governing customer interactions across multiple channels. The IM also adds a real-time capability for inserting and tracking each customer transaction as it occurs so that relevant values and more can be offered to consumers based on real-time information. More details on the IM will be provided later in this description.

The narrowcaster application preferably uses MicroStrategy software that runs against the relational database of the ODS in order to notify a notable event (hence it is also called notification application). Notable events are detected within the ZLE framework in real-time. Then, sharing data (in the ODS) that the IM and rules engine have used to assert the notable event, the narrowcaster selectively disseminates a notification related to such events. The notification is narrowcasted rather than broadcasted (i.e., selectively disseminates) to terminals, phones, pagers, and so on of specific systems, individuals or entities in or associated with the enterprise.

The campaign manager application can operate in a recognition system such as the data mining and analysis system (114, FIG. 1) to leverage the huge volumes of constantly refreshed data in the ODS of the ZLE core. The campaign manger directs and fine-tunes campaigns in real time based on real-time information gathered in the ODS.

The customer data manager application leverages customer data management software to synchronize, delete, duplicate and cleanse customer information across legacy systems and the ODS at the ZLE core in order to create a unified and correct customer view.

5. Extending ZLE via Enterprise Applications and Adapters

The ZLE core architecture is designed to evolve with changes in the business environment of the enterprise. Enterprise applications (typically specialized ISV solutions), such as PeopleSoft, SAP's ERP or Siebel's CRM applications, can “dock” on the ZLE core via adapters. The adapters enable normalized messaging for exchanges among standard applications (such as SAP, PeopleSoft, popular Web server applications, and so on) as well as exchanges with custom applications. There are other architectural and functional requirements that the adapters support, including allowing, for example, legacy environments and diverse databases to join the ZLE framework.

Enterprise applications are loosely coupled to the ZLE core, the clip-on applications and other third party enterprise application (or ISV solutions). When so interfaced, an enterprise application becomes a logical part of the ZLE framework and shares that data with all the other applications through its ZLE data store (ODS). Enterprise applications differ from the tightly coupled clip-on applications in that they can stand alone, without the benefit of the ZLE framework. However, their value to the enterprise is increased immensely by integration with the ZLE framework. In some cases, these applications are the “end-consumers” of the ZLE architecture. In others, they provide much of its fodder in the form of information and specialized procedures of the enterprise. Typically, as enterprise applications integrate or interface via the ZLE framework with other applications and systems across the enterprise they play both roles—i.e., taking and providing information in real time. Notably, the information applications take and provide is centrally warehoused in the ODS, more details of which are hereafter provided.

6. Operational Data Store (ODS) with Cluster-Aware RDBMS Functionality

The ODS with its relational database management system (RDBMS) functionality is integral to the ZLE core and central to achieving the hybrid functionality of the ZLE framework (106 FIG. 1). The ODS 106 provides the mechanism for dynamically integrating data into the central repository or data store for data mining and analysis, and it includes the cluster-aware RDBMS functionality for handling periodic queries and for providing message store functionality and the functionality of a state engine. Being based on a scalable database, the ODS is capable of performing a mixed workload. The ODS consolidates data from across the enterprise in real time and supports transactional access to up-to-the-second data from multiple systems and applications, including making real-time data available to data marts and business intelligence applications for real-time analysis and feedback. For the purpose of publish and subscribe as will be further detailed below, the ODS is managed using database extractors and database loaders technologies.

As part of this scheme, the RDBMS is optimized for massive real-time transaction and loads, real-time queries, and batch-extraction. The cluster-aware RDBMS is able to support the functions of an ODS containing current-valued, subject-oriented, and integrated data reflecting the current state of the systems that feed it. As mentioned, the preferred RDBMS can also function as a message store and a state engine, maintaining information as long as required for access to historical data. It is emphasized that ODS is a dynamic data store and the RDBMS is optimized to support the function of a dynamic ODS.

The cluster-aware RDBMS component of the ZLE core is, in this embodiment, either the NonStop™ SQL database running on the NonStop™ server platform. In supporting its ODS role of real-time enterprise data cache, the RDBMS contains preferably three types of information: state data, event data and lookup data. State data includes transaction state data or current value information such as a customer's current account balance. Event data includes detailed transaction or interaction level data, such as call records, credit card transactions, Internet or wireless interactions, and so on. Lookup data includes data not modified by transactions or interactions at this instant (i.e., an historic account of prior activity).

Overall, the RDBMS is optimized for application integration as well as real-time transactional data access and updates and queries for business intelligence and analysis. For example, a customer record in the ODS (RDBMS) might be indexed by customer ID (rather than by time, as in a data warehouse) for easy access to a complete customer view. In this embodiment, key functions of the RDBMS includes dynamic data caching, historical or memory data caching, robust message storage, state engine and real-time data warehousing.

The state engine functionality allows the RDBMS to maintain real-time synchronization with the business transactions of the enterprise. The RDBMS state engine function supports workflow management and allows tracking the state of ongoing transactions (such as where a customer's order stands in the shipping process) and so on.

The real-time data warehousing function of the RDBMS supports the real-time data warehousing function of the ODS. This function can be used to provide data to data marts and to data mining and analysis applications.

The dynamic data caching function aggregates, caches and allows real-time access to real-time state data, event data and lookup data from across the enterprise. Advantageously, this function, for example, obviates the need for contacting individual information sources or production systems throughout the enterprise in order to obtain this information. As a result, this function greatly enhances the performance of the ZLE framework.

The historical data caching function allows the ODS to also supply a historic account of events that can be used by newly added enterprise applications (or clip-on applications such as the IM). Typically, the history is measured in months rather than years. The historical data is used for enterprise-critical operations including for transaction recommendations based on customer behavior history.

The state engine functionality allows the RDBMS to maintain real-time synchronization with the business transactions of the enterprise. The state engine function supports workflow management and allows tracking the state of ongoing transactions (such as where a customer's order stands in the shipping process) and so on.

The robust message store function supports the EAI platform for ZLE core-based publish and subscribe operations. Messaging functions in the ZLE framework may involve a simple messaging scenario of an EAI-type request-response situation in which a call-center application requests information on a particular customer from a remote billing application. The call-center application issues a Tuxedo or CORBA call that the transformation service in the ZLE core maps to a Tuxedo call for communicating with the remote application. Billing information flows back to the call center through a messaging infrastructure. Performing publish and subscribe through the relational database enables the messaging function to leverage the parallelism, partitioning, and built-in manageability of the RDBMS platform. This platform supports priority, first-in/first-out, guaranteed, and once-and-only-once delivery. More details about publish and subscribe operations are provided below.

7. Enriched Publish and Subscribe Functionality

In general, publish and subscribe refers respectively to pushing data into and pulling data out of a system. Pushing data involves operations such as allocating, writing, inserting and/or saving data. Pulling data involves operations such as selecting, requesting, reading, and/or extracting data. Puling and pushing data may additionally involve sending and/or receiving the data by means of messages.

In the ZLE context, publish and subscribe operations are responsive to applications that subscribe to the ZLE framework. Subscribing applications ask for specific information whenever certain business events occur (e.g., customer interactions). These applications could be Web server, call center, or fraud detection applications in search of changes in a consumer's credit status; or they could be electronic catalog or supply chain applications dependent on receiving the most current inventory status. When events occur, an adapter publishes the change to the ZLE framework. The appropriate ZLE core service then formats the messages correctly and pushes them to the subscribing applications, where they are filtered through the application adapters.

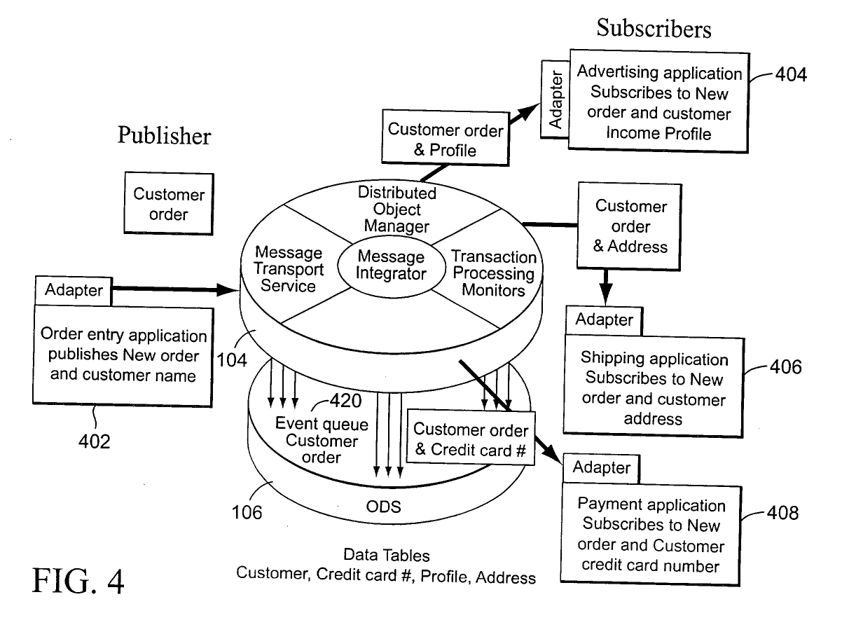

FIG. 4 illustrates the ZLE framework configuration for publish and subscribe operations. In the ZLE framework, ZLE core-based publish and subscribe operations involve EAI tools for performing message functions, while database and application servers are in charge of transaction and data functions. Data related to real-time operations of the enterprise is cached in the ODS using database extractors, database loaders and application adapter technologies to retrieve it. Using these technologies, the ZLE framework synchronizes information across the enterprise using the enriched publish and subscribe operations (supported by the ODS and EAI tools).

As shown, for message publishing (pushing to ODS) and message subscription (pulling from ODS and dissemination), the RDBMS caches and queues messages (420) for subscribers (relating for example to specific events, e.g, customer interactions, and their results). Data can be published by an application (e.g., 402) to the ODS 106 for formatting and insertion into a database table. The data can then be routed out of the ODS to multiple subscriber applications (e.g., 404, 406, 408). In this way, the innate parallelism, scalability, and reliability of the database can be leveraged, along with its management capabilities, to ensure an efficient flow of subscriber messages. Of course, the current information contained in the database tables is also available for ad hoc querying or for bulk shipment to analytic applications, data marts, and so on.

Notably, the ability of the ODS to cache data can be used to enrich the messages that pass through the ZLE framework. Similarly, information cached in the ODS for distribution to subscribers can pick up additional data that has been cached there by other applications. For example, a business-to-business customer wants to make an online purchase. As the ZLE architecture pulls together current inventory and pricing information, it can enrich it with personalized customer-specific data from its data store regarding special offers on related products—information that is invisible to the inventory system.

Although the ZLE framework supports message oriented middleware (MOM), its message routing capability differs from the scheme of routing and queuing messages that are moved from application to application. Indeed, with the ZLE framework the number of information requests to the system (including legacy applications and native core services), can be reduced and the overloading of the legacy system can be avoided.

The ZLE hub can minimize the number of messages by enriching the first message of each new event with the information that the legacy applications need in order to complete their task. The ZLE hub is pre-configured to know what sets of information these applications need as each legacy application identifies the events, type(s) of data changes and associated information in which it is interested. The legacy application then registers this request with a ZLE enriched publish-subscribe service provider module. The ZLE enriched publish-subscribe service provider module stores this pre-configured information request in the operational data store. When a new business event such as a new order arrives at the ZLE, the ZLE hub writes this information into the operational data store. This action in turn triggers an indication that some applications are subscribing to that event.

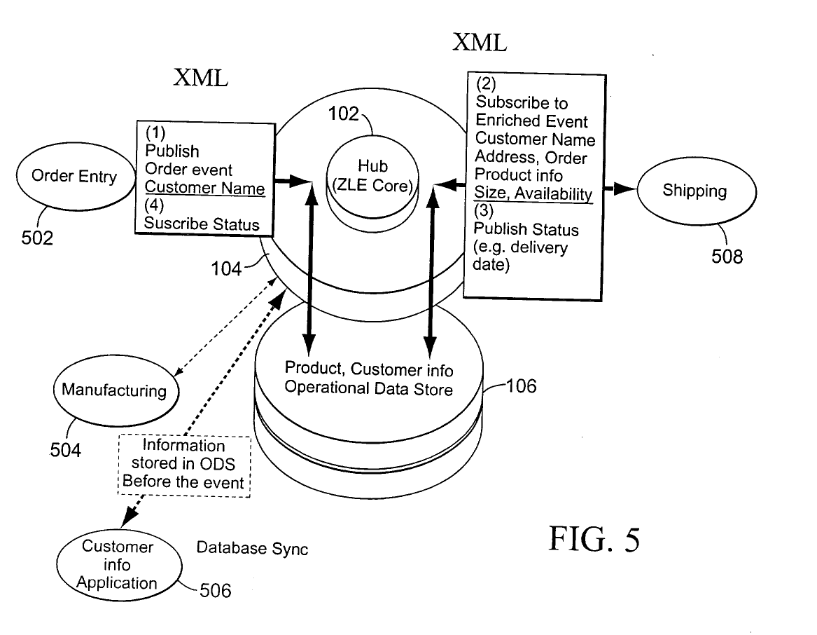

For example, before sending the order message to the shipping application in response to an order event, the ZLE hub enriches the order message with the customer address, product size and availability information (see, e.g., FIG. 5). In this way, the number of messages across the enterprise is reduced to half. Furthermore, there is no load imposed on applications that were not taking part in the transactions. Thus, In an enterprise running as a ZLE, when a business event (e.g., order) arrives at the ZLE hub and a message is sent to the shipping application, the shipping application does not need to create multiple requests and responses to other applications. Rather, it will subscribe or send a message only to the ZLE hub for information about product size and availability. Since the information is already cached in an operational data store (ODS), the ZLE hub is in a position to respond to the request directly. The shipping application then asks the ZLE hub for information about the customer address. The ZLE hub provides that piece of information without the need to also ask another application. As will be explained with reference to the interaction manager (IM), this information is cached in the ZLE hub whenever the customer interacts with the enterprise for the first time or whenever this information is subsequently changed.

With this architecture, the load on legacy applications is drastically reduced since the information is provided directly from the ODS at the ZLE hub and not from the legacy applications. The legacy applications update the information at the ODS on their own time, and only when some of the information in their environment changes, such as when a customer calls to change a home address.

In sum an enterprise equipped to run as a ZLE is capable of integrating, in real time, its enterprise-wide data, applications, business transactions, operations and values. Consequently, an enterprise conducting its business as a ZLE exhibits superior management of its resources, operations, supply chain and customer care.

II. ZLE Development Kit (ZDK)

In one embodiment, an interaction manager (IM) deployment template is provided in the ZDK (ZLE development kit), which is the tool kit that creates ZLE applications such as the IM (these applications are referred to above “the clip-on applications”). Although later versions of ZDK, e.g. ZDK2, are more suited for embodying the present invention, for simplicity we refer to them in general as “ZDK” to simplify the discussion.

Notably, the ZDK includes an IM template for creating the IM. Although the rules service template for creating the rules service will not be discussed here, in some instances one might want to think of the IM template as broadly encompassing both of those templates. For each template, there is an application deployment user guide with step-by-step instructions for completing the particular application. The IM template supports both Tuxedo and CORBA deployment to allow applications and services to run on top of CORBA or on top of Tuxedo (although other platforms can be supported as well).

Incidentally, to create the template for the IM it was necessary to refactor the IM. Refactoring is a term used in object oriented programming to describe code restructuring technique to effect program transformation. With object oriented programming, as the classes are redesigned, methods have to be moved from one class to another class where they have better cohesion with the other methods of that class or the properties of that class (as opposed to merely making them visible from one class to another; especially if there is a poor object design with too many links, and all classes are pointing (reference) all the other classes. By refactoring, things are moved around to refine the design. The IM had to be refactored in order to make it into a template because, initially, much of the business specific logic and reusable objects were scattered all over the place.

In the ZDK, each template provides a framework of wizards that generate code frames. Additional wizards are provided with the ZDK so as to allow incremental addition of functionality to applications such as the IM. Wizards are framed as scripts (a list of commands) that are used to generate the code frames. Perl (practical extraction and reporting language) is a cross platform scripting language that is preferably used in fashioning the wizards. Perl scripts are typically plain text files made up of Perl statements and Perl declarations. The scripts are not interactive hence the wizards are not interactive. The wizards are invoked by calling a file or directly from a command line. When the Perl command is used to run the scripts with the Perl interpreter the command looks for the script(s) line-by-line or in a file named in the command line.

In addition, the ZDK includes example applications that were built from the templates. An example will typically include more than one application built from more than one template, and although the templates are generic the example is industry specific. In one embodiment, the ZDK includes two examples of IM built from the IM template (the ATM and eCRM examples). These examples can help one understand how the IM template works and what a completed IM looks like.

The ATM example is based on the scenario of an ATM (automated teller machine) controller. In this example the customer is unambiguously identifiable via an ATM card number supplied at the start of the session, within the InsertCard interaction type. This interaction returns a new session ID. The other interaction types require the client to supply this session ID within the request interactions CheckBalance and WithdrawCash.

The eCRM example is based on the scenario of an online store. It illustrates the identification of sessions by cookies as it allows the guest to be anonymous or obscurely identified. It includes interaction types such as BrowseItem and AccountMaint.

Incidentally, the ZDK includes examples of services such as customer management, data cleansing and data enrichment services (used in eCRM context). For example, a CRM application may be required to display some interaction history and for that it interfaces with the customer manager. The customer manager pulls out that history and hands it back to the CRM application. This information is available to the customer manager (at the ODS), but the customer manager owns the customer information. Now and then it also uses data cleansing server class (e.g., Trillium) and data enrichment server class (Acxiom).

III. Interaction Manager

A. Overview

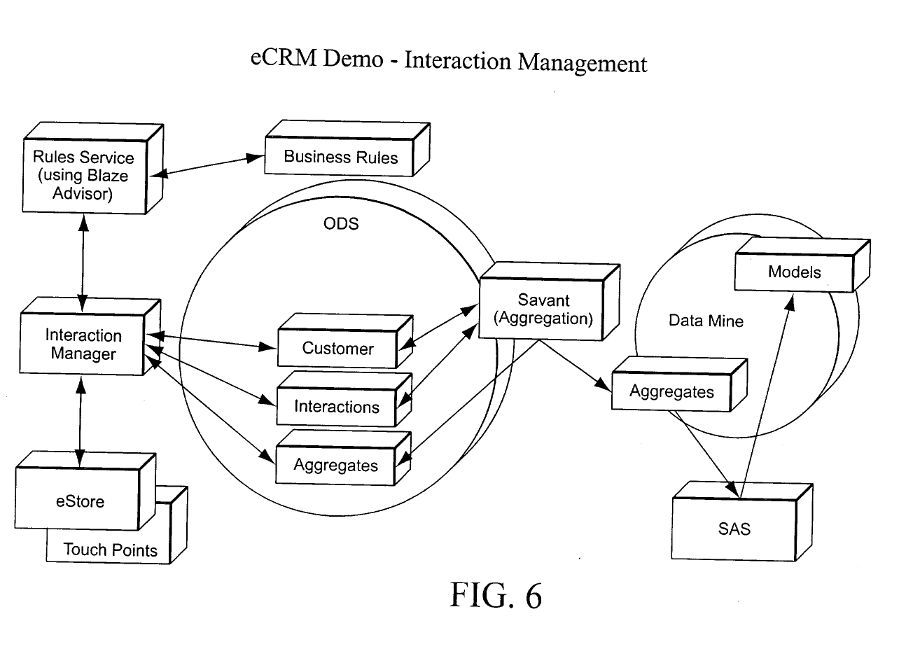

The interaction manager (IM) application is created from the IM template (in a manner as will be later explained). An example of IM deployed for eCRM is shown in FIG. 6. The IM interacts with the other ZLE components via the ODS. As noted above, the IM application leverages the rules engine within the ZLE core to define complex rules governing customer interactions across multiple channels. The IM also adds a real-time capability for inserting and tracking each customer transaction as it occurs, so that relevant offers could be made to consumers based on real-time information. The IM is a scalable stateless server class that maintains an unlimited number of concurrent customer sessions.

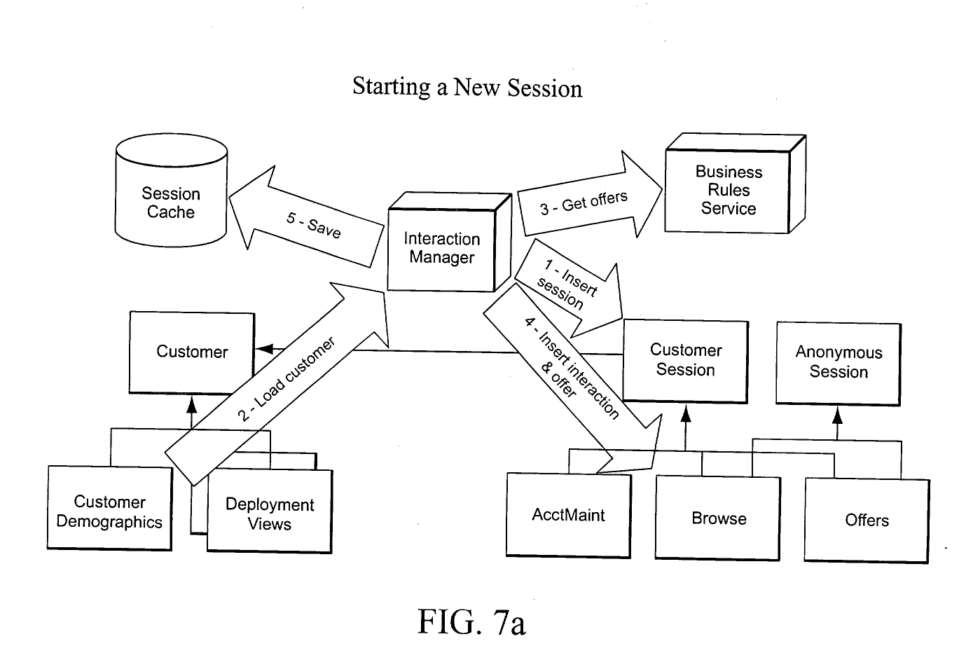

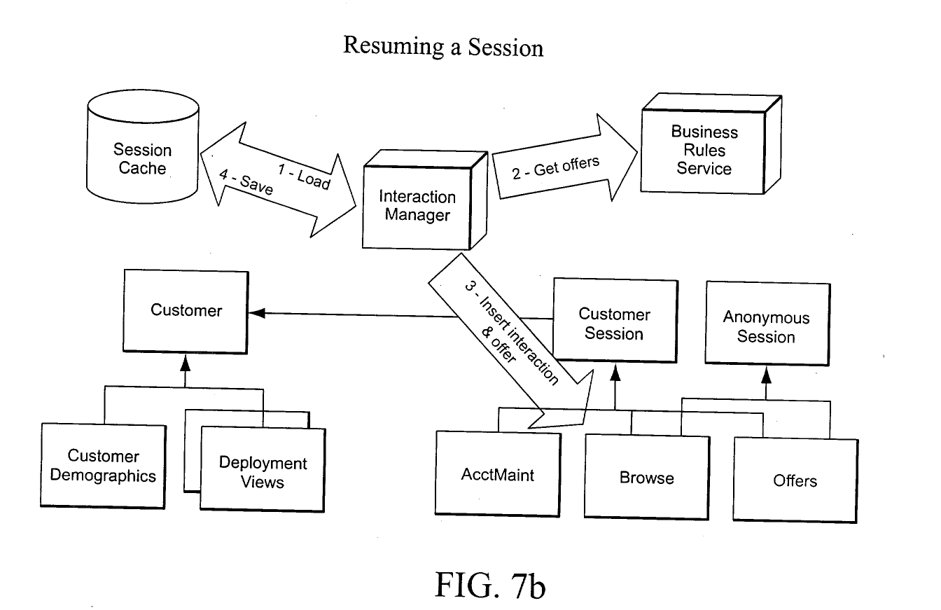

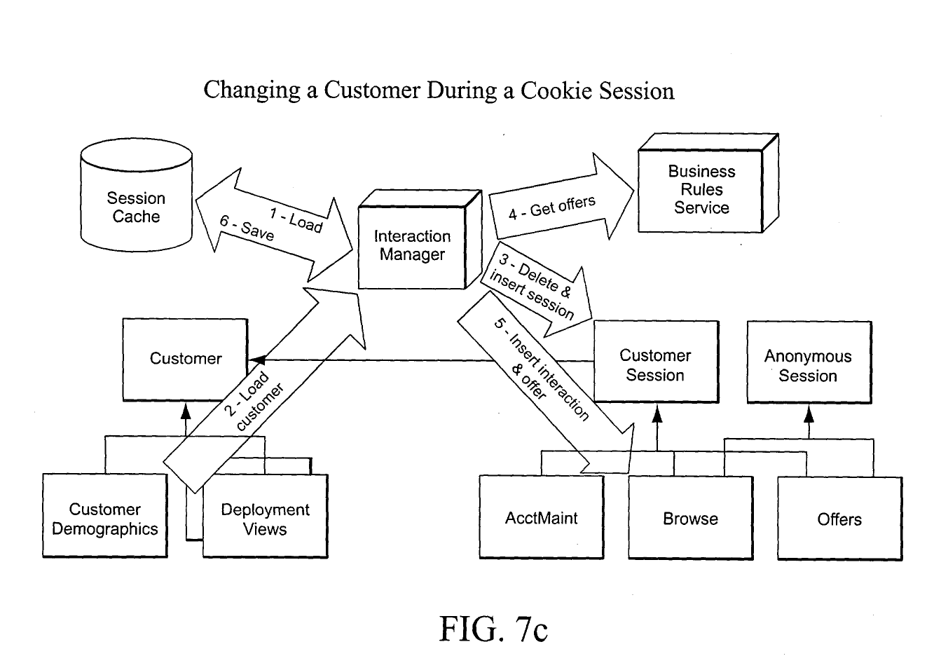

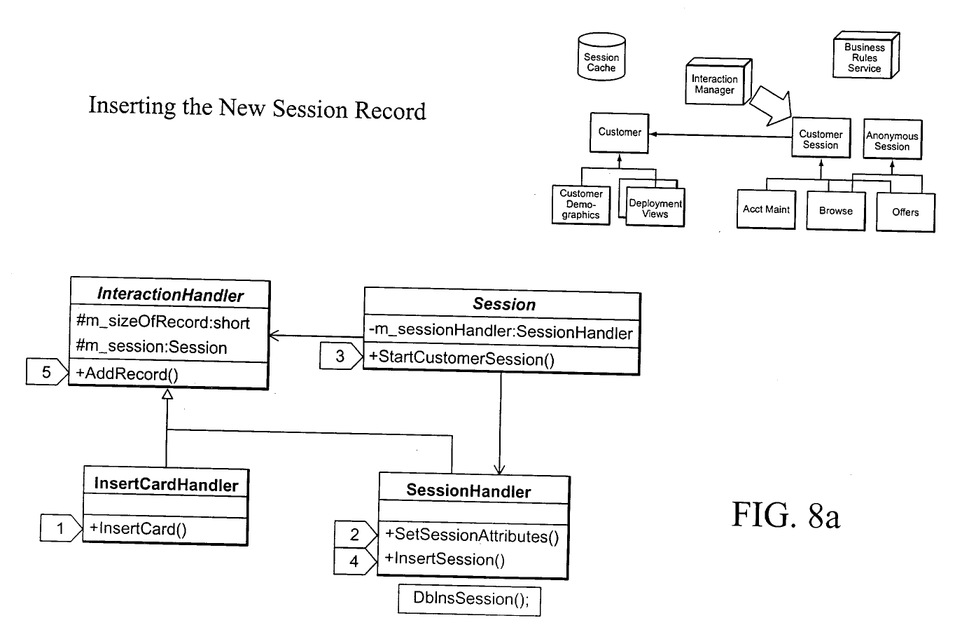

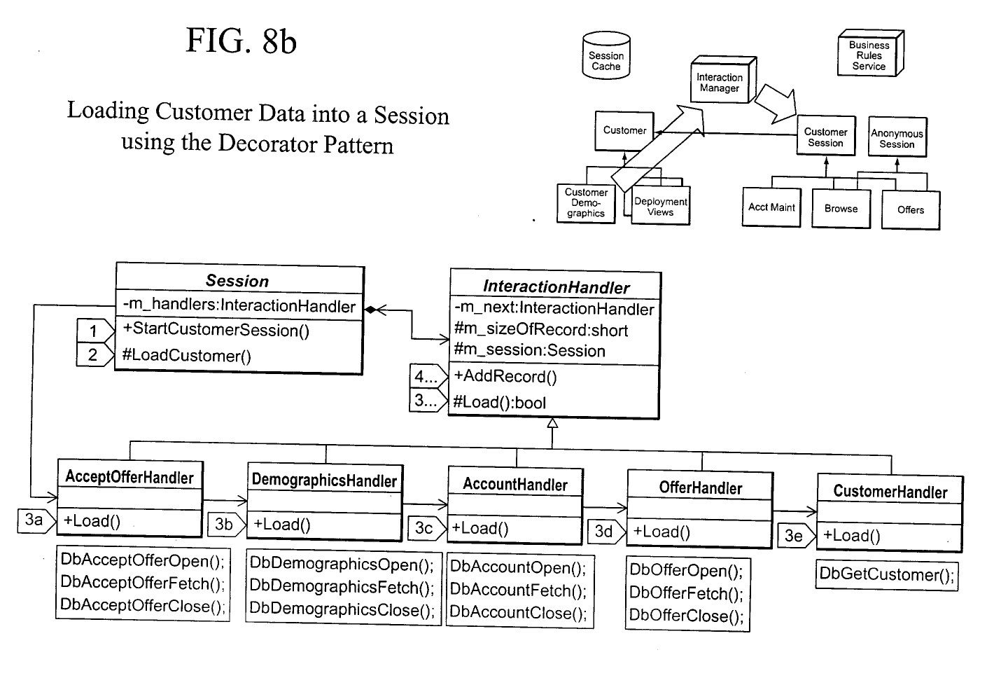

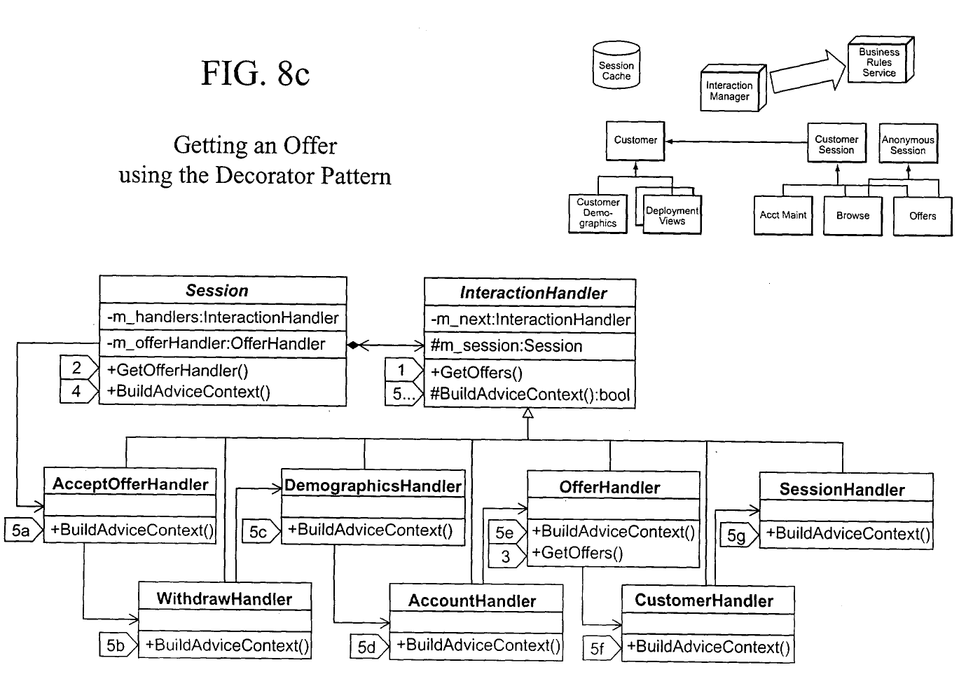

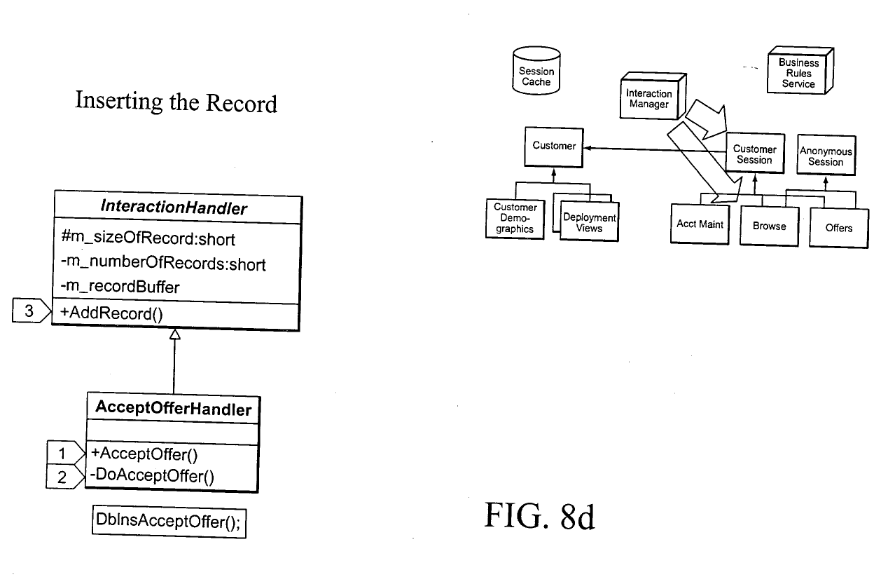

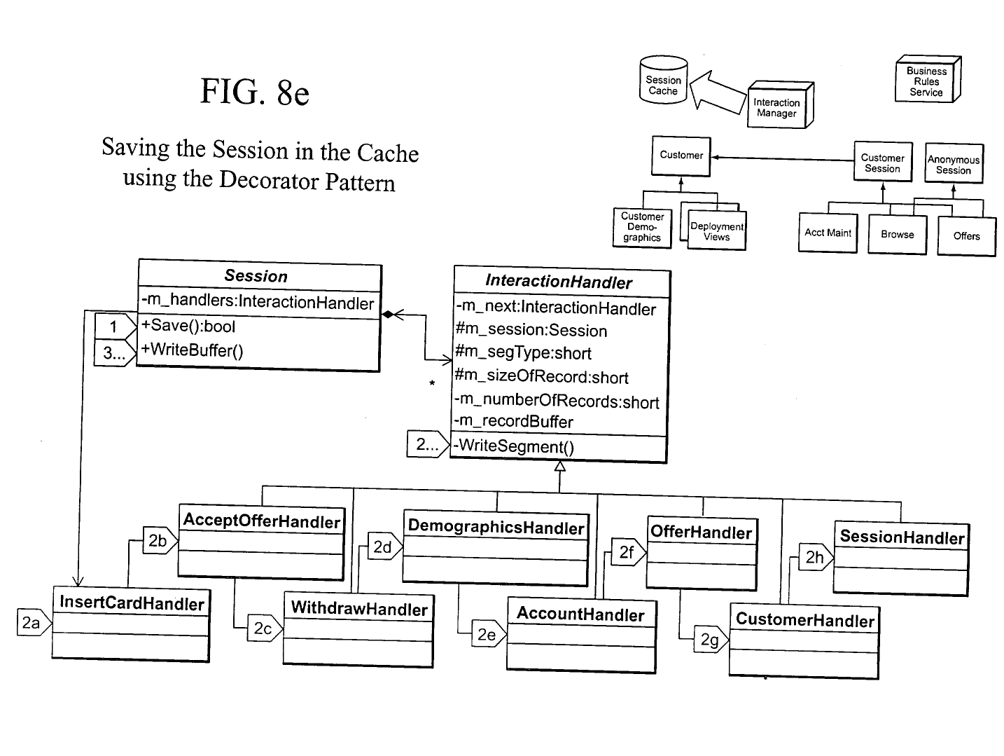

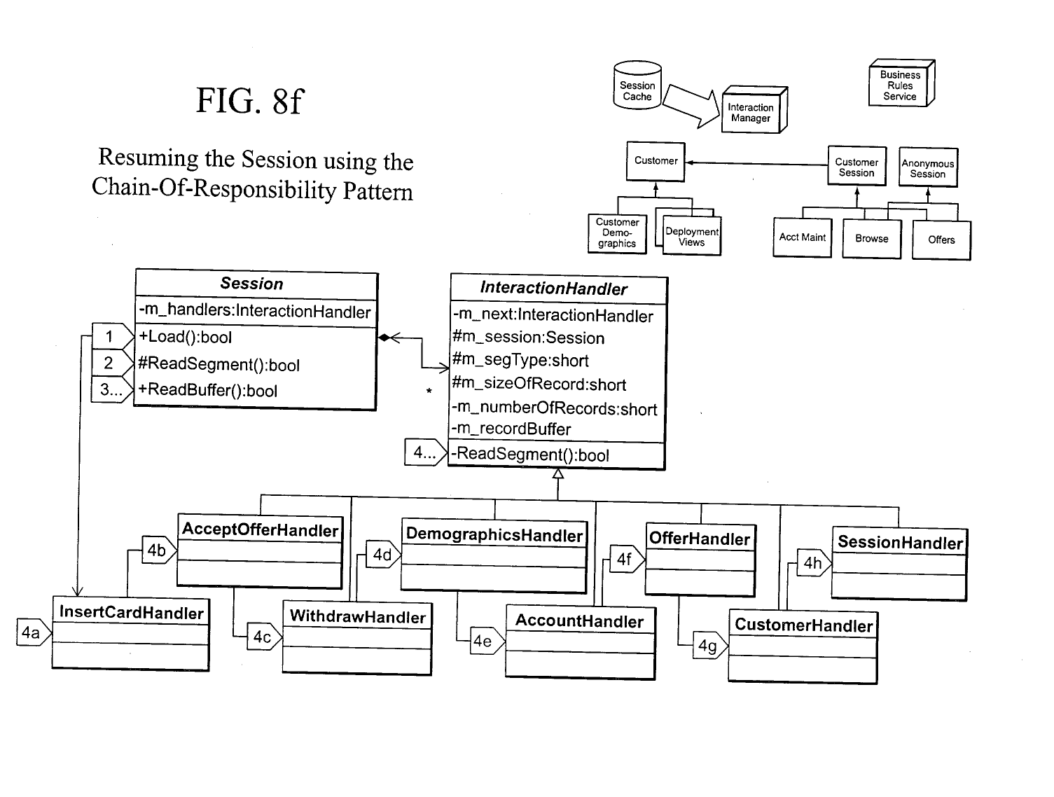

The IM provides a way of initiating and resuming sessions, each session consisting of one or more interactions (transactions). FIGS. 7a-c, show the flow of information during a session under the control of the IM. FIGS. 8a-f, illustrate the class framework for the IM handling of session records, customer data loading, getting offers and resuming sessions. As illustrated, the IM provides mechanisms for loading customer-related data at the beginning of a session, for caching session context (including customer data) after each interaction, for restoring session context at the beginning of each interaction and for forwarding session and customer data to a business rules service in order to obtain recommendations or offers. The IM stores session context in a table (e.g., NonStop SQL table).

As a support for enterprise customers who access the ZLE server via the Internet, the IM provides a way of initiating and resuming sessions in which the guest may be completely anonymous or ambiguously identified. In this scenario, the interface to the IM is running under a web server. The interface might be a CGI program, a Java servlet, a Java Server Page, or an Active Server Page. (The Common Gateway Interface (CGI), for example, is a standard for interfacing external applications with information servers, such as HTTP or Web servers. A CGI program is executed in real-time so that it can output dynamic information.)

For each customer that visits the enterprise web site, the interface program assigns a unique cookie and stores it on the enterprise customer's computer for future reference. If a customer has merely visited but has never registered at the enterprise web site or electronically purchased anything from the enterprise, that customer is anonymous. Using that customer's cookie, an indication of the customer's prior visit, the IM can find a record of that customer's previous interactions (even though the customer is otherwise anonymous). If, for example, a customer registers at the enterprise web site via its home computer and in subsequent sessions uses the same computer the IM then associates the subsequent sessions with that customer. If the customer visits the enterprise web site via a different computer, say an office computer, the IM does not associate the new cookie with that customer. Unless and until the customer again signs in, the customer is considered anonymous as far as the IM is concerned. Once the customer signs in (identifies herself) the IM associates both computers (i.e., both cookies) with that customer. If someone other than this particular customer uses the same home and/or office computer to also register at the enterprise web site, the IM notes that several customers share the home and/or office computer (i.e., share the same cookie(s)).

Getting back to the more general scenario to explain the core functionality of the IM, we start from the point where an interaction initiates a new session (as shown in FIGS. 7a-c and 8a-f). When indicia of this interaction (event) is detected, the IM creates a (new) session record. Assuming that this record identifies the customer, the IM loads (subscribes to) corresponding customer data from the various customer tables in the ODS (e.g., demographics, insurance policy, previous accepted offers or other tables). If this record does not identify the customer it is a cookie operation and the IM does not load customer data. Instead, the IM creates (publishes) an anonymous session record. Next, the IM calls the rules service passing data to it from yet another table as well as the previous-offers table so that it can form a new offer. The IM inserts the interaction as well as the new offer(s) in a table. Having a pointer to the collection of tables, the IM can combine customer response information. The IM then saves everything about this interaction in the session cache (ODS). At that point, the IM sends the response to the customer (completing the interaction).

When a subsequent interaction is detected we assume that it belongs to the current session. Having saved the previous interaction and customer data for that session in the cache, the IM need not load the customer-related data again from the tables, as it is available in the cache (See: FIG. 7b). Thus, the IM loads the information it needs from the session cache. Namely, after the first interaction, the IM need not re-read the customer tables again because anything that it read out of these tables when the session started, as well as any new interactions that occurred during that session, are in the session cache.

The session cache is actually another table in the ODS. As will be later explained in more detail, the data the IM retrieved from the normalized tables in the ODS, is crammed into one table record, i.e., it is denormalized. By using the new approach of caching the interaction information, the IM saves a read step on subsequent interactions and is able to supports the customer interactions based on cookies. Moreover, the IM is able to forward the customer data as well as information of previous interaction(s) in this session to the rules service and get a more suitable offer in response. Accordingly, the IM is optimized by this design.

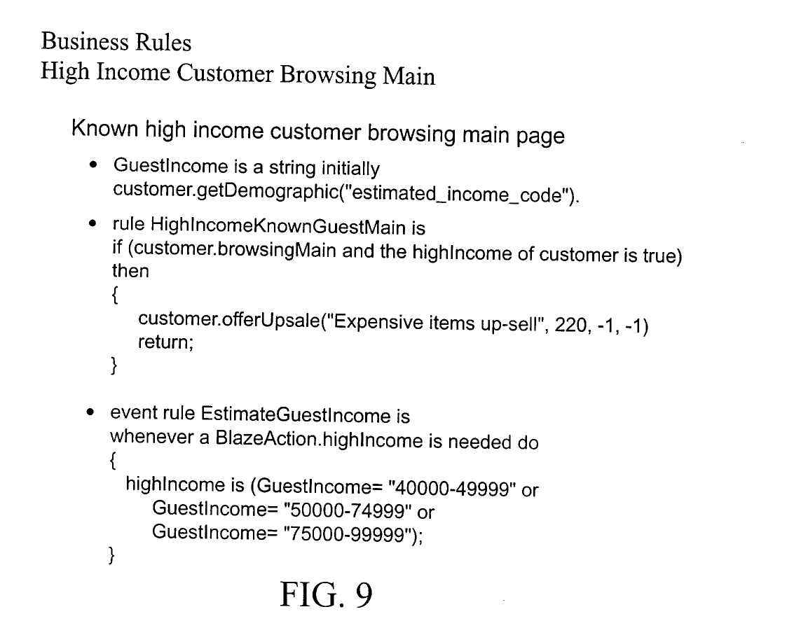

To further illustrate the functionality of an IM, an actual example of session management is presented. Initially, the enterprise does not know J. Doe, the customer. J. Doe clicks on the web site and since there is no known information about her, the IM offers her in response a default assortment of items. On establishing the session, a cookie is associated with J. Doe's computer. Later, J. Doe comes back to the ‘e-store’ (e.g., web site) and the enterprise still does not know who she is. However, from her cookie it is recognized that she has previously browsed the e-store and it is known where and on what she clicked. This time, the IM brings up (offers) items customized to J. Doe (assuming that she is interested in the same line of the items she clicked on before). Then, assuming that she goes and buys something J. Doe has to identify herself. At that point the IM can associate the cookie with J. Doe (for future interactions and sessions). Moreover, with the knowledge of J. Doe's identity, the IM goes to retrieve more information about her. For example, the IM can find out J. Doe's income bracket from Axiom (demographic information). Based on that information, as the example in FIG. 9 shows, the IM can tailor what it presents (offers) to J. Doe. (The assumption is that she is registering on the web site. Only then the IM can get a connection through her cookie, otherwise the IM will have two separate identifications. If she just mailed in a registration card, the IM does not have any way of associating her with the cookie.)

The ODS recalls all the information about J. Doe some of which comes from the applications feeding into the hub (including ODS) and some of which is the actual interactions captured by the IM. The IM is managing both kinds of data: data that came from somewhere else and data that the IM itself has captured, the actual interactions. The IM feeds this information to the business rules service that, in turn, applies business rules to it and recommends the offers that are made to the customer (J. Doe). Namely, the IM captures the interactions, gathers customer data that came from back-end systems, and calls the rules service and obtains an offer. There are rules that get for example the demographic information, and then there are cascading rules, called event rules, that are triggered based upon that demographic information (e.g., income). These are cascading events in that the are triggered from a previous event, e.g., the initial event.

B. Sessions

In managing enterprise customer interactions the IM governs sessions where, by and large, each session consists of a sequence of interactions (transactions) on behalf of a particular customer. Certain types of interaction always initiate a new session and indirectly they cause a preceding session to end. Certain events such as timeout can also cause a session to end, but normally there are no specific types of interaction that are specifically directed to ending a session. An interaction presenting a new customer ID, e.g., insert card, is one type of interaction that automatically starts a new session, although it first causes the pre-existing session to end and its corresponding area in the session cache to be purged. In the ATM example, there is a special interaction type when a customer removes his card from the ATM that causes the session to close. In the context of eCRM, a cookie-related session ends on time out. In handling a new interaction, when the IM loads the pre-existing session the IM determines if that session is timed out and if it is the IM starts a new session.

Various embodiments are associated with various session types. A notable addition to the assortment of session types is the identified user session. This type of session is based on the finding that financial institutions (banks, etc.) prefer to deal with identified customers and not with anonymous customers. The identified user session includes providing some unique customer identification on the initial interaction (e.g., insert card) and then returning a session ID. Namely, the customer is always identified in the beginning of the identified user session. The IM uses that session ID in subsequent interactions, such as a withdrawal or deposit. The IM obtains the customer identification, and any other information it needs that is relevant such as the ID of the ATM whereat the customer is. This information is provided with the session ID. In a withdrawal interaction, the customer provides the session ID as well as how much they want to withdraw from savings or checking, and then the IM returns the results.

In a web-browsing context, there is a semi-anonymous session. While browsing, a customer clicks on items and each click is an interaction. On everything the customer clicked the IM receives the customer's cookie ID, as well as information about what the customer clicked on. With each click (or sequence of clicks) the IM returns a web page (with purchase offers) customized to that customer. If the customer buys an item (or service) on any of the web pages the customer provides a real identity that can then be matched with the customer's cookie. In future sessions the cookie will be associated with that customer identity.

Thus, of the possible session types there are three notable types. One is the identified user type in which the customer is always identified at the beginning of the session. A second is the semi-anonymous type in which the customer is identified in the middle of the session. The third the anonymous type in which the customer is not identified at all, even though there is a cookie associated with that customer.

A cookie is unique but it is not uniquely associated with that customer. This is because the cookie identifies a computer but more than one person can use the same computer. Moreover, a customer may use several distinct computers. Therefore, there could be multiple cookies associated with multiple customers. Namely, there are various states of a cookie. There is a ‘non-state’ when a cookie is never matched with a customer identity or is matched with a customer only when that customer bought something (and identified itself). Therefore we assume that all uses of that cookie were for that customer. There is an ‘ambiguous state’ where, using the same computer, two customers have each previously purchased something, so that there are two customers associated with the same cookie and subsequently somebody is logging on. This cookie state is possible even though both customers, having previously bought something, are known during that particular session. It is noted that other cookie-like forms of identification can be used, including gate passes, hotel room keys etc. A gate pass or a hotel room can be handed over to another person, the pass/key being an anonymous identification yet allowing access to its holder.

C. Interactions

As mentioned, a session consists of a sequence of interactions on behalf of a particular customer. There are various kinds of interactions that can occur within a session, including those that always start a session and those that (indirectly) end a session. For example, in an ATM session the insert card is one kind of interaction that starts a session (it is the actual recognition of the card being inserted into the ATM machine). Withdrawal, deposit, account balance query and cash transfer are other possible interactions in an ATM session. During a web browsing session (in the eCRM context), each click is an interaction.

ATM or eCRM interactions need the enterprise to supply means of identifying the customers to the respective sessions. For an ATM session, the ATM card number is the identification means. That customer identification (the card number), is not the actual customer ID which is stored in the ODS. Rather, there is a table in the ODS that associates that card number with a particular customer ID because there is more than one way to identify a customer. Namely, at the ATM the customer uses the ATM card as the form of identification and at the teller's desk the customer uses either the card or another form of identification such as account number. Subsequent ATM interactions (such as a cash withdrawal or balance query) pass the session ID back to the IM as part of the interactions. In the eCRM context, the interface to the IM is running under a web server and the interactions return a unique session identifier. When providing a cookie, the customer ID can be provided at the same time.

Incidentally, interactions can be initiated by a customer via a web click or by customer service agent who is entering the interactions while on the phone with the customer. What is important to keep in mind is that there are different semantics associated with each situation which are distinguished when the wizards are run during deployment of the IM (as will be later explained). Also there needs to be a time-out mechanism, where after a certain time a session is no longer active.

It is also noted that a session involves various kinds of events. An interaction is an event. It is not the only kind of event, but it is a particular kind of event. Events are discrete in that each event represents a discrete transaction and if the event is incorrect a subsequent event is invoked to reverse (or offset the result of) the incorrect event. For example, a credit event will be invoked to offset an incorrect debit event. The events are linked to each other via the session to which they pertain. Namely, the events are identified to the IM via the session ID.

An offer is another kind of event, viewed as a feedback or response to the interaction. Offers are based upon the data provided by the IM, including interaction data, or event data, previous offers and customer data. Offers received from the rules service are inserted into the offer table of the ODS, to establish a record of what offers were made, and are returned to the customer by the IM. An ‘accept offer’ interaction is another event. One way in which accept offer can work is the customer types in his phone number on the keypad and clicks accept offer. Then, the IM captures the phone number so that a sales agent can call the customer. It may have been an insurance policy or a direct deposit or something like that. In the ATM session context, an insert card event is followed by an offer event. However, Not all interactions involve offers. For instance, a subsequent withdrawal or deposit event is followed by a result but no additional offer. Although it is a design choice, in one design results are combined into the corresponding interactions and stored as one event, but offers, if any, are stored in the ODS as a separate events.

D. Data Mining

As noted, the IM is responsible for capturing the interactions, but it receives the aggregates. The data preparation tool is responsible for selectively gathering the interactions and customer information in the aggregates, both for the IM and for data mining. Once the IM receives all this information it forwards that information to the rules service. In addition to generating the aggregates, the data preparation tool discovers behavior patterns (models). This pattern information is important in that a customer with, for instance, certain demographics and pattern of prior interactions is likely to respond favorably to a particular offer. Behavior patterns are discovered through data mining and models produced therefrom are deployed to the ODS by a model deployment tool.

The behavior models are stored at the ODS for later access by applications such as a scoring service in association with the rules service. The scoring service is actually intended to work with SAS Institute's enterprise intelligence software. In the ZLE environment it is deployed along with the Blaze Business Rules so that aggregates gathered by the IM can be scored with the behavior models when forwarded to the rules service. A behavior model is used in fashioning an offer to the enterprise customers. Then, data mining is used to determine who among them accepts the offer and to further determine what patterns predict whether a customer would accept or not accept an offer. New customers that contact the enterprise are scored in, and customers to whom no offer was previously made a determination is made whether they are in the group that would likely accept or likely reject such offer. Those among them that are likely to accept the offer are scored in such that the IM can appropriately forward the offer to such customers.

The behavior models are created by the data mining tool based on behavior patterns it discovers (See: FIG. 6). The business rules are different from the behavior models in that they are assertions in the form of pattern-oriented predictions (See, e.g., FIG. 9). For example, a business rule looking for a pattern in which X is true can assert that “Y is the case if X is true.” Business rules are often based on policy decisions such as “no offer of any accident insurance shall be made to anyone under the age of 25 that likes skiing,” and to that end the data mining tool is used to find who is accident prone. From the data mining a model emerges that is then used in deciding which customer should receive the accident insurance offer. This is not to say that behavior models are always followed as a prerequisite for making an offer. There may be policy decisions that force overwriting the behavior model or not pursuing the business model at all, regardless of whether a data mine has been used or not.

E. Caching Tables in the ODS

Considering the IM, one of the notable features of the ZLE architecture is the session cache in the ODS and the manner in which the IM uses this cache (as shown in FIGS. 7a-c and 8a-f). What is further notable is the manner in which the IM maps cookies in anonymous or ambiguous sessions. Additionally, the unique manner in which the IM gathers the information and forwards it to the rules service is a more effective way of scaling the business rules service (rather than requiring the business rules service to be a stateful service).

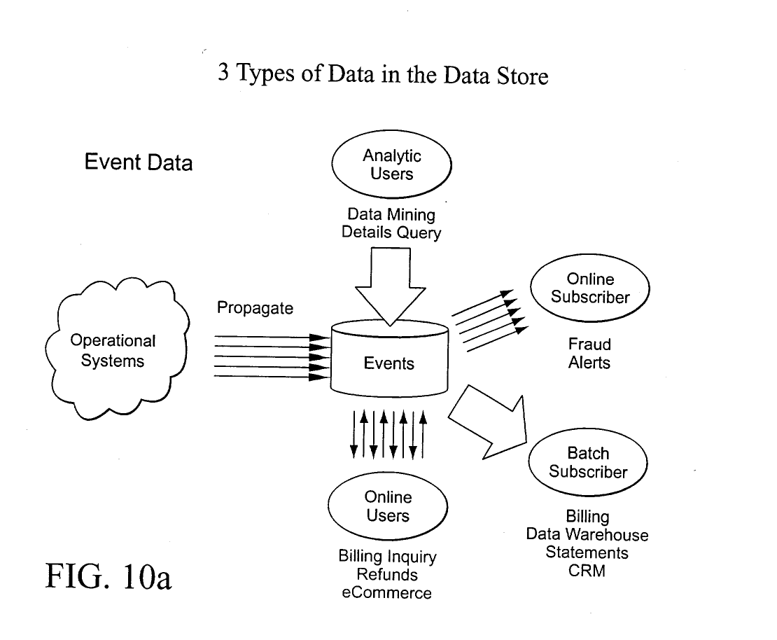

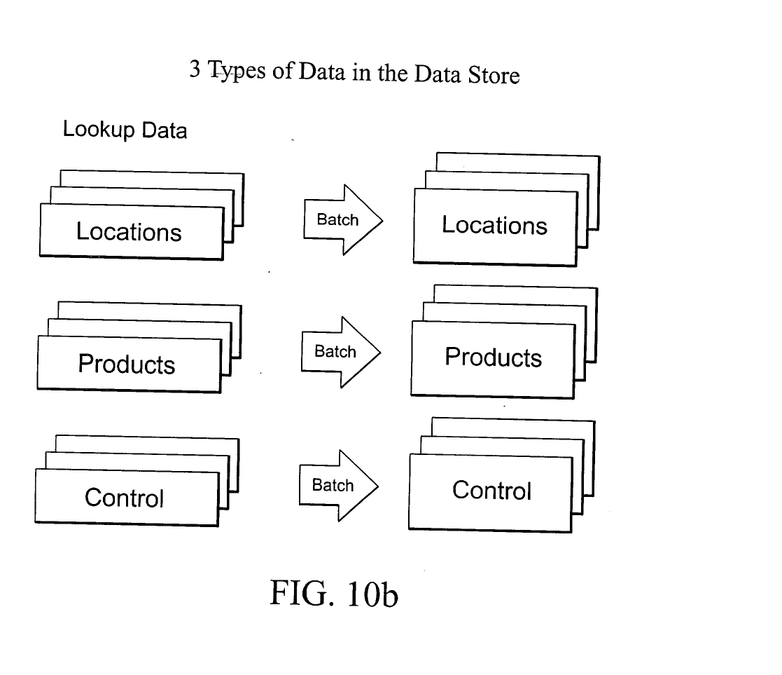

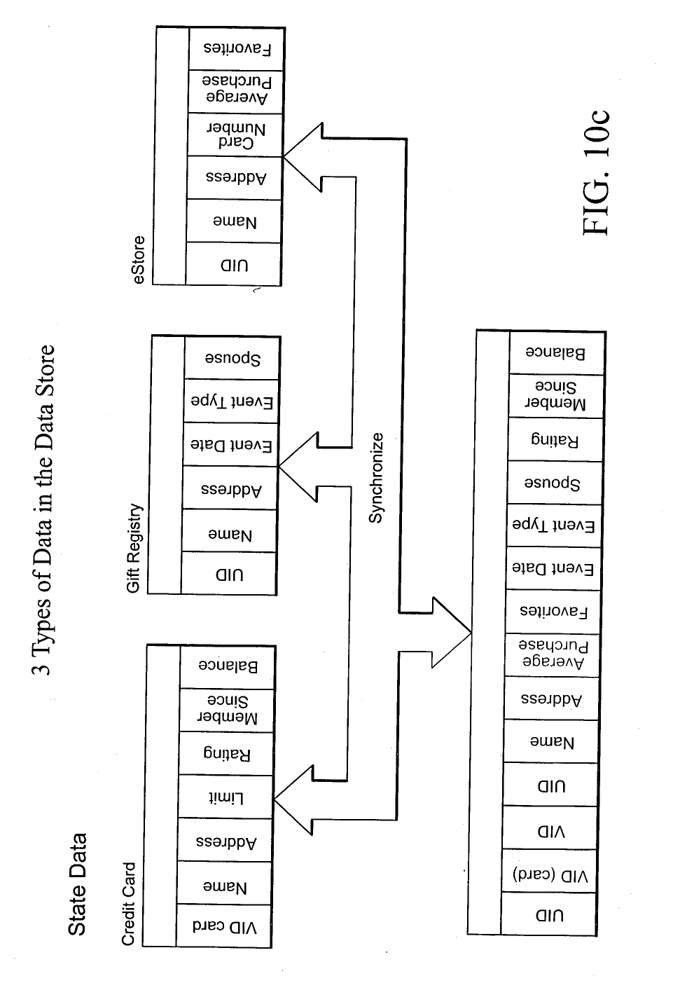

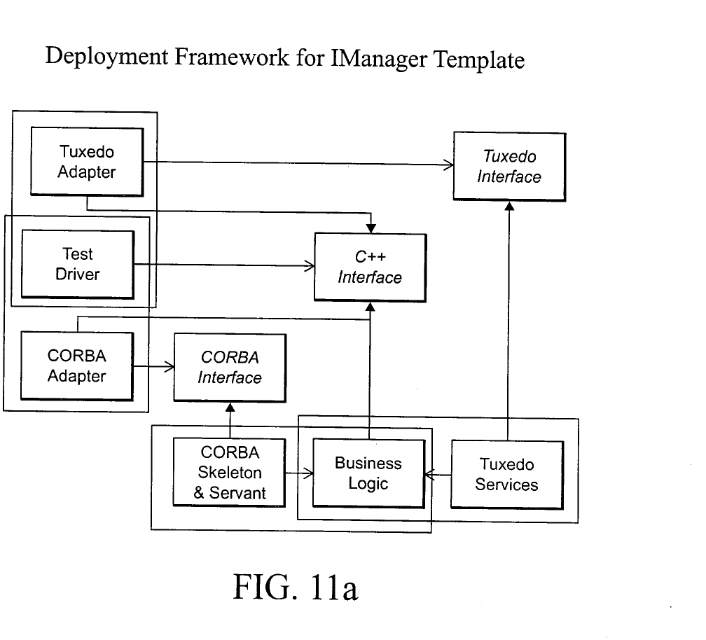

In view of that, the IM template is designed to allow several kinds of data to be cached in the ODS, including lookup data, event data and state data (FIGS. 10a-c). Lookup data contains information that is updated very infrequently (generally not in real time). Examples of lookup data include enterprise products catalog—e.g., the list of products or product part numbers—the location and identification of enterprise offices or stores, and like data. Lookup data is updated using typically a batch process (e.g., by uploading new products information into the product table once a week or even once a night).

Event data represent transaction data associated with events all through enterprise operations. Examples of events include the various aforementioned interactions, offers and more. As mentioned, events are discrete in that each event represents a discrete transaction and if an event is incorrect a subsequent event is invoked to reverse (or offset the result of) the incorrect event. The series of records for the events, including the records of incorrect and correct events, is captured by the IM and stored in the ODS. The records are linked to each other via the session to which they pertain, and they are identified to the IM with the session ID. In the ZLE infrastructure, event data publish and subscribe is real time focused.

State data is particularized to a customer and it includes data that can be updated while the customer is interacting with the enterprise. Examples of state data include the customer's (interaction) event date, credit balance, average purchase value, current address, etc.

Importantly, the traditional ODS would have state and lookup data, but it would not have the events. Hence, because the IM collects live events a traditional ODS would not involve an IM. By contrast, in the ZLE environment the IM interacts with the other ZLE components via the ODS.

For simplicity, a set of tables is grouped in the ODS (See: FIG. 6). For example, customer state data is contained in a group of tables that are particularized to the customer (i.e., customer oriented). Thus, the various customer tables are associated with the customer ID one way or another. Aggregates, another class of data grouped in tables, are event and state data combined. Aggregates represent a group of tables within the ODS that are different from the customer tables. The aggregates in the ODS and in the data mine are mirrored, i.e., are pretty much the same information. Tables that support cookies need not be customized, they are merely included or excluded from the ODS. The session cache table which is only for internal use by the IM.

With regards to the ODS design for operation with the IM, it is advantageous to build a large ODS (with many disks) for handling massive amounts of data. Although it is not a prerequisite for building a ZLE infrastructure, embodiments with more than one (cluster) node (i.e., super clusters with 4, 8 or more nodes) advantageously provide the larger ODS.

Having considered the foregoing features associated with the IM, it is important to then consider in more detail the IM template and how it shapes the deployment of a business-specific IM. It is important to also consider the role wizards play in fashioning the business-specific IM. The following discussion introduced the IM templates and wizards.

IV. IM Template Architecture

Functionally, the IM template is a set of programming tools used to create a ZLE IM (or simply IM). The IM is deployed, for instance, on a NonStop™ Himalaya system, either as a NonStop CORBA object or a NonStop Tuxedo server. The IM template is preferably designed using object-oriented concepts and, where appropriate, the description herein employs object-oriented design terminology (class, object, superclass, subclass, inheritance, etc.). Several UML diagrams appear in this document. Unified Modeling Language (UML) is a popular standard for the representation of object-oriented designs.

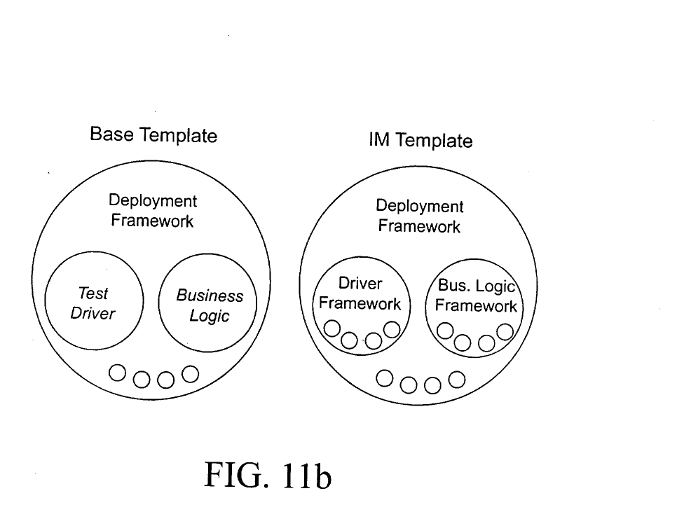

The IM template comprises a framework referred to as the “deployment framework”. In one embodiment, shown in FIG. 11a, the deployment framework of the IM template includes a suite of three distinct sub-frameworks. The IM template provides a sub-framework for the deployment of the IM and, in addition, a sub-framework for the business logic and a sub-framework for the test driver. In this embodiment, the deployment framework allows the IM, along with the test driver, to be deployed in one of three modes: (1) As a NonStop™ CORBA server object and a CORBA client test driver; (2) as a NonStop™ Tuxedo service and a Tuxedo client test driver; and (3) as a standalone test application.

In all likelihood, it is known in advance whether the IM is going to be deployed under NonStop CORBA or NonStop Tuxedo, and in that case the ability to deploy under the alternate framework may be irrelevant. However, this architecture yields a direct benefit by allowing to test the IM in a standalone mode.

The deployment framework provides a container for both the business logic of the server class and the logic of a test driver used to validate the behavior of the business logic and measure its performance. The deployment framework allows the business logic to be deployed as a CORBA object (server) and the test driver to be deployed as a CORBA client. The deployment framework also allows the business logic to be deployed as a Tuxedo server and the test driver to be deployed as a Tuxedo client. Moreover, the deployment framework allows the test driver to be linked directly with business logic for standalone testing. The test driver is platform independent, performing both functional testing and debugging and performance testing. The test driver is required to test all the various business cases or code paths and to generate a large volume of activity to see how well the IM performs in large scales. The test driver works off of a script and is instrumented so that performance measurement can be done. For deploying the IM with the business logic and the test driver, the deployment framework is in some ways similar to the framework of a so-called “base template.”

FIG. 11b illustrates the difference between the base template and the IM template. In both cases, the white circles represent source code that one has to write, and the dark areas represent source code that the template provides. As can be seen, the IM template provides more source code for the customized ZLE application. Since the base template is a generic template for any ZLE service, it makes no assumptions about what any particular service will do. Thus, with the base template one has to write all the business logic and test driver logic. By comparison, the IM template provides much of the business logic and test driver logic.

In particular, the IM template is designed for the specific purpose of allowing the IM to capture customer interactions that occur within the context of sessions, and forward those interactions to a rules service. The IM template also understands the semantics of session access, and the test driver framework it provides embodies the concept of a customer session. The IM template defines a specific model and process for implementing and integrating both business-specific interaction types and custom data objects that are business-specific data objects. The IM template enables definition and implementation of as many business-specific interaction types as desired. Each interaction type is implemented either as a method of a NonStop CORBA object or as a Tuxedo service (although other platforms are possible).

In order to implement the foregoing with a higher level of flexibility and customization, the framework of the IM template embodies Wizards. It is noted that in developing the wizards, a lot of refactoring may be done, but that does not change the way the wizards work. Refactoring is one reason why the wizards are implemented in scripts as will be explained below. It is noted that the wizards actually generate a project that builds a new IM source program.

A. Wizards

Broadly, the IM template includes wizards to assist in the deployment of the IM (the interaction manager is a clip-on application, as mentioned above). The wizards are implemented as Perl scripts that take input parameters and thus allow flexible and customized deployment of the IM. The wizards also maintain the application interface for both the CORBA related information and the Tuxedo related information. Then, once the wizards are invoked the ZLE application being deployed can execute under CORBA or Tuxedo.

In one implementation, the ZDK wizard GUI (graphic user interface) provides a user-friendly interface to gather the input parameters and launch the wizard scripts. However, in an implementation where the IM template does not support the ZDK wizard GUI, wizards are launched from a command line.

There are a number of wizards in an IM template framework, one of them is the “IM application wizard,” another is the “interaction wizard,” and yet another is “attribute wizard.” The IM application wizard creates a number of classes that are the starting point for the IM application. We shall refer to these classes as the base classes of the IM. Thus, as a primary step in each deployment, the IM Application wizard, named here Wizard.pl, is invoked to create an instance of the IM source (i.e., the starting-point IM source). Notably, once that instance of the IM source is created, the IM application wizard need not be invoked again unless a new instance of the IM source is needed (and, incidentally, a reference is made to the IM source because what is first created from the IM template is the source which is then linked to create the executable IM object).

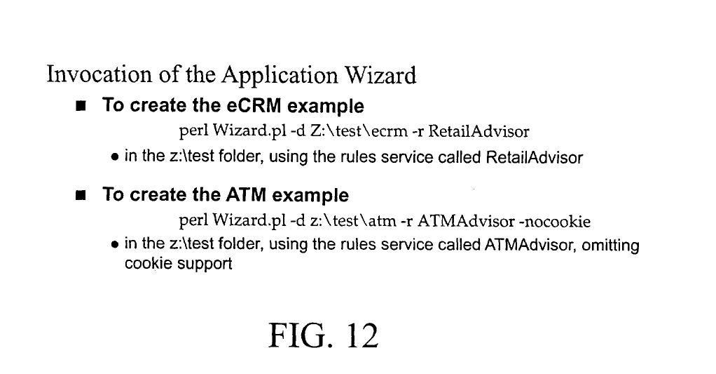

The IM application wizard is invoked by the command “perl Wizard.pl,” along with parameters, -d and -r (and the invocation is done from the proper directory as shown in the example at FIG. 12). A directory, named here z:\templates\IManager, contains the IM source. The parameters the IM application wizard is designed to take specify where the IM application is created and what rules service it uses. The parameter -d followed by a path (-d <path>) specifies the name of the path (folder) where the new IM will be created. The parameter -r followed by the rules service name (-r<rules server>) specifies the name of the rules service (e.g., Retail Advisor) that will be called on by the IM. If taken, a third parameter allows omission of cookies. The -nocookie parameter causes cookie support to be omitted and elimination of 3 tables that otherwise would be required: Cookie, CookieCustomer and Anonymous Session.

As an example, the IM application wizard is invoked with commands and parameters as follows:

cd z:\templates\IManager perl Wizard.pl -d z:\test\ecrm -r RetailAdvisor,

where the ‘cd’ command sets the stage for wizard execution from the correct directory. Here is another example invocation of the IM application wizard to create an IM in the folder z:\test\IManager that is to call the rules service named ATMAdvisor:

perl Wizard.pl -d z:\test -r ATMAdvisor

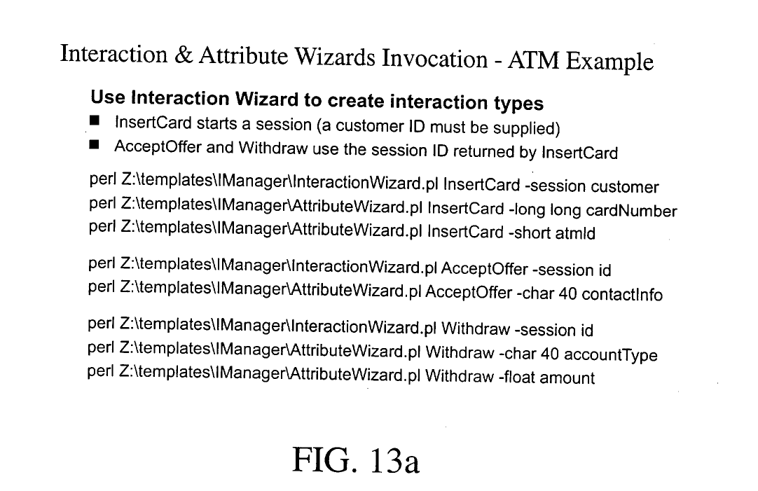

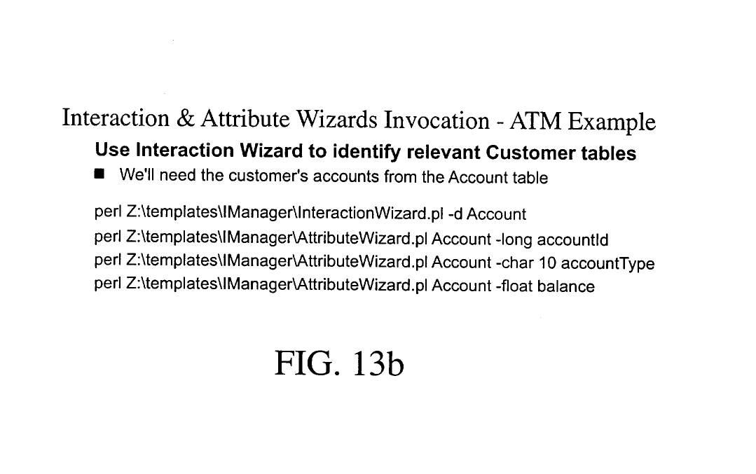

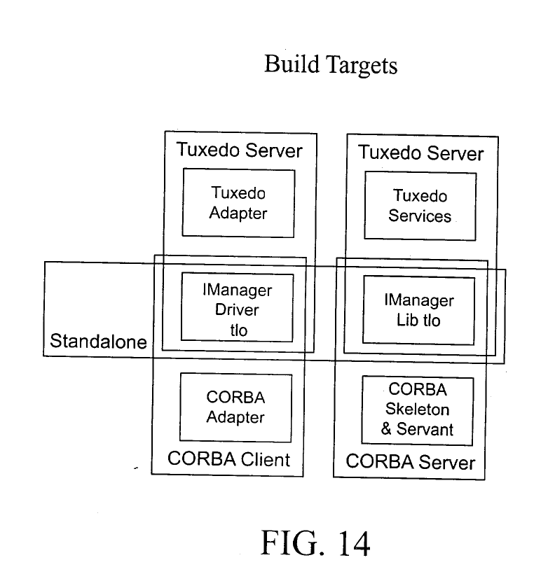

To add business-specific interaction types to an IM source, the interaction wizard, named here “InteractionWizard.pl,” is invoked for each new interaction type (see examples in FIGS. 13a,b). Importantly, the current directory needs to be set to the folder containing the new IM to be modified. The first parameter of the interaction wizard is the name of the new interaction type. This wizard also takes one of the following interaction-type parameters:

-session customer indicates that this interaction type starts a new session for a known enterprise customer. The customer id (identification) must be provided in the input to the interaction (although the code may be customized to provide an indirect means to identify the customer, such as an ATM card number);

-session id indicates that this interaction type takes place within the context of an existing session. The session id returned by some previous interaction must be input to access the session;

-session cookie indicates that this interaction type occurs sometimes within the context of an existing session and other times acts to resume a session. The customer may be known, anonymous or ambiguously inferred. The input to this interaction must include a unique externally assigned cookie (string). The input may also include a customer id, if the customer id is known.

An example invocation of the interaction wizard to create an InsertCard interaction type that starts a session (as in the ATM example of FIG. 13a) is formatted as follows:

perl Z:\templates\IManager\InteractionWizard.pl InsertCard -session customer

An example invocation of the interaction wizard to create an AcceptOffer interaction that occurs within a session (as in the ATM example) formatted as follows:

perl Z:\templates\IManager\InteractionWizard.pl AcceptOffer -session id

Then, an example invocation of the interaction wizard to create a Browse interaction that sometimes starts a new session (as in the eCRM example) for a customer that may be anonymous or ambiguously identified is formatted as follows:

perl Z:\templates\IManager\InteractionWizard.pl Browse -session cookie.

As mentioned above, the IM manages interactions operating on various data objects in or imported into the ODS. A data object represents some table in the database. The tables in the ODS contain data that is directly or indirectly related to the enterprise business. Data contained in the tables is at times relevant to the business rules for making recommendations or offers and at times data in such tables is relevant to the business logic implemented in the IM. For example, the interaction wizard is run to create a data object called Policy or Insurance which allows the IM to load all the insurance policy data into the session. Here is an example invocation of the interaction wizard to create business-specific data (e.g., customer data) object type called Account:

perl Z:\templates\IManager\InteractionWizard.pl -d Account.

It is noted that the interaction wizards don't create the database, it is still up to the enterprise to define the database, but this creates the (C++) code that allows the enterprise to access the (interaction) data in its database (i.e., tables).

As noted before, the IM application wizard creates a number of base classes that are the starting point for the IM application. The interaction wizard creates a number of additional classes each time it is invoked. These classes may be easily recognized because the interaction name specified in the invocation will be embedded within the name of each of these classes. The interaction wizard connects these new classes into the base classes so that they are constructed and invoked at the appropriate points during program execution. Basically, when the interaction wizard is invoked a script (written in perl) reads some template files and searches for certain tags which are called Wizard Hooks, i.e., hooks where it is going to expand some code or replace some code (akin to a macro). The interaction wizard looks for hooks in the base classes in order to connect the new classes thereto. These hooks appear as comments in the code. The hooks should not be modified so that the interaction wizard will work correctly when it is time to add additional interaction types to the IM.

Here is a typical example of an interaction wizard hook from the IManagerAgent class:

//----------- interaction wizard hook --------------------

// Customized by interaction wizard.

// The commented out function body is used by the interaction wizard.

// Do not change or remove.

//-------------------------------------------------

//m_MyInteraction=new MyInteractionHandler(*m_session);

The code generated by the interaction wizard is found just before the hook itself. Here is the code generated from this particular hook, by three invocations of the interaction wizard for the ATM example:

m_InsertCard=new InsertCardHandler(*m_session);

m_AcceptOffer=new AcceptOfferHandler(*m_session);

m_Withdraw=new WithdrawHandler(*m_session);

In any event, when contemplating deployment of an IM, a decision is first made as to what interaction types there are and how to structure the database for the enterprise.

Once the IM application wizard is invoked to deploy the base-frame IM and once interaction types and data objects are added thereto, the attribute wizard is invoked for each attribute of an interaction or a data object. The interaction wizard is invoked before the attribute wizard, and the attribute wizard is invoked for each of the attributes that are passed as part of a particular interaction type. One way of looking at it is, the interaction wizard is invoked to indicate that there is a table to be accessed, and the attribute wizard is then invoked to identify a column of that table. Hence, if there are 10 columns in that table the attribute wizard is invoked 10 times to identify the different columns of that table.

Take for instance the Insert Card interaction of the ATM example (FIGS. 13a,b). One attribute of this interaction is the card number, i.e., the actual ATM card number to be authenticated. The card number (card ID) information is needed in order to look up the account and the person's identity. Another attribute of the Insert Card interaction is the ATM number (ID) and location. The ATM knows where it is located and it is going to pass that information. There may be more attributes. The attribute wizard will provide these and other attributes.

When invoking the interaction wizard, what is specified is the name of some table in the database, but there are conventions about the name of the table. When specifying attributes to the attribute wizard, they have to match the attributes of the table (i.e., columns that need to be in the table). In an implementation with NonStop™ SQL, the name of a table is not the actual physical name of the table. Rather, there are defined names and then those defined names get resolved (mapped) to physical names. For instance, if an interaction called Browse is to be triggered, the defined name of the table is Browse_Interaction, and the key of the interaction is the session ID. The name of the data object in the table is just the name of the data object as defined. For instance, if it is an insurance policy the defined name is Insurance_Policy (and the key is assumed to be a customer ID). As long as these conventions are followed, the code produced from running the wizards can be compiled and run without additional work. In other words, the IM (executable code) is ready to run, where data is moved in and out of the database, without the need for writing any custom SQL code or any custom C code.

It is noted that, once the IM application, interaction and attribute wizards are invoked and the various corresponding source code modules are created, they are ready to be compiled and linked to become the (then customized) IM program. For example, once the interaction wizards are invoked, they create a set of corresponding files, C++ source codes and a project. The invoked interaction wizards create the aforementioned additional classes that are then added to the project. In addition, the invoked interaction wizards update many of the classes that were previously created so as to automatically ‘hook’ all of them together. In other words, the interaction wizards automatically update the hooks by inserting calls to the new classes (because otherwise it would not be possible to add new classes to an existing project).

By comparison, an attribute wizard does not add new classes. It merely adds additional lines of code to the previously created classes to which it is applicable. Thus, upon invoking an attribute wizard in order to add an attribute, an indication of the modified data object or interaction type is needed. Specifying the interaction type allows the attribute wizard to touch all the classes for that interaction type. The attribute wizard updates previously generated code by modifying and adding new code to methods. The attribute wizard is prompted to change the ‘type’ attribute specification (such as ‘-char’, ‘-float’, ‘-short’, ‘-long’, ‘-long long’, etc., respectively)

Furthermore, the IM source created by the IM application wizard has three special objects that are always part of it. The three special objects are the ‘session’, ‘customer’ and ‘offer’ objects. The attribute wizard is invoked to add attributes to these special objects. For example, to add a short attribute ‘intSubtype’ to the interaction, the attribute wizard is invoked as follows:

perl z:\templates\IManager\AttributeWizard.pl AcctMaint -short intSubtype

To add contact information of up to 40 characters to the interaction, the attribute wizard is invoked as follows:

perl z:\templates\IManager\AttributeWizard.pl AccetpOffer -char 40 contactInfo

The last thing on each line is the name of the attribute that matches the name of the data in table.

To first build its associated interactions, the interaction wizard scripts are fashioned for the enterprise based upon the data model the enterprise has (e.g., by determining what columns the enterprise keeps in its table). The attribute wizards are run to specify those columns. And, since the interactions and attributes are different (customized) for each enterprise, the wizards are provided to allow this customization. In other words, although the IM application wizard is common to all, we don't build one (IM) application that is supposed to handle every type of enterprise. Rather, once the IM application wizard is run to deploy a basic IM, the interaction and attribute wizards are invoked to specify how that IM maps onto the enterprise's database. Accordingly, rather than editing the C code or C++ code to adapt IM to a particular enterprise, the interactions and attributes are customized by creating and editing the scripts that launch the wizards. Namely, the interaction and attribute wizards are used to customize the IM to the enterprise.

As noted, one can invoke the scripts manually using command lines or, preferably, create a text file that contains all these commands and then just run it as a batch script. With this approach, one can change the scripts and run the batch again to correct mistakes or introduce updates without having to do it all manually.

An additional concept to point out regarding the test driver is that the IM template, including the wizards, takes care of building both the server side and the client. The server and client sides are built in such a way that they can be bound directly and tested directly, or they can be deployed separately. The IM template is designed to be very flexible with many different options for deploying the server and client sides (e.g., test driver as stand alone at the client or at the server sides, same or different NonStop™ system, etc.).

V. IM Deployment

To recap, the basic IM is deployed used the IM application wizard. For each instance of IM being deployed there is a project file, called here IManager.ide (as in the ZDK). On running the IM Application Wizard, it creates the project file IManager.ide with the set of base classes, except for the Tuxedo-specific classes (which are organized under the targets as later described). After the interaction wizard has been invoked, the new classes need to be manually added to the project file.

While the IM created by the wizards is executable as is, one needs to write business-specific logic into it before it will become a useful application. The first task is to add more attributes to the interactions themselves. (For starters, the interactions have customer ID, cookie and/or session ID as attributes.) Each time an attribute is added, it is likely that the classes created need to be modified.

The following sections describe what the different classes (source files) of the IM do, and indicate how and why they will likely need to be modified. This discussion is illustrated by the ATM example that the ZDK includes.

A. Build Model

Provided with the ZDK is a z:/templates/Manager folder for the IM template. This folder includes a batch file called buildAtm.bat that executes the series of interaction wizards to create the skeletal ATM IM. This batch file creates the skeletal ATM IM in the folder Z:\tests\IManager. By comparing this source code with the source code of the completed ATM IM, in the folder Z:\examples\ATM\IManager, one can learn much about what is involved in completing the ATM IM.

The IM is built using a development suite (e.g., the Tandem Development Suite which is based on Borland C++ 5.0). As mentioned, in one example there is a project file called IManager.ide for each IM that is created. All the source files for that IM are located in the same directory with this project file. In that implementation, there are five targets defined within the project file (see FIG. 14).

IManagerLib.tlo is a static library containing the modules that compose or extend the business logic framework. Building this target causes all of the business logic classes to compile.

IManagerDriver.tlo is a static library containing the modules that compose or extend the test driver framework. Building this target causes all of the test driver classes to compile.

IManagerStandalone.txe is the standalone test program. Building this target compiles those modules specific to the standalone test program and links them with both IManagerDriver.tlo and IManagerLib.tlo.

IManagerCorbaServer.txe is the CORBA server. Building this target compiles those modules specific to the CORBA client and links them with IManagerLib.tlo.

IManagerCorbaClient.txe is the CORBA client. Building this target compiles those modules specific to the CORBA server, and links them with IManagerDriver.tlo.

The foregoing targets are preferably built on a Windows desktop computer. The IManagerTuxedoServer and IManagerTuxedoClient are preferably built on the NonStop NonStop™ server platform. The modules specific to the Tuxedo server and client are transferred to the NonStop™ (using. e.g., the file FtpTuxedoFiles.bat) and compiled there (using the command make). IManagerDriver.tlo and IManagerLib.tlo are also transferred to the NonStop™ and linked with the Tuxedo specific modules. A file known as Makefile is provided for compiling the Tuxedo modules and linking them with the libraries for both the client and server.

In this implementation, the IManagerCorbaServer and IManagerStandalone need to be SQL-compiled on the NonStop™ before they can be executed. And, both IManagerLib.tlo and IManagerDriverLib.tlo need to be built before building any of the other targets (i.e., the executables). This is the only restriction on the order of building the components.

The following table illustrates the classes that are created by the interaction wizard, the build target for those source files, and the corresponding header files. In this table, Withdraw represents the name of an interaction type added to the IM.

| Source file created: | Build target for this source file | Corresponding header files created: |
|---|---|---|
| WithdrawHandler.cpp | IManagerLib.tlo | Withdraw.h |
| WithdrawSql.c | (the business logic). | WithdrawHandler.h |
| | | WithdrawSql.h |
| ParseWithdraw.cpp | IManagerDriver.tlo | ParseWithdraw.h |
| TestWithdraw.cpp | (the test driver). | TestWithdraw.h |
| TuxedoWithdraw.cpp | IManagerTuxedoServer | Tuxedo Withdraw.h |
| WithdrawTuxedoAdapter.cpp | IManagerTuxedoClient | WithdrawTuxedoAdapter.h |

The following table illustrates the classes that are created by the interaction wizard for a data source, the build target for those source files, and the corresponding header files. In this table, Account represents the name of a data source that you have added to the IM.

| | Build target for | Corresponding header |
|---|---|---|
| Source file created: | this source file | files created: |
| AccountHandler.cpp | IManagerLib.tlo | Account.h |
| AccountSql.c | (the business logic). | AccountHandler.h |
| | | AccountSql.h |

The Tuxedo server and client are built via a Makefile. For this example, the Makefile is edited to add the additional source files that must be compiled. Once the appropriate changes are made to the build environment, and the required database tables exist, the IM program is built and can be executed. One can create a test script that is read by the test driver to simulate interactions.

In one implementation NonStop SQL Scripts are used. Based on that, the IM application wizard generates database scripts to create the core IM SQL tables. On running the interaction wizard for each addition of an interaction type or data handler, the following files need to be edited and the following new SQL table definitions need to be added.

| Source file created: | Purpose of the file |
|---|---|
| DBCREATE | Contains the SQL statements to create the SQL |
| | database |
| dbdefs.tdf | Contain the SQL DEFINE's for the TACL |
| | environment. In the .ide you must set the SQL |
| | options for the SQL source file (ex. WithdrawSql.c) |
| | to use this define file. |
| Ossdbdef | Contain the SQL DEFINE's for the OSS |
| | environment. You will use this file to SQL compile |
| | the executable in the OSS environment. |

B. Common Deployment Classes Framework

1. Overview of Common Deployment Classes Framework

The IManagerInterface and Response classes connect the Test Driver framework and the Business Logic framework (see, e.g., FIGS. 15a-g). IManagerInterface defines the methods that are implemented by the business logic, and which the client will invoke. A method is implemented for each interaction type. The interaction types for the ATM example are InsertCard, AcceptOffer and Withdraw. The IManagerInterface also defines the input for each interaction type. Each method takes a single parameter, a reference to a struct containing the data for that interaction type.

If one is going to deploy the service under CORBA, as shown in FIGS. 15c,d, the methods defined in IManagerInterface mirror methods defined in the Interface Definition Language (IDL) file. Alternatively, if one is going to deploy the service under Tuxedo, as shown in FIGS. 15e-g, a method should be defined in IManagerInterface for each Tuxedo service that the server implements.

The PrintSession method of IManagerInterface does not reflect a method in the IDL, and is not implemented by the CORBA server or Tuxedo service. It is used to display the entire contents of a session only when the service is linked standalone with the test driver. This feature is provided for testing and debugging.

Response contains the data that is returned by the business logic methods. It also provides methods for manipulating these elements. The Response object illustrated contains standard elements that will be returned by a typical IM: the offer, a status code and a session ID. The ATM example Response also contains a business-specific element, the account balance. IManagerAgent is the entry point to the business logic. It implements the methods defined in IManagerInterface, and it returns a Response to each of those methods. It must be hosted within some environment: i.e., as a CORBA server object, a Tuxedo service, or standalone executable. But it does not depend on any particular environment.

IManagerClient is the main program of the test driver. It calls the global function getIManager to obtain a reference to an implementation of the IManagerInterface. This global function is declared in the header of the IManagerInterface, but not implemented there. The implementation of getIManager within the IManagerAgent allows the test driver to be bound directly with the business logic, and run as a standalone test program. As noted in later sections of this document, the getIManager function can also be used to bind the test driver as CORBA client or a Tuxedo client.

2. Customization Guidelines for Business Logic Interface

The interaction wizard automatically inserts the method declaration for the interaction in the IManagerInterface and the method body in the IManagerAgent. The method includes one parameter, which is a reference to a record (struct) named for the interaction (e.g., the record for the InsertCard interaction is named InsertCardRec). We refer to this record as the interaction record.

Any input attributes for an interaction need to be added to the corresponding interaction record within IManagerInterface.h. These attributes can be declared short, long, long long, float, or char*. Other data types are possible, but would require modifications not spelled in this document. Preferably, fixed-size character arrays are to be avoided.

To hold any additional data to be returned to the client, members have to be added to the Response class. The Response contains a record (struct) called OfferRec, defined in Response.h. If offers contain additional data elements, besides an offer ID and text, these elements need to be added to the declaration of OfferRec. It is assumed that all interactions return the same response object. Typically this contains an offer from the rules service along with other data. If different interactions must return widely varying data objects in the particular IM configuration, one might create classes for those different data objects and store them as members in the customized Response class.

C. Deployment Framework: CORBA and TUXEDO Deployment

The IM is deployed so that, for example, it is able to support both CORBA and Tuxedo middleware at the same time. One reason for being neutral initially on the issue of CORBA and Tuxedo is to allow integration of the IM with the IT infrastructure and solutions already in place. An enterprise is going to want to build its ZLE framework around Tuxedo (as it may be already using Tuxedo to access its Unisys main frame). If the enterprise is not already committed to using either CORBA or Tuxedo, CORBA is the preferred choice. Because both CORBA or Tuxedo are open APIs, it makes it easier for an enterprise to build their applications on other middleware platforms, either on their IM or on the back end services that are going to feed data into the operational data store (ODS).

Another embodiment can be provided with a native pathway solution or platform. The main ideas and architecture would equally apply to native pathway. IBM's MQ series is another middleware platform. Namely, the ideas and architecture expressed herein are extendible to environments other than CORBA and Tuxedo.

1. CORBA Deployment Classes

The static Unified Modeling Language (UML) diagram of FIG. 15b, shows the interrelationships between the classes discussed in this section. The interaction names shown, InsertCard, AcceptOffer, and Withdraw, are drawn from the ATM example. These class names will be the same for any IM—only the interaction names will change (e.g., for the eCRM example, the interaction names are BrowseItem and AccountMaint).

a. Overview of CORBA Deployment Classes

getIManager is a global function (not a class method) that constructs and returns an IManagerCorbaAdapter as an IManagerInterface to the IManagerClient.

IManagerCorbaAdapter obtains a CORBA object reference from the CORBA Object Request Broker during class construction. IManagerCorbaAdapter invokes the CORBA method corresponding to each business logic method defined in the IManagerInterface. IManagerCorbaAdapter also converts the ImResponse returned by the CORBA service to a generic Response.

IManager is the CORBA object the implementation of which is generated by idl compiler as part of the CORBA stub (IManager_client.cpp/.h).

ImResponse is the response returned by the CORBA service. Its implementation is also generated by idl compiler as part of both the CORBA stub (IManager_client.cpp/.h) and the CORBA skeleton (IManager_server.cpp/.h.)

POA_IManager is also generated by idl compiler as part of the CORBA skeleton (IManager_server.cpp/.h.)

IManager_impl extends the POA. This is the CORBA servant piece that CORBA programmers normally implement. Its job is very limited in this architecture. It dispatches the methods of the CORBA object to the corresponding methods in the IManagerAgent. It also creates the ImResponse from the Response object.

IManagerCorbaServer is the main program of your CORBA service. It constructs the CORBA servant, utilizing the methods defined in the ZDK framework class CorbaServer.

b. CORBA Customization Guidelines

There is no need to customize the framework classes IManagerCorbaServer or CorbaServer. Much of the CORBA customization work is performed by the interaction wizard. The steps performed automatically by the interaction wizard are asterisked below.

*The IManager.idl file is expected to contain a struct declaration for each interaction type, with the name of the interaction suffixed with “Rec”; i.e., it has the same name as the interaction record defined in IManagerInterface.h. The interaction wizard creates this struct with the attributes sessionId, customerId and cookie.

*The IManager.idl file is expected to contain a method corresponding to each interaction type, with the same name as the interaction type, taking the interaction record as its input parameter and returning an ImResponse. The attributes that are irrelevant to this interaction may be removed from the interaction record. However, other attributes that are relevant to this interaction should be added. The relevant attributes must be equivalent to those defined in the corresponding record in the IManagerInterface, and declared in identical order. Attributes declared as char* in the IManagerInterface must be declared as string in the .idl file.

It is necessary to add to ImResponse struct in the IManager.idl file attributes corresponding to any members added to the Response class.

It is necessary to add to the Offer struct in the IManager.idl file attributes corresponding to any members added to the OfferRec defined in Response.h.

IManager, ImResponse, POA_IManager are generated whenever the IManager.idl is changed by running idl compiler. These modules are contained in the CORBA stub (IManager_client.cpp/.h) and/or the CORBA skeleton (IManager_server.cpp/.h.)

*IManager_impl is expected to contain a method corresponding to each method defined in the CORBA IDL. It dispatches such method to the corresponding method in the IManagerAgent.

The member variables of the ImResponse are copied from the Response object before returning to the client. You will use CORBA::string_dup( ) to return any strings.

*IManagerCorbaAdapter is expected to implement each method (i.e., interaction type) in the IManagerInterface. It dispatches the method to the corresponding method of the CORBA object reference.

The MapResponse method of the IManagerCorbaAdapter is expected to be customized to copy the member variables from the ImResponse to the Response.

D. Tuxedo Deployment Classes

1. Overview of Tuxedo Client-Side Classes

The static UML diagram of FIG. 15d, shows the interrelationships between the client-side classes of the ATM example Tuxedo driver. Such classes are hereafter provided.

getIManager is a global function (not a class method) that constructs and returns an IManagerTuxedoAdapter as an IManagerInterface to the IManagerClient. During program construction, IManagerTuxedoAdapter calls tpinit to initialize the Tuxedo session and tpalloc to obtain two Tuxedo buffers. It constructs two TuxedoBuffer objects wrapping those Tuxedo buffers. It constructs a TuxedoAdapter subclasses for each interaction type. At execution time, IManagerTuxedoAdapter invokes the CallService method of the TuxedoAdapter subclass corresponding to each business logic method defined in the IManagerInterface.

The TuxedoBuffer class wraps a Tuxedo buffer, and provides methods to marshal parameters into the buffer, and unmarshal parameters out of the buffer. The Marshal and Unmarshal methods are overloaded to handle various data types. Marshal and Unmarshal methods are provided for various scalar types as well as for the Response object. Note that this class is also used by the Tuxedo server.

TuxedoAdapter is an abstract superclass used to access a Tuxedo service. A distinct subclass of TuxedoAdapter is instantiated to adapt to each Tuxedo service. The CallService method does all of the setup required to invoke a Tuxedo service. It invokes the MarshalRequest method of the subclass to marshal the particular parameters of the interaction type.

The MarshalRequest method of the InsertCardTuxedoAdapter marshals the individual members of InsertCardRec into the FML buffer, using the overloaded Marshal method of the TuxedoBuffer class. The class constructor sets m_serviceName to “INSERTCARD”.

The MarshalRequest method of the AcceptOfferTuxedoAdapter marshals the individual members of AcceptOfferRec into the FML buffer, using the overloaded Marshal method of the TuxedoBuffer class. The class constructor sets m_serviceName to “ACCEPTOFFER”.

The MarshalRequest method of the WithdrawTuxedoAdapter marshals the individual members of WithdrawRec into the FML buffer, using the overloaded Marshal method of the TuxedoBuffer class. The class constructor sets m_serviceName to “WITHDRAW”.

a. Tuxedo Driver Customization Guidelines

The interaction wizard creates a subclass of TuxedoAdapter for each interaction type specified. It performs the steps asterisked below automatically.

*The IManagerTuxedoAdapter is expected to construct each of the TuxedoAdapter subclasses. Each of the interactions defined in the IManagerInterface is expected to be implemented in the IManagerTuxedoAdapter by invoking the CallService method of the corresponding TuxedoAdapter.

*The TuxedoAdapter subclass constructor should be designed to set the member m_serviceName to the name of the interaction.

It is noted that an ‘FML field id’ should be added for each of the attributes of the interaction record in the field definition file msgflds. Moreover, within the MarshalRequest method of TuxedoAdapter subclass, a call should be added to one of the overloaded Marshal methods of the Tuxedo input buffer, for each of the attributes of the interaction record. The call must use the FML field id added to msgflds.

The Unmarshal(Response& response) method of TuxedoBuffer should be customized to unmarshal custom attributes of the Response object from the Tuxedo output buffer. The TuxedoBuffer class may be customized if data elements need to be represented in another manner. The default implementation passes all data types as strings within an FML buffer. The Marshal and Unmarshal methods should be consistent, however.

2. Overview of Tuxedo Server-Side Classes

The static UML diagram of FIG. 15e, shows the interrelationships between the Tuxedo server-side classes of the ATM example.

IManagerTuxedoServer is the entry point to the Tuxedo service. As a Tuxedo service, implementing only global functions, it is not a real class. It implements the tpserverinit function that all Tuxedo services provide, and implements the various services. It implements each service by calling the ExecuteRequest method of the corresponding subclass of TuxedoService.

The TuxedoBuffer class wraps a Tuxedo buffer, and provides methods to marshal parameters into the buffer, and unmarshal parameters out of the buffer. The Marshal and Unmarshal methods are overloaded to handle various data types. Marshal and Unmarshal methods are provided for various scalar types as well as for the Response object. Note that this is the same class used in the Tuxedo test driver.

TuxedoService is an abstract superclass used to process an individual Tuxedo service. A subclass of TuxedoService is implemented for each method defined in the IManagerInterface. The ExecuteRequest method of the TuxedoService class calls the UnmarshalRequest method of the subclass to umarshal the input buffer, and the ExecuteService method to invoke the corresponding business method in IManagerAgent. The ExecuteRequest method performs tpbegin, tpcommit and tpabort based upon the status returned in the Response.

TuxedoInsertCard contains an InsertCardRec as a private member. The UnmarshalRequest method unmarshals the parameters from the input buffer into the InsertCardRec. The ExecuteService method calls the InsertCard method of the IManagerAgent, passing the InsertCardRec. The constructor sets m_serviceName to “InsertCard”.

TuxedoAcceptOffer contains an AcceptOfferRec as a private member. The UnmarshalRequest method unmarshals the parameters from the input buffer into the AcceptOfferRec. The ExecuteService method calls the AcceptOffer method of the IManagerAgent, passing the AcceptOfferRec. The constructor sets m_serviceName to “AcceptOffer”. The constructor also sets the contactInfo member of the AcceptOfferRec to point to a buffer allocated as a member of the class.

Tuxedo Withdraw contains the record WithdrawRec as a private member. The UnmarshalRequest method unmarshals the parameters from the input buffer into the WithdrawRec. The ExecuteService method calls the Withdraw method of the IManagerAgent, passing the WithdrawRec. The constructor sets m_serviceName to “Withdraw”. The constructor also sets the accountType member of the WithdrawRec to point to a buffer allocated as a member of the class.

a. Tuxedo Server Customization Guidelines

The interaction wizard creates a subclass of TuxedoService for each interaction type. It automatically performs the steps asterisked below.

*IManagerTuxedoServer is expected to include a function for each interaction type (e.g., C-langauage function). It is also expected to call the ExecuteRequest method of the corresponding TuxedoService subclass.

*The TuxedoService subclass is expected to contain the interaction record as a private member.

The ExecuteService method is expected to call the corresponding method of the IManagerAgent, passing a reference to the interaction record. The constructor will set the member m_serviceName to the name of the interaction.

Within the UnmarshalRequest method of the TuxedoService subclass, it is expected that there is a call to one of the overloaded Unmarshal methods of the Tuxedo buffer for each of the members of the interaction record.

The MarshalResponse method of TuxedoBuffer is expected to be customized to marshal custom attributes of the Response object into the Tuxedo buffer.

The TuxedoBuffer class should be customized if data elements are to be represented in another manner. The default implementation passes all data types as strings within an FML buffer. It is necessary, however, to maintain the Marshal and Unmarshal methods consistent.

*The ubbconfig (Tuxedo configuration file) should be edited and an entry should be added for each interaction type in the SERVICES section.

E. Standalone Deployment Framework

Standalone deployment involves linking the test driver classes (in the library IManagerDriver.tlo) directly with the business logic classes (in the library IManagerLib.tlo). The standalone build design is shown in FIG. 15f. In some instances, an empty class, Dummy, should be added to the IManagerStandAlone target in order to avoid a possible problem linking 2 libraries without a single object file.

Standalone deployment is based upon a number of key classes that unify or connect all the sub-frameworks of the IM. The static UML diagram of FIG. 15g, shows how these classes are interrelated. These class names are the same in any IM. The method names shown here are those for the ATM IM.

F. Business Logic Framework

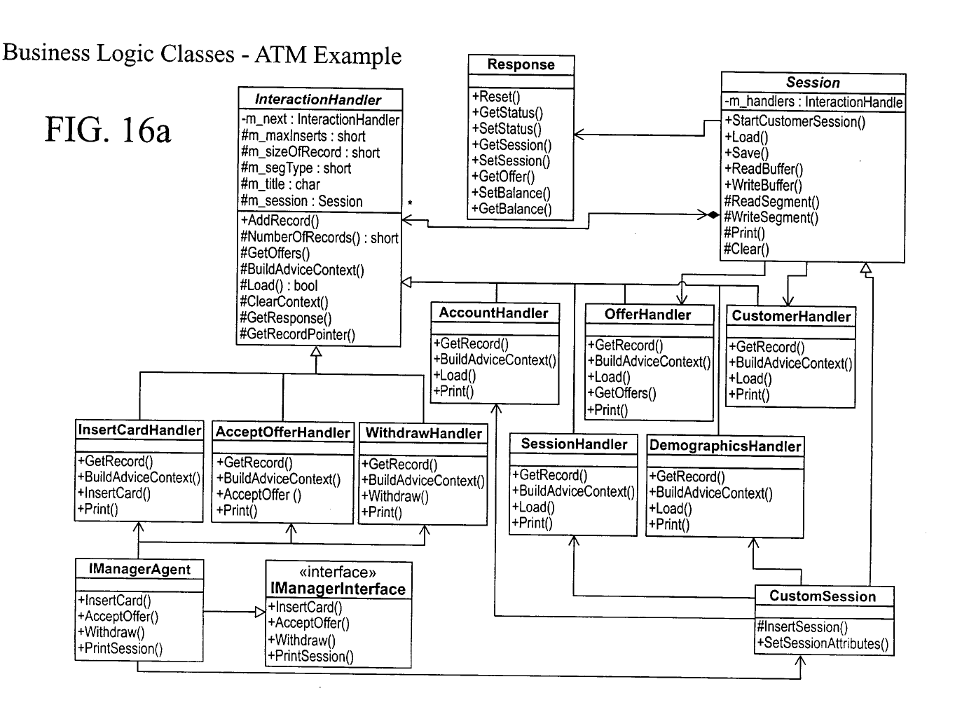

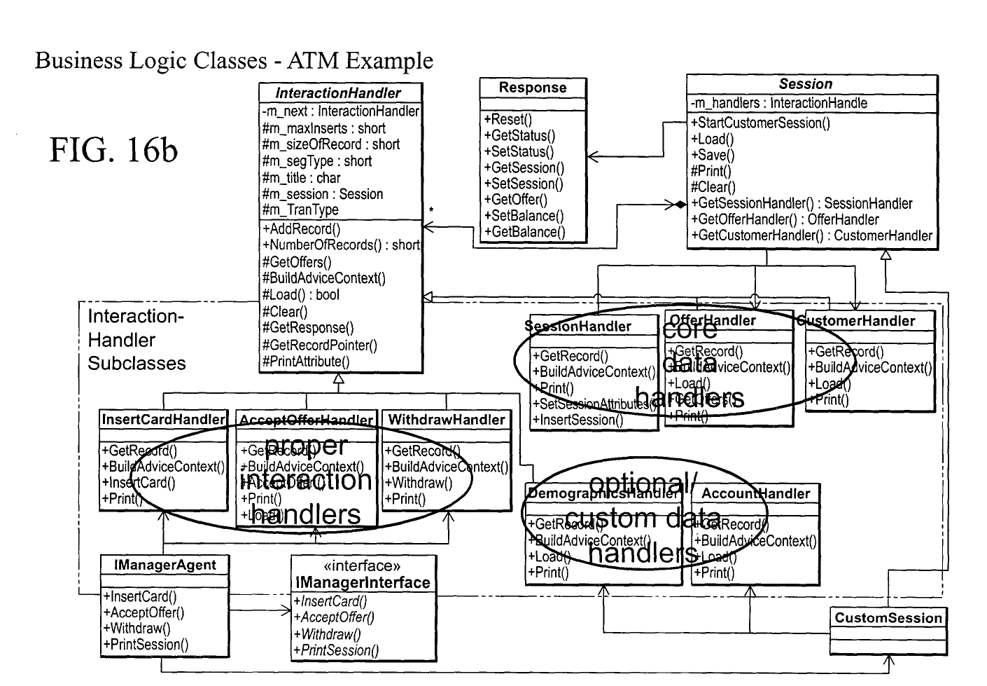

The static UML diagrams of FIGS. 16a,b, show the interrelationships between the business logic classes as embodied in the ATM example IM.

1. Overview of Business Logic Classes (ATM Example).

Note that the IM is a single threaded application. It deals with one interaction at a time. For this reason, each of the following classes is instantiated exactly once, at program initialization.

IManagerAgent is the entry point to the business logic of the IM, whether it is linked as a CORBA object, Tuxedo server or a standalone test driver. It constructs the Session object and one InteractionHandler object for each interaction type. It dispatches each request to the appropriate InteractionHandler object.

Response is an object that holds the response to the interaction that will be returned to the client.

Session is the brain of the IM. Its members include the essential data for a session. It also holds a list pointer to all of the InteractionHandlers. It calls each of the InteractionHandlers at the appropriate time within a session to do their work.

InteractionHandler is an abstract superclass for the various interaction types. Each class derived from the InteractionHandler conveys information to and from the Session (analogous to a nerve feeding signals to the brain). Each InteractionHandler can hold an array of records of a specialized type. Typically these records represent previous interactions of that type during the session. Each of these classes is responsible for storing and retrieving its own data into or from the ODS and passing such data on to the rules service for a recommendation. The InteractionHandler superclass takes care of storing this data in the session cache at the end of each interaction, and restoring from the session cache when a subsequent interaction for this session is process. Your custom code need not be directly concerned with saving and restoring state.

InsertCardHandler is a subclass of InteractionHandler that processes the InsertCard interaction of the ATM example. It looks up the customer ID by the ATM card number, and starts a new session. It calls the GetOffers method to obtain an offer from the rules service.

AcceptOfferHandler is a subclass of InteractionHandler that processes the AcceptOffer interaction of the ATM example. It accesses a current session identified by the session ID. It looks up the last offer extended (in the OfferHandler) and combines information from that to insert a TAcceptOfferRec record into both the session and the ODS.

WithdrawHandler is a subclass of InteractionHandler that processes the Withdraw interaction of the ATM example. It accesses a current session identified by the session ID. It checks and updates the account balance (in the AccountHandler) and updates the ODS.

OfferHandler is a subclass of InteractionHandler that holds all of the offers that have been made during the session. Since it implements the Load method, offers made in previous sessions are also loaded. All previous offers are passed to the rules service by the BuildAdviceContext method. (This information is used by rules service to avoid extending the same offer again and again.) The OfferHandler illustrates the fact that InteractionHandlers are not used only for interaction types. The OfferHandler also has the specific job of calling the business rules service, when the Session class calls the GetOffers method of the OfferHandler. The GetOffers method needs to retain each offer returned by the rules service and insert it into the ODS.

CustomerHandler is a subclass of InteractionHandler that is responsible for loading the customer (guest) table record, identified by the ZLE-assigned customer ID (guestID).

DemographicsHandler illustrates how to subclass InteractionHandler to handle customer-centric data from the ODS. Its Load method loads the demographics from the ODS. The demographics records are created in the eCRM example by the customer manager application, using Acxiom™. One may customize this module, replace it, or remove it if not using Acxiom™.

CustomSession is a subclass of Session for providing any customization of the behavior of the Session class.

SessionHandler is a subclass of InteractionHandler. It serves as a ‘helper’ to the CustomSession class. It allows custom attributes of the session to be saved as part of the session, and to be passed to the business rules service.

Using repeat invocations of the interaction wizard, additional subclasses of InteractionHandler can be created for each interaction type to be handled by the IM. For example, one might add a Deposit interaction to the ATM example.

In addition to the aforementioned classes, there are C-language modules largely corresponding to each of the handler classes. These C-language modules contain compiled SQL code used to access the ODS. In the ATM example, these modules are AcceptOfferSql, AccountSql, DemographicsSql, CustomerSql, IManagerSql, OfferSql, SessionCtxSql, and WithdrawSql. The functions defined within the C language modules are typically called from the corresponding InteractionHandler subclass.

2. Overview of Business Logic Classes (eCRM Example).

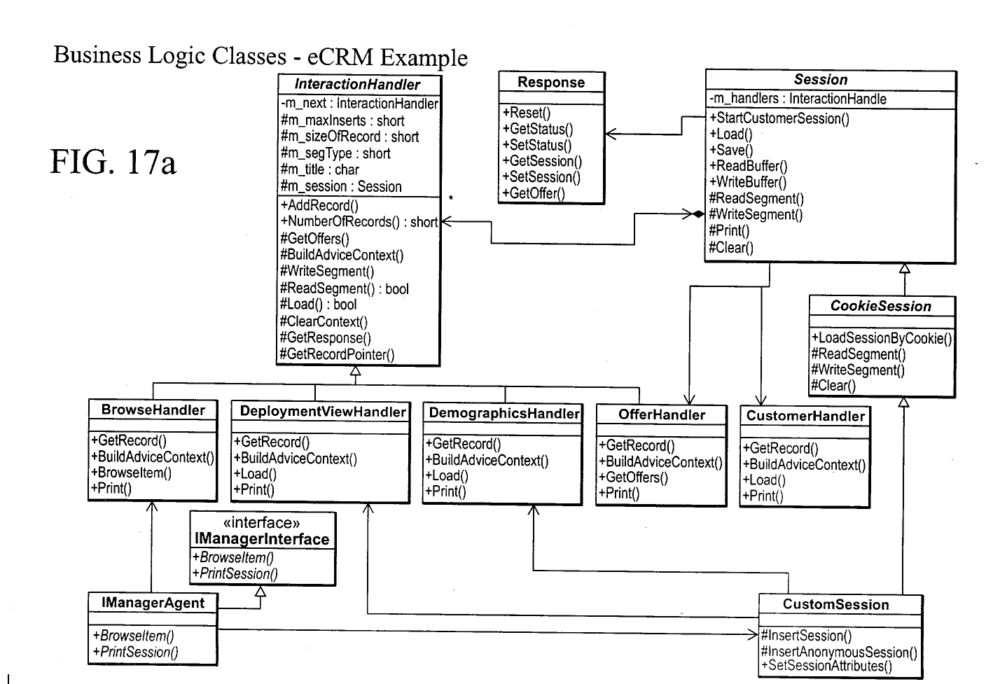

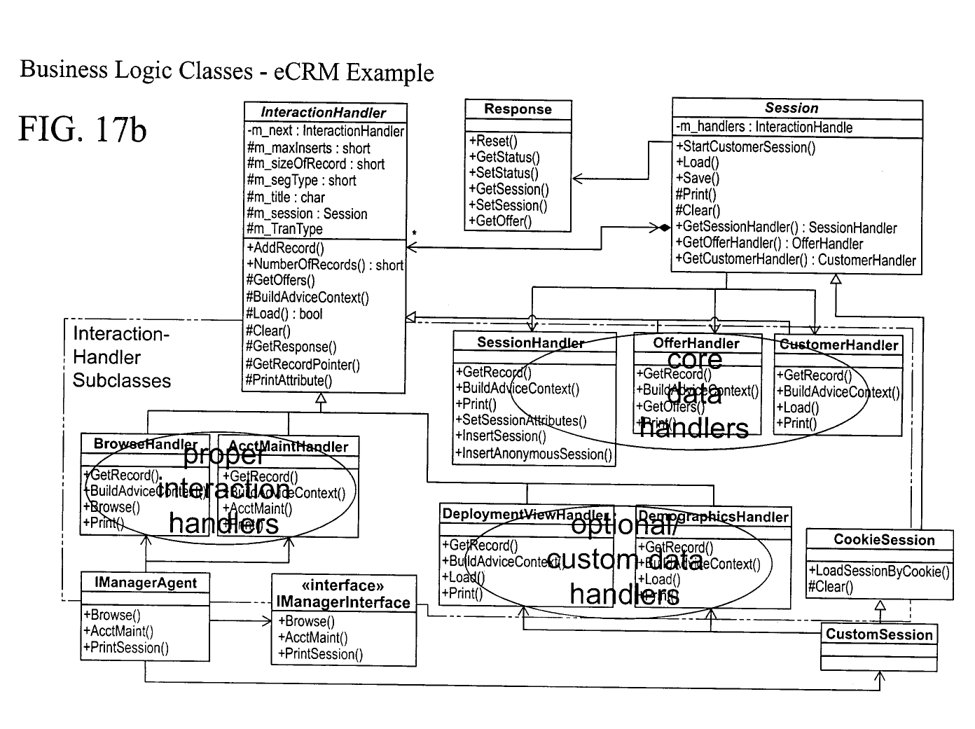

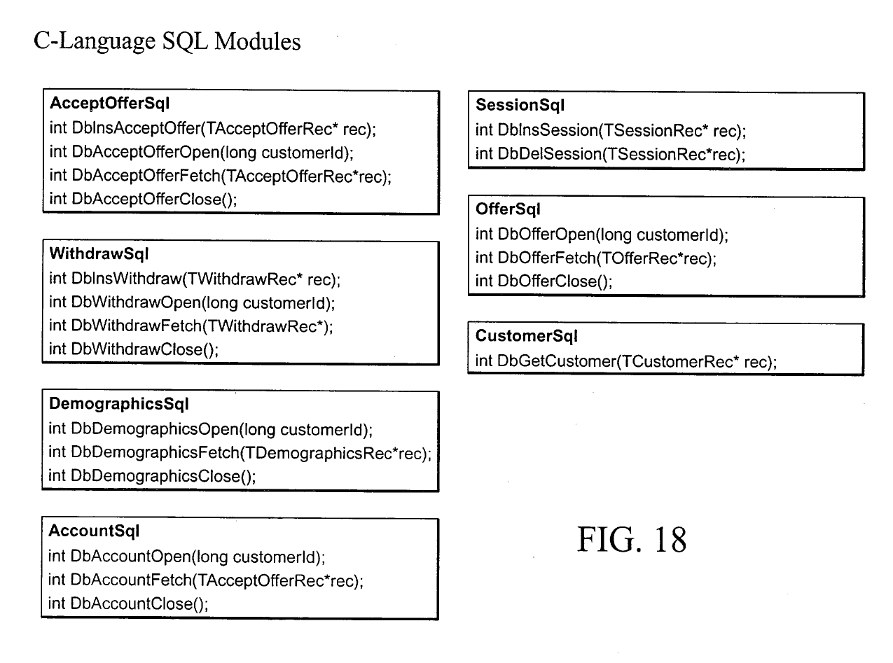

The static UML diagrams of FIGS. 17a,b, show the business logic classes of the eCRM example. It is very similar to the ATM example above. Therefore, this section covers classes that are different from the classes of the ATM example.

CookieSession is a subclass of Session that implements cookie semantics for a session. A CustomSession class can inherit directly from either the Session class (as in the ATM example) or the CookieSession class (as in the eCRM example). CookieSession provides means of identifying sessions and associating them with users via Cookies. Cookies are information stored on a particular computer, when that computer connects to a web set. Cookies therefore can be associated with more than one customer who shares the same computer (different members of a family, for instance). A customer can have multiple cookies also, since she may use multiple computers. If one does not intend to support cookies (for example, you are not providing web access), one should modify the CustomSession class to inherit directly from Session and remove CookieSession and CookieSql from your TDS project.

BrowseHandler is a subclass of InteractionHandler that implements the BrowseItem interaction of the eCRM example. It accesses a new or existing session using a cookie. It also supplies a customer ID. Oftentimes this customer is unknown (signified by a customer ID value of −1.)

AccountMaintHandler is a subclass of InteractionHandler that implements the AccountMaint interaction of the eCRM example. It constructs a new session using a customer ID. (AccountMaintHandler is omitted in the UML diagram for reasons of space.)

DeploymentViewHandler is another subclass of InteractionHandler in the eCRM example. It obtains deployment variables (aggregated data) for the customer from the ODS. These deployment views are typically created by a daily batch program managed by Genus Mart Builder, or built using Data Loader.

3. Business Logic Class Construction (Program Initialization)

The IManagerAgent constructor receives the ParamsReader object as a parameter. The ParamsReader object is used to obtain initialization parameters (from an initialization file).

The IManagerAgent constructor constructs the CustomSession object, passing the ParamsReader object.

The CustomSession constructor calls the CookieSession superclass constructor, and thus the Session superclass constructor, passing the ParamsReader object.

The Session superclass constructor constructs the OfferHandler and CustomerHandler passing its this pointer. The Session constructor also constructs the Response object.

The CustomSession constructor constructs any desired optional or custom subclasses of InteractionHandler that are not constructed by the IManagerAgent. Such subclasses maintain specific elements of a session, obtained from the ODS, which are NOT actual interactions. In the ATM example, these are the DemographicsHandler, SessionHandler and AccountHandler. The CustomSession passes its this pointer to these constructors. The IManagerAgent constructor then constructs each of the individual InteractionHandlers subclasses that process customer interactions, retaining the reference to each so that it can dispatch the actual interaction request to the appropriate InteractionHandler. In the eCRM case, the IManagerAgent constructs the BrowseHandler. The CustomSession object is passed to each of these constructors (implicitly upcast as a Session object).

Each InteractionHandler subclass constructor takes a reference to the Session object as a parameter and passes it to the InteractionHandler superclass constructor. The InteractionHandler constructor automatically adds the new InteractionHandler instance to the list of InteractionHandlers owned by the Session. Each InteractionHandler subclass constructor initializes various inherited members that customize the behavior of various InteractionHandler methods. These specify a unique type code for the interaction (m_TranType), an identifying string (m_title), a unique type code for the context segments (m_segType) and the size of records (m_sizeOfRecord).

4. Business Logic Customization Guidelines

a. General Customization Guidelines

Preferably, the abstract superclasses shown in the business logic framework diagram, InteractionHandler, Session and CookieSession should not be customized (FIGS. 16a,b & 17a,b). The concrete subclasses can be freely modified, however. The behavior of these abstract classes can be customized by overriding their virtual methods in the concrete classes. Methods are declared as virtual if it is anticipated that their behavior may need to be overridden during customization (although one may not be able to anticipate in advance every customization need).

There are additional classes in the IM business logic framework (although they are not shown in the UML diagram). The Session object hides most of these classes. Preferably, these classes should not be customized or accessed directly so as to allow future changes in subsequent ZDK releases.

If providing custom logic to be used in multiple interaction types, it should be preferably implement directly in the CustomSession class, or a public method should be in the CustomSession class to access the object that implements the logic. This way, each of the InteractionHandlers can obtain access to the logic, by casting its session reference (m_session) to CustomSession. Typically, the logic is implemented specifically to a particular interaction type in the corresponding InteractionHandler subclass.

b. Interaction Handling Guidelines

An InteractionHandler subclass is implemented using the interaction wizard for each distinctive interaction type in the IM application. Steps that are automated by the interaction wizard are asterisked in this and subsequent sessions.

*The constructor of the IManagerAgent is required to construct the InteractionHandler subclass and retains a reference to it in a member of the class.

*The InteractionHandler subclass is required to contain a method with the same name and parameter that the interaction has in the business logic interface. The IManagerAgent dispatches the corresponding request to this method.

*The InteractionHandler subclass is required to accesse a session by invoking one of three methods in the Session or CookieSession class: StartCustomerSession, Load, or LoadSessionByCookie.

*The InteractionHandler subclass is required to invoke m_session.StartCustomerSession when the interaction starts a new session for a known guest (See: InsertCardHandler in ATM example). The interaction record supplies a customer ID. The Session class assigns a new session ID for the session. The interaction then returns the session ID to the client in the Response object so that the client can supply the session ID on subsequent access. The interaction wizard generates the StartCustomerSession call, passing the customer ID from the input record, when the parameter pair-session customer is specified.

*The InteractionHandler subclass is required to invoke m_session.Load when the interaction uses a session ID to access a session that is already open. (See WithdrawalHandler in the ATM example.) The interaction wizard generates the Load call, passing the session ID from the input record, when the parameter pair-session id is specified.

*The InteractionHandler subclass is required to invoke (CookieSession*)&m_session).LoadSessionByCookie when the session is accessed via a client-supplied cookie. (A cookie is a unique string stored on the user's computer by the web server. It uniquely identifies the user's computer rather than the user herself.) The session member must be cast to a CookieSession as above. (See: BrowseHandler in the eCRM example). If the client supplies the customer ID, it also passes the customer ID. The partition ID may be specified, otherwise partitions are assigned in round-robin fashion. The CookieSession class itself is responsible for determining when a new session starts (based on timeouts) and who the customer is, if it is not supplied and there is prior customer data for this cookie. The interaction wizard generates the LoadSessionByCookie call, passing the cookie from the input record, when the parameter pair-session cookie is specified. If the interface specifies some other means for identifying the customer (other than the ZLE-assigned customer ID), the business logic must map the customer identification to a customer ID before calling StartCustomerSession or LoadSessionByCookie. Refer to the InsertCardHandler of the ATM example for the use of an ODS table to map an ATM card number to a customer ID.

*The InteractionHandler subclass is normally required to create a table record from the interaction record, and insert it into an ODS table, using a compiled SQL c-language function. (See AcceptOfferHandler and AcceptOfferSql in the ATM example.) See the section “SQL Function Customization Guidelines” below for more details.

*The InteractionHandler subclass is normally also required to insert the table record for the interaction into the active session cache. The AddRecord method of the InteractionHandler superclass is used to do this.

The InteractionHandler subclass is required to call the inherited GetOffers method in order to forward the data in the current session to business rules service (Blaze Advisor) and obtain an offer or recommendation in response. The interaction wizard inserts this code but comments it out. However, when ready to call the rules service from this interaction, the comments should be removed. In addition, the InteractionHandler subclass inserts information that must be returned to the client into an instance of the Response object held by the Session. To access the Response object, the GetResponse method should be called.

Error codes are returned by calling the SetStatus method of the Response object. It is possible to customize the Response class to return additional data to the client. Finally, the InteractionHandler subclass needs to call the Save method of the session object when it completes handling an interaction.

c. Interaction Handler Construction Guidelines

The constructor of an InteractionHandler subclass is required to set certain inherited member variables in order for other inherited methods to work properly. With the one exception noted below, these requirements apply both to InteractionHandlers that process interactions and InteractionHandlers that are used only for data handling. (The AcceptOfferHandler of the ATM example is referenced in the following paragraphs)

*The constructor of the InteractionHandler subclass is required to set m_sizeOfRecord (using the C++ sizeof operator) to size of the table record associated with this interaction type (TAcceptOfferRec).

*The constructor of the InteractionHandler subclass is required to set m_segType to an enum SEGTYPEE value (e.g., SEG_ACCEPTOFFER) that is declared in CustomTypes.h. The interaction wizard currently generates the definition but does not assign a unique number. CustomTypes.h needs to be edited to make the numeric value unique.

*The constructor of the InteractionHandler subclass is required to set m_TranType to an enum INTERACTIONTYPE value (e.g., TTAcceptOffer) defined in CustomTypes.h. This step can be skipped if this InteractionHandler subclass is only used to load customer data from the ODS. The interaction wizard currently generates the definition but does not assign a unique number. However, CustomTypes.h needs to be edited to make the numeric value unique.

*The constructor of the InteractionHandler subclass is required to set m_title to a descriptive string (e.g., “AcceptOffer”).

If the business logic needs to insert more than one record of this type during a single interaction, m_maxInserts needs to be set to the appropriate maximum value; otherwise, m_Maxinserts is set to 1 by default. The InteractionHandler automatically reserves a contiguous block of memory when loading interactions in the Load method, or when restoring interactions from the session cache. There is no fixed limit on how many records can be loaded at the beginning of the interaction. The m_maxinserts parameter determines how much additional memory will be reserved for AddRecord calls made after loading is complete. Typical InteractionHandlers call AddRecord at most only one time per interaction (apart from the Load method). The default value of 1 needs to be overridden only in unusual circumstances.

d. Interaction Handler Template Method Customization Guidelines

*The InteractionHandler subclass should implement (inline in the header) a GetRecord method that takes an index as its parameter and returns a reference to the table record (e.g., TAcceptOfferRec) handled by this InteractionHandler. This method calls the GetRecordPointer method of the superclass and casts the result to the appropriate type.

Note that certain InteractionHandlers handle only a single record (CustomerHandler, SessionHandler). Consequently the GetRecord method of these classes do not have any parameters. They call GetRecordPointer with an index value of 0. The InteractionHandler class defines several template methods that may be overridden in the InteractionHandler subclass.

*The InteractionHandler subclass is required to implement the Load method if data is to be loaded from the ODS at the beginning of a session. The methods are then invoked in the corresponding C language SQL module to read the selected records. If Load is not implemented, there will be no customer data in this InteractionHandler at the beginning of a session. The interaction wizard creates this method automatically (except when the -session customer parameter pair is specified). If there is no need to load prior interactions, the method body should be replaced with an empty pair of braces.

It is noted that if the interactions or data held by this InteractionHandler are relevant to the business rules, the BuildAdviceContext method needs to be implemented. This method should copy the relevant data to the AdviceContext record that will be passed to the business rules service to obtain an offer. The Interface Definition Language (IDL) code of the Rules Service needs to be first modified and recompiled to receive this data. Moreover, when applicable, CORBA::string_dup should be used to pass strings. (See: DemographicsHandler in the eCRM example.) The interaction wizard creates a skeletal implementation of this method, which you will modify.

*In addition, the Print method should be implemented so that it displays the interaction data to the console. This helps in validating and debugging the business logic behavior when the application is running in standalone mode (a wizard does this and no manual customization is required).

e. Customer Data Handling Guidelines

A subclass of InteractionHandler should be created for each table in the ODS which contains data directly or indirectly related to the customer, that is relevant to the business rules. These InteractionHandler subclasses don't actually process interactions, and don't do any of the session-related logic described under “Interaction Handling Guidelines.” We will refer to such classes as “data handlers.” The interaction wizard should be used to create these classes, specifying the -d parameter. Steps that are at automated by this wizard are asterisked in this and subsequent sessions.

*The CustomSession class is needed to construct each of the data handler classes.

*A data handler always implements the Load method, as described in the section titled “Interaction Handler Template Method Customization Guidelines” below.

DemographicsHandler is an optional data handler provided with the IM template. It is constructed in the CustomSession class. If demographics is not used, one should remove the call to the DemographicsHandler constructor, and further remove the DemographicsHandler and DemographicsSql from the IManager.idl TDS project. A data handler may need to be build in order to obtain aggregated data about the enterprise customer(s). The DeploymentViewHandler of the eCRM example shows one way of doing this.

f. Customer Data Customization Guidelines

The customer table will surely need to be customized to reflect the customer attributes of interest for the particular business. The primary place to handle these additional attributes is in the CustomerHandler.

The Load method of the CustomerHandler needs to be modified to read additional members of the Customer table into the session. The files Customer.h and CustomerSql.c will also need to be modified.

The BuildAdviceContext method of the CustomerHandler needs to be modified to pass additional customer attributes to the business rules service.

Note that the CustomerHandler is different from other InteractionHandlers in that it holds only a single record. If NumberOfRecords ( ) returns 1, the customer record exists, and if NumberOfRecords( ) returns 0, the customer record does not exist. This class might serve as a useful model if there is some other table from which the launched application selects only a single record (per session).

g. SQL Function Customization Guidelines

*The interaction wizard, each time it is executed, creates a module (e.g., a C-language module) containing compiled SQL functions used to insert/retrieve the table records to/from the ODS. The module contains skeletal implementations of the functions described below, which must be completed. The AcceptOffer interaction is used here as an example. The table record, TAcceptOfferRec, is defined in AcceptOffer.h. In this implementation, as shown in FIG. 18, the name of the C-language module is AcceptOfferSql.

The function that inserts a table record (DbInsAcceptOffer) to handle the additional attributes of that record needs to be customized. This method is used to insert a new interaction into the ODS. This step can be skipped, however, if this record will not be inserted into the ODS.

The function that opens a query for loading records (DbAcceptOfferOpen) to select the additional attributes of the record needs to be customized. This method is called from the Load method of the InteractionHandler. This step can be skipped, however, if the Load method is not going to be implemented

The function that fetches a record (DbAcceptOfferFetch) to fetch the additional attributes of that record needs to be customized. This method is called from the Load method of the InteractionHandler. This step can be skipped, however, if the Load method is not going to be implemented.

The WHERE clause of the query for loading records (DbAcceptOfferOpen) may need to be customized to reduce the number of table records loaded. By default, it loads all interactions from sessions associated with the current customer. For example, one might only wish to select interactions since a particular date.

The UNIQUE ON clause may be specified to limit the number of records loaded.

By default, the query for loading records for a data handler selects all records with the current customer ID. Data handlers may also be used to access tables that are not keyed by the customer ID. In this case you will need to customize the query, perhaps doing a join or a nested select. For example, the DbAccountOpen method of the ATM example (in AccountSql.c) is customized to fetch specific account numbers (for savings and checking) identified in the Customer table.

h. Session Customization Guidelines

If the deployed application uses cookies, the CustomSession should be derived from CookieSession (See: eCRM example, FIGS. 17a,b). If the application does not use cookies, the CustomSession should be derived directly from Session, and CookieSession should be omitted (See: ATM example, FIGS. 16a,b.)

If the CookieSession table is customized, the files TSessionRec.h and CookieSessionSql.c should be modified as well.

The CustomSession class implements the template method InsertSession, so that one can customize the attributes of the CustomerSession table, which holds information on known customer sessions.

If the CustomerSession table is to be customized, the files TSessionRec.h and SessionSql.c will need to be modified as well.

The CustomSession class implements the template method InsertAnonymousSession, so that one can customize the attributes of the CookieSession table, which holds information on anonymous sessions. This method should be omitted if the CustomSession class is not derived from CookieSession.

The custom session record is held in memory by the SessionHandler class. CustomSession calls the AddRecord method of the SessionHandler to hold the session record. Thus, there is only one modification one will likely need to make to the SessionHandler. That is, the BuildAdviceContext method of the SessionHandler needs to be customized in order to pass relevant session attributes to the business rules service.

The SetSessionAttributes method of the CustomSession class is provided so that an InteractionHandler subclass can pass custom attributes of a session. This is the manner in which the CustomSession obtains customized attributes that it inserts into the GuestSession and CookieSession tables. For example, the InsertCardHandler passes the ATM number and ATM card number using this method. In order to pass any custom session attributes, the parameters of this method need to be customized.

As typified by the InsertCard interaction of the ATM example, an interaction that starts a session is likely to contain attributes that are relevant to all of the interactions of the session. For reasons of economy, it is preferred to make those attributes of the Session record, and bother creating a separate interaction table to hold the InsertCard interactions. When the -session customer parameter pair is specified, the code generated by the interaction wizard follows this model: no code to insert the interaction into the session is generated.

i. Offer Handler Customization Guidelines

The OfferHandler handles the offers that are returned from the business rules service. This class needs to be customized to reflect the specific attributes of an offer returned by the rules service.

The OfferHandler is another subclass of InteractionHandler. Consequently it follows all of the rules that apply to a data handler (an InteractionHandler that does not process interactions.)

The OfferHandler BuildAdviceContext method is expected to copy prior offers received into the AdviceContext record before the business rules service is called. This allows business rules to consider what previous offers have been made. (Oftentimes it is not a good idea to repeatedly make the same offer.)

The OfferHandler GetOffers method is called in order to invoke the business rules service. It first calls BuildAdviceContext method of the Session class. After the business rules service is invoked the offer needs to be stored in the ODS and inserted into the active session by calling AddRecord.

The Offers_Det table may need to be customized in order to hold additional attributes of offers that have been returned by the business rules service. In relation to that, the files TOfferRec.h and OfferSql.c will have to be modified as well.

The Response class should be modified in order to return additional offer attributes to the client.

The Load method should be implemented if your business rules need to know about offers made in previous sessions.

G. Technical Comments: Aggregation and Use of the Decorator Pattern

In the UML diagrams, ‘collections’ are represented using the composition symbol: [symbol] Each of these collections, both in the business logic framework and in the test driver framework, have been implemented in the same way, as a linked list. However, this is fairly transparent to the template user since the collection relationships hold between abstract superclasses. And, usually, only the subclasses in these collection relationships are customized.

The owning class in the collection relationship (on the end with the diamond) has a pointer to the first instance in the linked list. Each item in the list has a pointer to the next instance (of the same class) on the list. These pointers are private. Each item in the list also has a protected pointer to the instance of the owning class. The subclass can obtain access to the parent of the super class through this pointer. The constructor for the owned class always takes a reference to the owning class as a parameter, and inserts itself into the linked list. The owned class always has at least one method that traverses the linked list. The owning and owned superclasses are declared friend to each other, so that they can access each other's private linked list pointers.

Often, design patterns commonly known as decorator are applied to these collections. In this case, each instance in the linked list is of a different subclass of the same super class. Each instance is called in turn to do its specific work. To a significant degree, the IM is customized by creating additional decorators. Load, BuildAdviceContext, and Print are all applications of the decorator pattern. Each InteractionHandler subclass does its part of the relevant job when these methods are called.

The Parse method of the ParseInteraction subclasses of the Test Driver framework (covered below) makes use of a related design pattern, known as Chain-of-Responsibility. Only one subclass handles any individual task. The classes that cannot perform the task return false. When subclass ParseInteraction can perform the task, it does so and returns true. No additional subclasses are called once one has returned true. An error is reported if none of the subclasses return true.

VI. Test Driver

A. Test Driver Framework

1. Test Driver Class Overview (ATM Example)

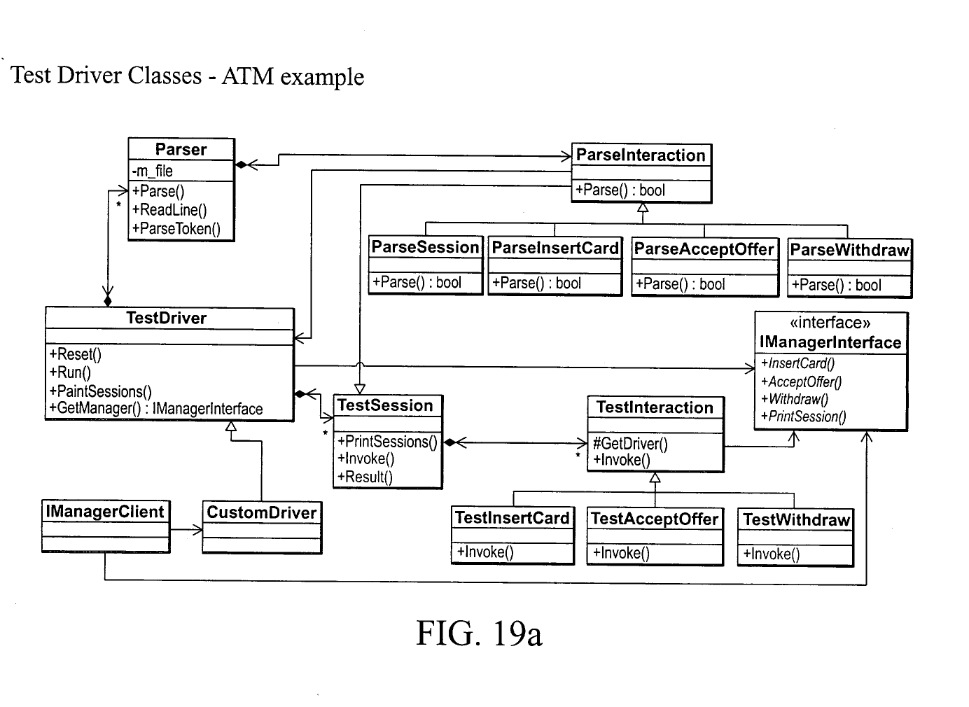

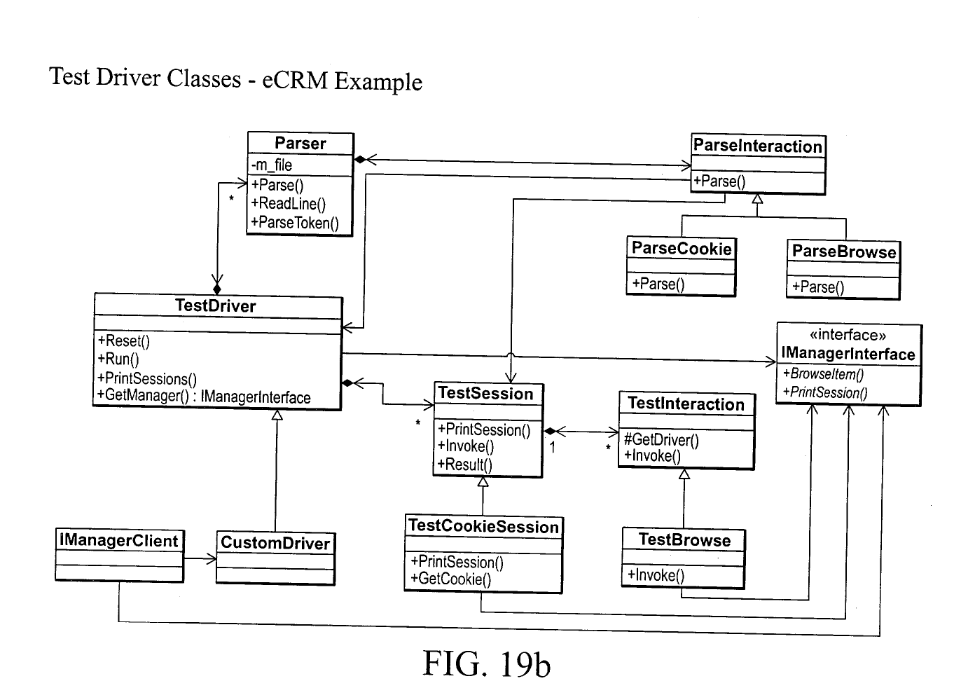

The static UML diagram of FIG. 19a, shows how the Test Driver framework classes are interrelated within the ATM example. The classes ParseInsertCard, TestInsertCard, ParseAcceptOffer, TestAcceptOffer, ParseWithdraw and TestWithdraw are created by the interaction wizard. The other classes are created by the IM Application/Project Wizard.

IManagerInterface exposes the methods of the service. It is the piece that plugs into the Deployment Framework. This is an abstract class. Different subclasses provide access to Tuxedo server and to the CORBA server. In standalone mode, the IManagerAgent is the subclass used.

IManagerClient provides the main method of the test driver, which gets the command line arguments. The IManagerClient obtains a reference to the concrete IManagerInterface and passes it to the test driver.

TestDriver is the entry point to the Test Driver logic. Its constructor calls Parser with the name of the top-level test script file. Parser will construct a number of TestSessions in the TestDriver.

The TestDriver Run method will execute those sessions one or more times.

The CustomDriver subclass provides a means to customize the TestDriver without directly modifying the TestDriver code.

Parser handles an input test script file. Parser is invoked only during the initial phase of the program. The test script file is parsed in its entirety before testing begins.

ParseInteraction parses the portion of the script that defines a single interaction. Subclasses of ParseInteraction are implemented for each distinct interaction type. Each interaction in the script begins with a keyword. Parser calls the Parse method of each subclass of ParseInteraction, passing the keyword from the script file, until one subclass indicates its recognition of the keyword, by returning true. Before returning, the subclass must in that case parse the entire body of the interaction in the script. Each subclass of ParseInteraction is instantiated exactly one time.

TestInteraction represents a single test interaction. A separate subclass of TestInteraction is implemented to handle each distinct interaction type. TestInteraction subclasses can be instantiated many times. A TestInteraction is instantiated each time that an interaction appears in the test script. Each TestInteraction subclass calls the corresponding method defined in the IManagerInterface, with interaction record required by that particular interaction. The interaction record must be therefore an instance member of the TestInteraction subclass, and must be supplied when the instance is constructed. Certain specific members of the interaction record (normally only session ID or cookie) are obtained from the parent TestSession or TestCookieSession object. When the driver is running in standalone mode, the TestDriver calls the PrintSession method of each TestSession just before it exits. This allows the user to see the complete accumulated contents of each session. This is useful in verifying that all of the InteractionHandler subclasses are doing their work. This can help one determine if the right data is sent to the business rules service to obtain the recommendations expected.

ParseSession parses the test script keyword “Session”, and constructs a TestSession object. Subsequent keywords will construct TestInteraction subclasses owned by the new TestSession object.

The TestSession object contains all of the interactions for a distinct session. A TestSession can contain any number of interactions of various types, constrained only the semantics of the application. Note that a TestSession can really contain one or more distinct IM sessions, executed in sequence. For example, we use a single TestSession to simulate 2 successive visits to an ATM by the same customer.

The Invoke method of the TestSession class invokes the next interaction of the test session, by calling the Invoke method of the TestInteraction. Invoke returns false when no interactions remain in the test session. TestDriver simulates a real environment in which many sessions run concurrently. It currently cycles through the sessions round-robin, instructing each to invoke a single interaction. It stops when all of the TestSessions indicate that they are finished. In the future it may invoke test sessions in random order, in order to provide a more realistic test load.

The Reset method of the TestSession object is called before each execution of a session.

The PrintSession method of the TestSession class invokes the PrintSession method of the IManagerInterface, passing the session ID as a parameter. This method is implemented by the IManagerAgent, which calls the Load and Print method of the Session class, inside the business logic framework. This method is not implemented in the IManagerTuxedoAdapter and IManagerCorbaAdapter, since these client stubs do not have direct access to the business logic classes.

The PrintSession method of the TestCookieSession class invokes the PrintSession method of the IManagerInterface, passing the cookie as a parameter. This method is implemented by the IManagerAgent, which calls the LoadSessionByCookie and Print methods of the Session class, inside the business logic framework. This method is not implemented in the IManagerTuxedoAdapter and IManagerCorbaAdapter, since these client stubs do not have direct access to the business logic classes.

The ParseInsertCard class parses the keyword “InsertCard”, and name-value pairs “CARDNUMBER” and “ATMID”, filling an InsertCardRec, and constructs a TestInsertCard object.

TestInsertCard invokes the InsertCard method of the IManagerInterface, passing the InsertCardRec.

The ParseAcceptOffer class parses the keyword “AcceptOffer”, and name-value pairs “CONTACT”, filling an AcceptOfferRec, and constructs a TestAcceptOffer object.

TestAcceptOffer inserts the session ID from the TestSession into the AcceptOfferRec and invokes the AcceptOffer method of the IManagerInterface, passing the AcceptOfferRec.

The ParseWithdraw class parses the keyword “Withdraw”, and name-value pairs “ACCTTYPE” and “AMOUNT”, filling a WithdrawRec, and constructs a TestWithdraw object.

TestWithdraw inserts the session ID from the TestSession into the WithdrawRec and invokes the Withdraw method of the IManagerInterface, passing the WithdrawRec.

2. Test Driver Class Overview (eCRM Example)

The UML diagram of FIG. 19b, shows the test driver classes of the eCRM example. The classes ParseBrowse and TestBrowse would be created by the interaction wizard. ParseAccountMaint and TestAccountMaint, are also part of the eCRM test driver, but are not shown above. The following notes discuss the classes that are not part of the ATM example. Incidentally, the eCRM example was created prior to the completion of the. template, so it does not follow the model described in subsequent sections in every detail.

ParseCookie parses the line beginning with the keyword “Cookie”. It constructs a TestCookieSession object.

TestCookieSession session is a subclass of TestSession that is used when a session is identified by a cookie. It holds the value of the cookie (obtained from the test script) so that it can be passed on subsequent interactions.

ParseBrowse parses the browse interaction for the eCRM example IM. It parses interactions that begin with the keyword “Browse”. ParseBrowse also recognizes keywords within the body of the interaction: “GUEST”, “INTSUBTYPE”, “DEPT”, “CLASS” and “ITEM”. ParseBrowse constructs a TestBrowse object.

TestBrowse invokes the BrowseItem interaction of the IManagerInterface, using the cookie from the current CookieSession.

3. Test Driver Class Construction

IManagerClient constructs the CustomDriver, passing a reference to the IManagerInterface. These parameters are passed upwards to the TestDriver constructor.

The TestDriver constructor constructs the Parser, passing the filename as a parameter.

The CustomDriver constructor constructs in turn each of the ParseInteraction subclasses used in this application.

Each of the ParseInteraction subclass constructors takes a reference to the Parser. The parent ParseInteraction constructor adds that class instance to the list owned by the Parser.

The Parse method of most ParseInteraction subclasses will construct the corresponding TestInteraction subclass instance, each time that the corresponding interaction is invoked within the test script.

The Parse method of certain ParseInteraction subclasses (those which always start new sessions, such as InsertCard of the ATM example) constructs a new TestSession before constructing the relevant TestInteraction.

The Parse method of ParseCookie will construct the corresponding TestCookieSession subclass instance, each time that the COOKIE keyword is specified within the test script.

The constructor of the TestSession takes as a parameter the TestDriver class reference. It chains itself onto the list held by that TestDriver instance.

The constructor of the TestInteraction takes as a parameter the TestSession class that owns it. It chains itself onto the list held by that TestSession instance.

4. Test Driver Customization Guidelines

a. General Test Driver Customization Guidelines

The classes TestDriver, Parser, ParseInteraction, TestSession, TestCookieSession and TestInteraction need not be modified, although they can be modified. IManagerClient is a complete application as implemented, supporting features such as timed performance testing, and it may also remain unchanged.

b. Parser Customization Guidelines

With invocations of the interaction wizard, a separate subclass of ParseInteraction is created for each interaction type. Steps performed automatically by the interaction wizard are asterisked in this and subsequent sections.

*The Parse method of the ParseInteraction subclass tests the value of the keyword passed in and return false if it does not match the unique keyword assigned for this interaction type. Otherwise it constructs and initializes the interaction record. Then it commences a loop, calling ReadLine and scanning the input test script. Within the loop in the Parse method, a test should be inserted for each keyword allowed within the interaction and its corresponding value should be stored in the interaction record that is passed on this interaction type. The interaction wizard creates the skeletal loop, to which the code is added to parse each attribute of the interaction record.

The Parse superclass contains a method called NewString to be used in adding members declared char* to the interaction record. NewString takes as its parameter a null terminated char array, allocates the exact number of bytes required, and returns a copy of the string. As an example, see how contactInfo is added to the AcceptOfferRec by ParseAcceptOffer in the ATM example.

*After parsing is completed, call is made to a constructor for the corresponding TestInteraction subclass, passing the parent TestSession along with the record containing the parsed values.

*CustomDriver constructs each ParseInteraction subclass once only within the its constructor. The constructor gets the Parser as its only parameter. It does not retain a reference to these objects, as the ParseInteraction constructor automatically adds the object to the list owned by Parser.

c. Test Object Customization Guidelines

Using invocations of the interaction wizard, a separate subclass of TestInteraction should be created for each interaction type. Again, steps performed automatically by the interaction wizard are asterisked in this and subsequent sections.

*The initializer of the constructor of the TestInteraction subclass should call the superclass constructor and store the reference to the interaction record supplied.

*The constructor of the TestInteraction subclass should obtain the cookie from the parent test session and set it in the interaction record (if needed).

*The Invoke method of the TestInteraction subclass should obtain the session ID of the parent session and set it in the interaction record (if needed).

The Invoke method of the TestInteraction subclass should call the corresponding method of the IManagerInterface, passing the interaction record stored within the object. It is possible to customize the information printed from the response in the Invoke method of the TestInteraction subclass.

5. Testing the IM—simulating sessions.

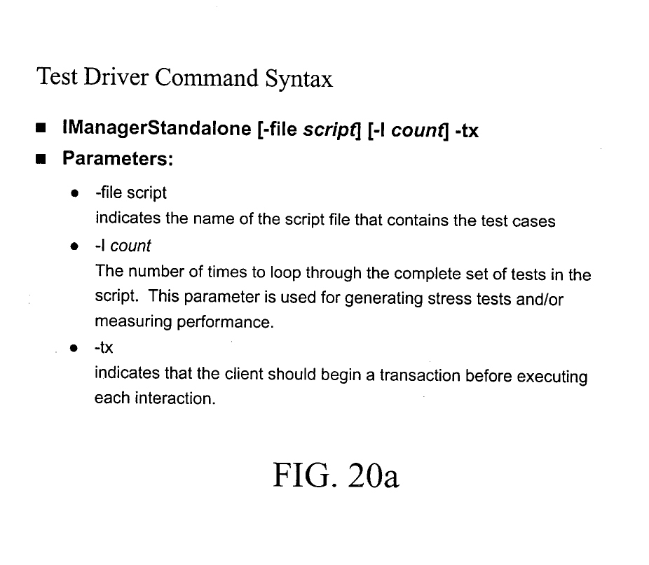

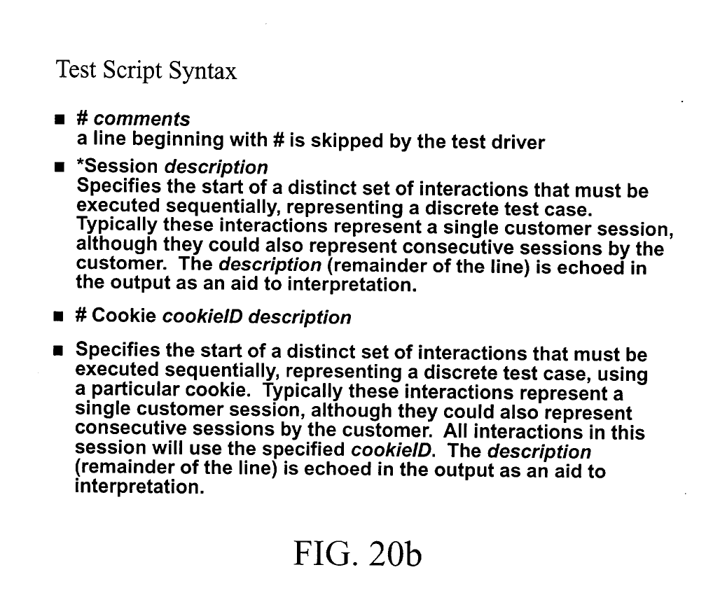

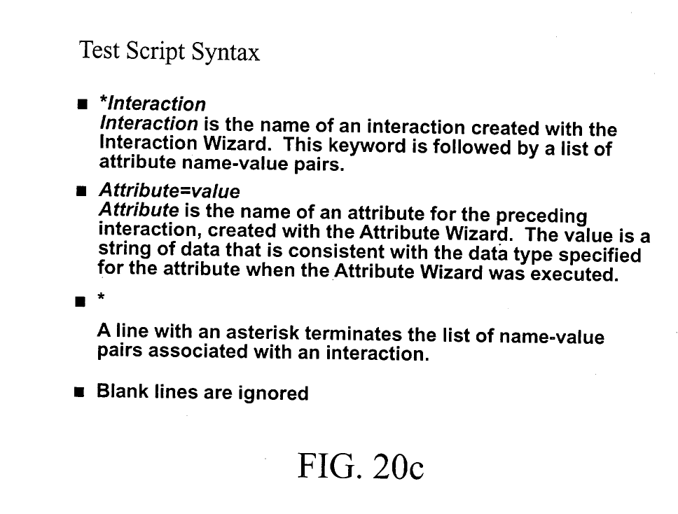

To test the IM, a session—i.e., a series of interactions—is simulated. As mentioned before, the test driver is generated when the IM is generated via the project that the wizards generate (see FIGS. 20a-c). Actually, there are several different library components, including a driver component, a business logic component and a CORBA and Tuxedo deployment component. These library components are within one project out of which one can build different executables. For instance, one can build the standalone executable.

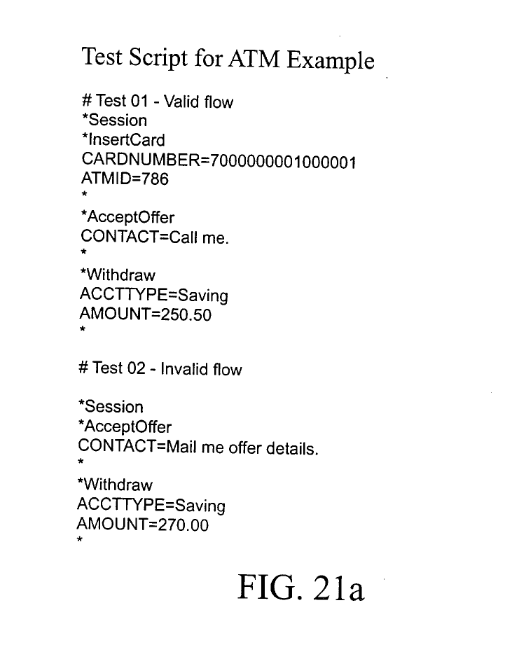

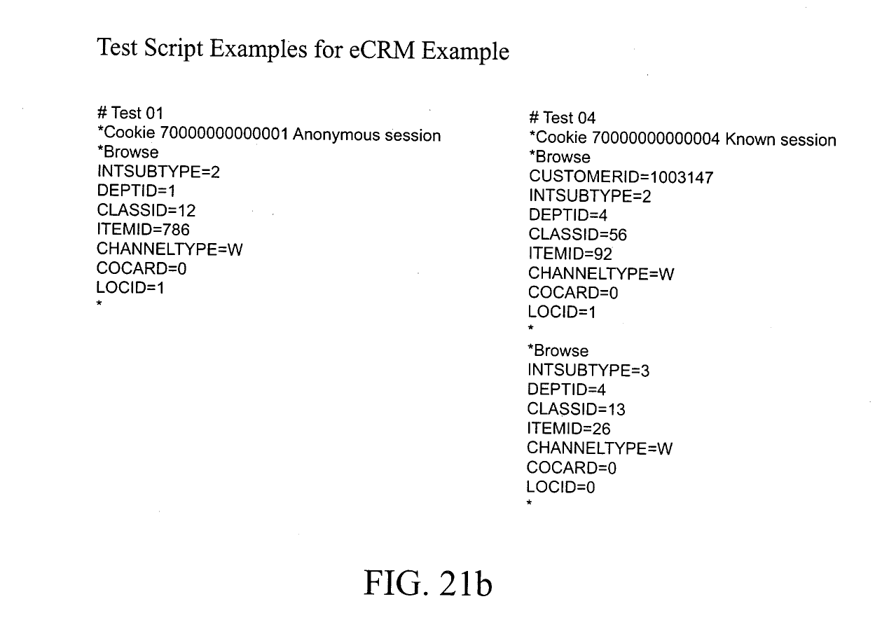

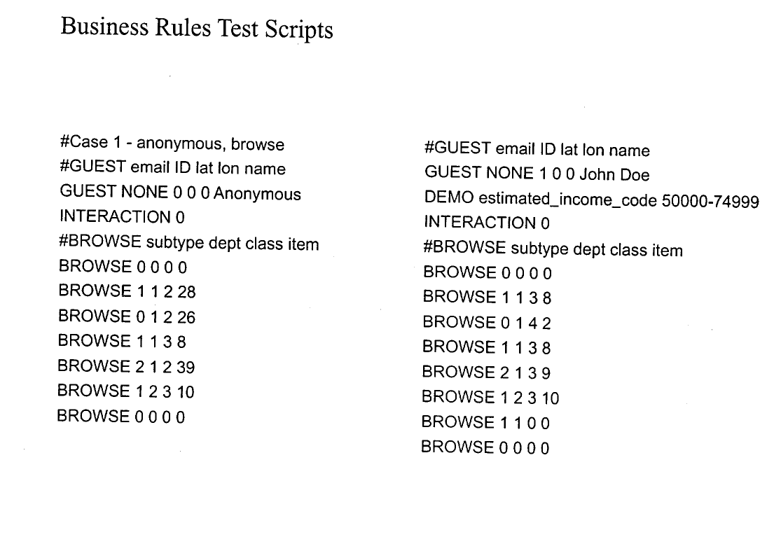

The test script file provides the test case driver that passes the data. For performance testing, the script file can include instructions to loop over the complete set of tests some number of times. The test script may further provide for beginning a transaction before each interaction. FIGS. 21a,b, illustrate test script syntax for the ATM and eCRM examples, respectively. FIG. 21c illustrates the business rules test scripts.

In the ATM and eCRM examples, the syntax of a test script includes terms such as *Session, indicating the start of a test session (a comment describes the test session). A *Cookie followed by a CookieID (and a comment), is used to start a session that is making use of a cookie. An *Interaction is the name of the interaction, e.g., Browse. When the interaction wizard is invoked, the Browse interaction is specified since the test driver was customized to recognize *Browse as a word that could be encountered in the script. The interaction name is followed by attribute-value pairs that are associated with that interaction. Again, the driver is customized by the attribute wizard so that it would read the attribute names, e.g., Latitude and Longitude. Namely, the test script provide a list of ‘name=value’ pairs such as ‘Latitude=value’, ‘Longitude=value’, and that list can be terminated with a new-line character. Incidentally, an error message is generated if the list includes an attribute name that doesn't exist or a value that doesn't make sense for the data type of the attribute.

As shown for example in FIG. 21b, the script for Test 01 simulates a session with a Browse Interaction. As mentioned, the cookie number comes from the customer's computer that interacts with the eStore system and it is assigned for instance by the web server for identification purposes.

When the test driver is invoked, it reads the entire script, parses it and makes a determination as to problems with the script, if any. If there is a problem with the script, the test driver will provide a notice immediately before it begins to execute it. The test driver takes that script and actually creates an internal representation of each of the interactions, and it groups those interactions into sessions. Then the test driver does something else that is interesting, it ‘clutters’ (e.g., interleaves) the sessions.

Consider the situation where the script refers to a number of sessions that one wants to test. The simple way to do that would be to take one session at a time and simulate (run) all its interactions. However, that wouldn't be a realistic test, because in the real world the IM is handling multiple concurrent sessions in the order which it receives requests (which come in randomly). The IM has to keep strict ordering and remember with whom it is talking to at each instance. Therefore, the Test Driver interleaves (clutters) all of those sessions, and when it reaches the last interaction for a particular session it cannot process anymore interactions for that session.

As for test results, the test driver displays its output (log) in the order in which the sessions are executed. At the end of the log, the driver goes to the session context (which is identified by the session ID or the cookie). The test driver outputs all the session contexts, which is helpful for debugging purposes. The test driver finds a session and displays its contents. Note that this works only when running standalone mode. It doesn't work when running the test driver as a separate program at the client, unless the session ID is available, because the test driver doesn't have access to the session (as the session only happens at the server). When running as a stand-alone program, the test driver has direct access to all the data that the IM is handling. This is particularly helpful when trying to also debug the business rules when certain conditions are triggered, as the test driver provides a log for the business rules. Between the developer/implementer who is writing the business rules and the developer/implementer who is writing the IM, they both have their own audit trail to compare and see where a particular problem is occurring if they are not getting the right rules to fire. Note that there is a wizard for the business rules, but we don't necessarily have the equivalent of the interaction wizard or attribute wizard for the rules service template (although for further customization it is possible to implement such wizards for the rules service).

To recap, the present invention envisions a set of programming tools, primarily an interaction manager template. In the preferred form, the interaction manager template is a class framework that allows enterprise-specific deployment of an interaction manager (IM). With the assistance of wizards, and with class libraries, source code, scripts and documentation the IM template is established as an application framework customized to support the special needs of enterprises. The IM template provides an IM deployment mechanism where the IM is designed for gathering information associated with customer interactions that occur within sessions and for enriching those interactions with offers or recommendations based upon the comprehensive real-time view of customer information, augmented by business rules and/or data mining. The IM template is provided as part of the ZLE (zero latency enterprise) development kit (ZDK).

Although the present invention has been described in accordance with the embodiments shown, variations to the embodiments would be apparent to those skilled in the art and those variations would be within the scope and spirit of the present invention. Accordingly, it is intended that the specification and embodiments shown be considered as exemplary only, with a true scope of the invention being indicated by the following claims and equivalents.

What is claimed is:

1. A template fashioning a deployment framework, comprising:
an application sub-framework;
a business logic sub-framework; and
a test driver sub-framework,
wherein the template is adaptable with wizards for deployment that is enterprise-specific, and wherein the application, business logic and test driver sub-frameworks provide a mechanism for deploying an application along with a test driver for validating and measuring the performance of the application.

2. A template as in claim 1, wherein the application is an enterprise application, and wherein the template is a set of programming tools for developing and deploying enterprise applications.

3. A template as in claim 2, wherein the application is an interaction manager (IM) which is one of the enterprise applications and wherein the template is an IM template.

4. A template as in claim 3, wherein the deployment framework is a mechanism for deployment of the IM as a server along with deployment of a test driver as a client or for deployment of the IM along with the test driver as a standalone test application.

5. A template as in claim 4, wherein the deployed server and client are CORBA or Tuxedo-based.

6. A template as in claim 4, wherein the deployed test driver is platform independent, designed for performing functional testing and debugging and performance testing.

7. A template as in claim 4, wherein the deployed test driver is designed to test various enterprise-specific operation cases or code paths and generate a large volume of activity for large-scale performance testing of the IM.

8. A template as in claim 4, wherein the deployed test driver works off of a script and is instrumented for performance measurements.

9. A template as in claim 2, wherein the set of programming tools is included in a zero latency enterprise (ZLE) development kit (ZDK).

10. A template as in claim 3, wherein the deployed IM is designed to provide a way for initiating and resuming a session in which a guest is identified via a cookie if anonymous browsing is supported, and wherein the template is configured for deployment of the IM that omits a cookie table for associating the session with the cookie if the anonymous browsing is not supported.

11. A template as in claim 1, wherein the wizards provide for customized deployment of the IM in that they include
an application wizard to be invoked for generating an IM source,
an interaction wizard to be invoked for defining a data object or an interaction type, wherein each time the interaction wizard is invoked a defined data object or an interaction type is added to the IM source, and
an attribute wizard to be invoked for defining each attribute of one of the defined data objects or interaction types.

12. A template as in claim 1, wherein the wizards are configured for maintaining application interface for either one of CORBA and Tuxedo related information.

13. A template as in claim 1, wherein the wizards are implemented with Perl scripts to be invoked via a batch file or manually via a command lines.

14. A template as in claim 1, wherein the wizards are designed for invocation by a Perl command along with parameters.

15. A template as in claim 11, wherein a data object represents a table, the interaction type references the table and each attribute associated therewith represents a column in the table.

16. A template as in claim 15, wherein the table is located at an operation data store (ODS) within a ZLE infrastructure.

17. A template as in claim 11, wherein the application is an IM deployed with business logic and designed for leveraging a rules engine designed to process business rules, wherein the data objects are relevant to the business rules or to the business logic.

18. A template as in claim 11, wherein the application wizard is designed for creating a number of base classes of the IM source and the interaction wizard is designed for creating additional classes each time it is invoked such that the additional classes are respectively connected to the base classes via hooks in such base classes.

19. A template as in claim 11, wherein the attribute wizard adds lines of code to or updates a previously created class.

20. A template as in claim 11, wherein the interaction wizard is designed to create classes associated with the interaction type being defined thereby, and wherein the attribute wizard is designed to touch each class associated with that interaction type when its invocation specifies that interaction type.

21. A template as in claim 1, wherein for each instance of the application being deployed there is a project file located in a directory in which all source files related to the project file are located.

22. A template as in claim 1, wherein the application is deployed with business logic specific to the enterprise via the wizards.

23. A template as in claim 21, wherein there are build targets defined within the project file including
a first library containing modules for composing and/or extending the business logic sub-framework,
a second library containing modules for composing or extending the test driver sub-framework,
a standalone test modules associated with the modules of both the first and second libraries,
server modules associated with the modules of the first library, and
client modules associated with the modules of the second library.

24. A template as in claim 23, wherein the first and second libraries are first to be built among the build targets.

25. A method for deploying an interaction manager (IM), comprising:
producing a template adaptable with wizards for enterprise-specific deployment of an IM along with a test driver, the wizards including
an application wizard,
an interaction wizard, and
an attribute wizard;
invoking the application wizard which invocation instantiates a project file with a set of base classes that define build targets of which a first target include common and business logic library, a second target includes a test driver library and a third target includes a stand alone test program with modules linked to the first and second targets;
invoking the interaction wizard once for each enterprise-specific interaction type and data object which invocation creates classes and connects them to any of the base classes that are named in the interaction wizard invocation;
invoking the attribute wizard once for each attribute of the enterprise-specific interaction type and data object which invocation adds lines of code to or modifies any of the classes that are named in the attribute wizard invocation; and
compiling and linking the classes and base classes and creating therefrom the IM in the form of an executable file.

26. A method for deploying an IM as in claim 25, further comprising:
building a fourth target that fashions a CORBA server with modules linked to the first target; and
building a fifth target that fashions a CORBA client with modules linked to the second target.

27. A method for deploying an IM as in claim 25, further comprising:
building a fourth target that fashions a Tuxedo server with modules linked to the first target; and
building a fifth target that fashions a Tuxedo client with modules linked to the second target.

28. A system for deploying an interaction manager (IM), comprising:
means for providing a template adaptable with wizards for enterprise-specific deployment of the IM along with a test driver, the wizards including
an application wizard,
an interaction wizard, and
an attribute wizard;
means for invoking the application wizard which invocation instantiates a project file with a set of base classes that define build targets of which a first target include common and business logic library, a second target includes a test driver library and a third target includes a stand alone test program with modules linked to the first and second targets;
means for invoking the interaction wizard once for each enterprise-specific interaction type and data object which invocation creates classes and connects them to any of the base classes that are named in the interaction wizard invocation;
means for invoking the attribute wizard once for each attribute of the enterprise-specific interaction type and data object which invocation adds lines of code to or modifies any of the classes that are named in the attribute wizard invocation; and
means for compiling and linking the classes and base classes and for creating therefrom the IM in the form of an executable file.

29. A system for deploying an IM as in claim 28, further comprising:
means for building a fourth target that fashions a CORBA server with modules linked to the first target; and
means for building a fifth target that fashions a CORBA client with modules linked to the second target.

30. A system for deploying an IM as in claim 28, further comprising:
means for building a fourth target that fashions a Tuxedo server with modules linked to the first target; and
means for building a fifth target that fashions a Tuxedo client with modules linked to the second target.

31. An interaction manager (IM) template, comprising:
a class framework for building source code of an interaction manager and a test driver;
wizards including
an application wizard for building a base class portion of the class framework, and
interaction and attribute wizards for extending or modifying the class framework once the base class portion is built so as to provide for enterprise-specific deployment of the interaction manager along with the test driver;
test driver script through which the test driver is to be used for validating and measuring the performance of the interaction manager once their source code is converted to executable code.

32. An IM template as in claim 31, wherein the base class portion created via the application wizard fashions objects that are always part of the class framework, including session, customer and offer objects, and wherein the attribute wizard adds to or modifies attributes of these objects.
